(19) United States
(12) Patent Application Publication
(10) Pub. No.: US 2010/0230958 A1
(43) Pub. Date: Sep. 16, 2010

(54) Method and Apparatus for coupling Expandable Tubular Members

(75) Inventor: Mark Burford Holland, Katy, TX (US)

Correspondence Address: HAYNES AND BOONE, LLP;IP Section, 2323 Victory Avenue, Suite 700, Dallas, TX, 75219, US

(73) Assignee: ENVENTURE GLOBAL TECHNOLOGY, L.L.C., Houston, TX (US)

(21) Appl. No.: 12/088,498

(22) PCT Filed: Sep. 22, 2006
(86) PCT No.: PCT/US06/37277

§ 371 Date: Mar. 28, 2008

Related U.S. Application Data
(60) Provisional application No. 60/721,579, filed on Sep. 28, 2005.

(51) Int. Cl. F16L 25/10

(52) U.S. Cl. 285/333

(57) ABSTRACT

A method and apparatus for coupling expandable tubular members.

### CROSS REFERENCE TO RELATED APPLICATIONS

This application claims the benefit of the filing date of U.S. provisional patent application Ser. No. 60/721,579, attorney docket number 25791.327, filed on Sep. 28, 2005, the disclosure of which is incorporated herein by reference.

This application is a continuation in part of (1) U.S. National Stage application Ser. No. 10/525,402, attorney docket number 25791.120.05, filed on Aug. 18, 2003; (2) U.S. National Stage application Ser. No. 10/528,222, attorney docket number 25791.129.03, filed on Aug. 18, 2003; (3) U.S. provisional patent application Ser. No. 60/702,395, attorney docket no. 25791.133, filed on Jul. 27, 2005; (4) PCT patent application serial no. PCT/US2004/028438, attorney docket no. 25791.137.02, filed on Sep. 1, 2004; (5) U.S. National Stage application Ser. No. 10/546,084, attorney docket no. 25791.185.05, filed on Aug. 17, 2005; (6) U.S. National Stage application Ser. No. 10/546,082, attorney docket no. 25791.378, filed on Aug. 17, 2005; (7) U.S. National Stage application Ser. No. 10/546,076, attorney docket no. 25791.379, filed on Aug. 17, 2005; (8) U.S. National Stage application Ser. No. 10/546,936, attorney docket no. 25791.380, filed on Aug. 17, 2005; (9) U.S. National Stage application Ser. No. 10/546,079, attorney docket no. 25791.381, filed on Aug. 17, 2005; (10) U.S. National Stage application Ser. No. 10/545,941, attorney docket no. 25791.382, filed on Aug. 17, 2005; (11) U.S. National Stage application Ser. No. 10/546,078, attorney docket no. 25791.383, filed on Aug. 17, 2005 the disclosures of which are incorporated herein by reference.

This application is related to the following co-pending applications: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02; filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999, (122) PCT patent application serial no. PCT/US2004/06246, attorney docket no. 25791.238.02, filed on Feb. 26, 2004, (123) PCT patent application serial number PCT/US2004/08170, attorney docket number 25791.40.02, filed on Mar. 15, 2004, (124) PCT patent application serial number PCT/US2004/08171, attorney docket number 25791.236.02, filed on Mar. 15, 2004, (125) PCT patent application serial number PCT/US2004/08073, attorney docket number 25791.262.02, filed on Mar. 18, 2004, (126) PCT patent application serial number PCT/US2004/07711, attorney docket number 25791.253.02, filed on Mar. 11, 2004, (127) PCT patent application serial number PCT/US2004/029025, attorney docket number 25791.260.02, filed on Mar. 26, 2004, (128) PCT patent application serial number PCT/US2004/010317, attorney docket number 25791.270.02, filed on Apr. 2, 2004, (129) PCT patent application serial number PCT/US2004/010712, attorney docket number 25791.272.02, filed on Apr. 6, 2004, (130) PCT patent application serial number PCT/US2004/010762, attorney docket number 25791.273.02, filed on Apr. 6, 2004, (131) PCT patent application serial number PCT/US2004/011973, attorney docket number 25791.277.02, filed on Apr. 15, 2004, (132) U.S. provisional patent application Ser. No. 60/495,056, attorney docket number 25791.301, filed on Aug. 14, 2003, (133) U.S. provisional patent application Ser. No. 60/600,679, attorney docket number 25791.194, filed on Aug. 11, 2004, (134) PCT patent application serial number PCT/US2005/027318, attorney docket number 25791.329.02, filed on Jul. 29, 2005, the disclosures of which are incorporated herein by reference. (135) PCT patent application serial number PCT/US2005/028936, attorney docket number 25791.338.02, filed on Aug. 12, 2005, (136) PCT patent application serial number PCT/US2005/028669, attorney docket number 25791.194.02, filed on Aug. 11, 2005, (137) PCT patent application serial number PCT/US2005/028453, attorney docket number 25791.371, filed on Aug. 11, 2005, (138) PCT patent application serial number PCT/US2005/028641, attorney docket number 25791.372, filed on Aug. 11, 2005, (139) PCT patent application serial number PCT/US2005/028819, attorney docket number 25791.373, filed on Aug. 11, 2005, (140) PCT patent application serial number PCT/US2005/028446, attorney docket number 25791.374, filed on Aug. 11, 2005, (141) PCT patent application serial number PCT/US2005/028642, attorney docket number 25791.375, filed on Aug. 11, 2005, (142) PCT patent application serial number PCT/US2005/028451, attorney docket number 25791.376, filed on Aug. 11, 2005, and (143). PCT patent application serial number PCT/US2005/028473, attorney docket number 25791.377, filed on Jul. 29, 2005, (144) U.S. National Stage application Ser. No. 10/546,084, attorney docket no. 25791.185.05, filed on Aug. 17, 2005; (145) U.S. National Stage application Ser. No. 10/546,082, attorney docket no. 25791.378, filed on Aug. 17, 2005; (146) U.S. National Stage application Ser. No. 10/546,076, attorney docket no. 25791.379, filed on Aug. 17, 2005; (147) U.S. National Stage application Ser. No. 10/546,936, attorney docket no. 25791.380, filed on Aug. 17, 2005; (148) U.S. National Stage application Ser. No. 10/546,079, attorney docket no. 25791.381, filed on Aug. 17, 2005; (149) U.S. National Stage application Ser. No. 10/545,941, attorney docket no. 25791.382, filed on Aug. 17, 2005; (150) U.S. National Stage application Ser. No. 10/546,078, attorney docket no. 25791.383, filed on Aug. 17, 2005 the disclosures of which are incorporated herein by reference.

### BACKGROUND

This disclosure relates generally to oil and gas exploration, and in particular to a method and apparatus for coupling expandable tubular members to facilitate oil and gas exploration.

### SUMMARY

According to one aspect of the present disclosure, an expandable tubular member is provided that includes a first tubular member comprising a first tubular member diameter which decreases from a first outside diameter along the length of the first tubular member to a second outside diameter adjacent a first tubular member connection end on the first tubular member, a second tubular member comprising a second tubular member diameter which decreases from a third outside diameter along the length of the second tubular member to a fourth outside diameter adjacent a second tubular member connection end on the second tubular member, whereby the second tubular member connection end is positioned adjacent the first tubular member connection end, and a connection member coupled to the second outside diameter and the fourth outside diameter, whereby the connection member comprises a connection member diameter which is not substantially greater than the first outside diameter and the third outside diameter.

According to another aspect of the present disclosure, an expandable tubular member is provided that includes a first tubular member comprising a maximum first tubular member diameter, a second tubular member comprising a maximum second tubular member diameter, whereby the second tubular member is positioned adjacent the first tubular member, and means for allowing a connection member to be coupled to the first tubular member and the second tubular without a maximum connection member diameter being substantially greater than the maximum first tubular member diameter and the maximum second tubular member diameter.

According to another aspect of the present disclosure, an expandable tubular member is provided that includes a tubular member comprising an inner surface and an outer surface, a thread member extending from the inner surface, and an expansion channel defined by the tubular member and located on the outer surface and adjacent the thread member.

According to another aspect of the present disclosure, an expandable tubular member is provided that includes a tubular member comprising an inner surface and an outer surface, a thread member extending from the inner surface, and means for providing a stress concentration in the thread member during radial expansion and plastic deformation of the tubular member.

According to another aspect of the present disclosure, an expandable tubular member is provided that includes a first tubular member comprising an inner surface and an outer surface, a thread member extending from the inner surface, an expansion channel defined by the first tubular member and located on the outer surface and adjacent the thread member, and a second tubular member coupled the first tubular member and engaging the thread member.

According to another aspect of the present disclosure, an expandable tubular member is provided that includes a first tubular member comprising an inner surface and an outer surface, a thread member extending from the inner surface, an expansion channel defined by the first tubular member and located on the outer surface and adjacent the thread member, a tubular connection sleeve positioned on the first tubular member, an expansion slot defined by the tubular connection sleeve in a substantially axial orientation with respect to the tubular connection sleeve and located adjacent the expansion channel, a second tubular member coupled the first tubular member and engaging the thread member, whereby upon radial expansion and plastic deformation of the first tubular member and the second tubular member, the first tubular member and the second tubular member can withstand a pressure of up to approximately 4000 pounds per square inch.

According to another aspect of the present disclosure, an expandable tubular member is, provided that includes a first tubular member defining a flange channel on a first surface of the first tubular member, and resilient means positioned in the flange channel for forming a seal between the first tubular member and a second tubular member.

According to another aspect of the present disclosure, an expandable tubular member is provided that includes a first tubular member comprising a flange member extending from a surface on the first tubular member, the flange member comprising a resilient beam extending from a distal end of the flange member for forming a seal between the first tubular member and a second tubular member.

According to another aspect of the present disclosure, an expandable tubular member is provided that includes a first tubular member defining a flange channel on a surface of the first tubular member, a second tubular member comprising a flange member extending from a surface on the second tubular member, the second tubular member coupled to the first tubular member with the flange member positioned in the flange channel, whereby a sealing passageway is defined between the flange member and the flange channel, and resilient means for forming a seal between the first tubular member and the second tubular member positioned in the sealing passageway.

According to another aspect of the present disclosure, a connection member for coupling expandable tubular members is provided that includes a tubular connection member comprising an inner surface and an outer surface, a primary sealing member having a substantially diamond shaped cross section and extending from a substantially central location on the inner surface, a reinforced section located on the outer surface and adjacent the primary sealing member, and a plurality of secondary sealing surfaces located on opposite distal ends of the tubular connection member and on opposite sides of the primary sealing member.

According to another aspect of the present disclosure, a connection member for coupling expandable tubular members is provided that includes a tubular connection member, and means for providing a primary and secondary metal to metal seal between the tubular connection member and an expandable tubular member.

According to another aspect of the present disclosure, an expandable tubular member is provided that includes a first tubular member comprising a first connection end, a second tubular member comprising a second connection end, and a connection member coupling together the first tubular member and the second tubular member, the connection member including a tubular connection member comprising an inner surface and an outer surface, the inner surface engaging the first tubular member and the second tubular member, a primary sealing member having a substantially diamond shaped cross section, extending from a substantially central location on the inner surface, and positioned between the first connection end and the second connection end, a reinforced section located on the outer surface and adjacent the primary sealing member, and a plurality of secondary sealing surfaces located on opposite distal ends of the tubular connection member and on opposite sides of the primary sealing member, the secondary sealing surfaces coupled to the first connection end and the second connection end.

According to another aspect of the present disclosure, an expandable tubular member is provided that includes a first tubular member comprising a first connection end, a second tubular member comprising a second connection end, a connection member coupled to the first connection end and the second connection end; and means for providing a primary and secondary metal to metal seal between the connection member and the first tubular member and the second tubular member.

According to another aspect of the present disclosure, a method for coupling expandable tubular members is provided that includes providing a first tubular member comprising a maximum first tubular member diameter, providing a second tubular comprising a maximum second tubular member diameter, and coupling the first tubular member to the second tubular member with a connection member comprising a maximum connection member diameter which is not substantially greater than the maximum first tubular member diameter and the maximum second tubular member diameter.

According to another aspect of the present disclosure, a method for coupling expandable tubular members is provided that includes providing a first tubular member comprising a thread member extending from an inner surface and defining a expansion channel on the outer surface which is located adjacent the thread member, and coupling a second tubular member to the first tubular member by engaging the thread member with a thread channel in the second tubular member.

According to another aspect of the present disclosure, a method for coupling expandable tubular members is provided that includes providing a first tubular member comprising a flange member extending from an inner surface, providing a second tubular member defining a flange channel on an outer surface, positioning a resilient member in the flange channel, and coupling the first tubular member to the second tubular member by positioning the flange member in the flange channel and adjacent the resilient member.

According to another aspect of the present disclosure, a method for coupling expandable tubular members is provided that includes providing a first tubular member comprising a first connection end, providing a second tubular member comprising a second connection end, positioning a connection member adjacent the first connection end and the second connection end such that a primary sealing member on the connection member is positioned between the first connection end and the second connection end, and a plurality of secondary sealing surfaces are positioned adjacent the first tubular member and the second tubular member, and coupling the first tubular member to the second tubular member using the connection member.

According to another aspect of the present disclosure, an expandable tubular member is provided that includes a first tubular member, a second tubular member coupled to the first tubular member, and means for effecting a gas and fluid tight seal between the first tubular member and the second tubular member before, during, and after radial expansion and plastic deformation of the first tubular member and the second tubular member, the means providing a seal which can withstand a pressure of up to 4000 pounds per square inch.

According to another aspect of the present disclosure, an expandable tubular member is provided that includes a first tubular member comprising a first tubular member diameter which decreases from a first outside diameter along the length of the first tubular member to a second outside diameter adjacent a first tubular member connection end on the first tubular member, a second tubular member comprising a second tubular member diameter which decreases from first outside diameter along the length of the second tubular member to the second outside diameter adjacent a second tubular member connection end on the second tubular member, whereby the second tubular member connection end is coupled to the first tubular member connection end, and a connection member coupled to the second outside diameter, whereby the connection member comprises a connection member diameter which is less than or equal to the first outside diameter.

According to another aspect of the present disclosure, an expandable tubular member is provided that includes a tubular member comprising an inner surface and an outer surface, a plurality of thread members extending from the inner surface, and a helical expansion channel defined by the tubular member and located on the outer surface and radially adjacent each of the plurality of thread members, whereby the expansion channel provides a stress concentration in the thread member during radial expansion and plastic deformation of the tubular member.

According to another aspect of the present disclosure, an expandable tubular member is provided that includes a first tubular member comprising an inner surface and an outer surface, a plurality of thread member extending from the inner surface, a helical expansion channel defined by the first tubular member and located on the outer surface and radially adjacent each of the plurality of thread members, a second tubular member coupled the first tubular member and engaging the plurality of thread members, whereby the expansion channel provides a stress concentration in the thread member during radial expansion and plastic deformation of the first tubular member and the second tubular member, a tubular connection sleeve positioned on the first tubular member, and a plurality of spaced apart expansion slots defined by the tubular connection sleeve in a substantially axial orientation with respect to the tubular connection sleeve and oriented substantially perpendicularly adjacent to and with respect to the expansion channel; whereby the plurality of expansion slots on the tubular connection sleeve provides a plurality of discrete point stress concentrations on the thread member during radial expansion and plastic deformation of the first tubular member, the second tubular member, and the connection sleeve.

According to another aspect of the present disclosure, a connection member for coupling expandable tubular members is provided that includes a tubular connection member comprising an inner surface and an outer surface, a primary sealing member having a substantially diamond shaped cross section, extending from a substantially central location on the inner surface, and deformable to provide a metal to metal seal between the tubular connection member and an expandable tubular member, a reinforced section located on the outer surface and adjacent the primary sealing member, and a plurality of secondary sealing surfaces located on opposite distal ends of the tubular connection member on opposite sides of the primary sealing member, and deformable to provide a metal to metal seal between the tubular connection member and an expandable tubular member.

According to another aspect of the present disclosure, an expandable tubular member is provided that includes a first tubular member comprising a first connection end, a second tubular member comprising a second connection end, and a connection member coupling together the first tubular member and the second tubular member, the connection member including a tubular connection member comprising an inner surface and an outer surface, the inner surface engaging the first tubular member and the second tubular member, a primary sealing member having a substantially diamond shaped cross section, extending from a substantially central location on the inner surface, positioned between the first connection end and the second connection end, and deformable to provide a metal to metal seal between the connection member and the first tubular member and the second tubular member, a reinforced section located on the outer surface and adjacent the primary sealing member, and a plurality of secondary sealing surfaces located on opposite distal ends of the tubular connection member and on opposite sides of the primary sealing member, the secondary sealing surfaces coupled to the first connection end and the second connection end and deformable to provide a metal to metal seal between the connection member and the first tubular member and the second tubular member.

According to another aspect of the present disclosure, a method for coupling expandable tubular members is provided that includes providing a first tubular member comprising a maximum first tubular member diameter, providing a second tubular comprising a maximum second tubular member diameter, coupling the first tubular member to the second tubular member with a connection member comprising a maximum connection member diameter which is not substantially greater Than the maximum first tubular member diameter and the maximum second tubular member diameter, positioning the first tubular member, the second tubular member, and the connection member in a wellbore, and radially expanding and plastically deforming the first tubular member and the second tubular member, wherein the radially expanding and plastically deforming comprises one of either radially expanding and plastically deforming a first reduced diameter section on the first tubular member to substantially the maximum first tubular member diameter and radially expanding and plastically deforming a second reduced diameter section on the second tubular member to substantially the maximum second tubular member diameter or radially expanding and plastically deforming the first tubular member and the second tubular member into engagement with the wellbore.

According to another aspect of the present disclosure, a method for coupling expandable tubular members is provided that includes providing a first tubular member comprising a thread member extending from an inner surface and defining a expansion channel on the outer surface which is located adjacent the thread member, coupling a connection sleeve to the outer surface of the of the first tubular member, the connection sleeve defining an expansion slot oriented axially with respect the connection sleeve and which is positioned substantially perpendicularly to the expansion channel, coupling a second tubular member to the first tubular member by engaging the thread member with a thread channel in the second tubular member, positioning the first tubular member, the second tubular member, and the connection sleeve in a wellbore, and radially expanding and plastically deforming the first tubular member, the second tubular member, and the connection sleeve, whereby the expansion slot and the expansion channel provide a stress concentration which increases the deformation of the thread member in the thread channel during the radially expanding and plastically deforming and provides a metal to metal seal between the thread member and the thread channel.

According to another aspect of the present disclosure, a method for coupling expandable tubular members is provided that includes providing a first tubular member comprising a flange member extending from an inner surface, providing a second tubular member defining a flange channel on an outer surface, positioning a resilient member in the flange channel, coupling the first tubular member to the second tubular member by positioning the flange member in the flange channel and adjacent the resilient member, positioning the first tubular member and the second tubular member in a wellbore, and radially expanding and plastically deforming the first tubular member and the second tubular member, whereby the radially expanding and plastically deforming compresses the resilient member and provides a seal between the flange member and the flange channel; whereby the radially expanding and plastically deforming provides a metal to metal seal between the flange member and the flange channel.

According to another aspect of the present disclosure, a method for coupling expandable tubular members is provided that includes providing a first tubular member comprising a first connection end, providing a second tubular member comprising a second connection end, positioning a connection member adjacent the first connection end and the second connection end such that a primary sealing member on the connection member is positioned between the first connection end and the second connection end, and a plurality of secondary sealing surfaces are positioned adjacent the first tubular member and the second tubular member, coupling the first tubular member to the second tubular member using the connection member, whereby the coupling includes providing a metal sealing member between the first tubular member, the second tubular member, and the secondary sealing surfaces, positioning the first tubular member, the second tubular member, and the connection member in a wellbore, and radially expanding and plastically deforming the first tubular member and the second tubular member, whereby the radially expanding and plastically deforming provides a primary seal between the primary sealing member and the first tubular member and the second tubular member, and the radially expanding and plastically deforming provides a secondary seal between the secondary sealing surfaces and the first tubular member and the second tubular member.

According to one aspect of the present invention, a method of forming a wellbore casing within a borehole that traverses a subterranean formation is provided that includes assembling a tubular liner by coupling threaded portions of first and second tubular members having a multi-layer tubular insert between the threads of the first tubular member and the threads of the second tubular member, positioning the tubular liner assembly within a borehole, and radially expanding and plastically deforming the tubular liner assembly within the borehole wherein the multi-layer tubular insert includes a first layer having a first modulus of elasticity and a second layer coupled to the first layer having a second modulus of elasticity wherein the first modulus of elasticity is different from the second modulus of elasticity. According to another aspect of the present invention, a method of forming a wellbore casing within a borehole that traverses a subterranean formation is provided that includes assembling a tubular liner by coupling a multi-layer metallic insert assembly to a threaded portion of the first tubular member and coupling a threaded portion of a second tubular member to the threaded portion of first tubular member with the multi-layer tubular insert there between, and positioning the tubular liner assembly within a borehole and radially expanding and plastically deforming the tubular liner assembly and wherein the first tubular insert is a metal have a first modulus of elasticity and a second tubular insert is composed of a metal having a second modulus of elasticity different from the first modulus of elasticity. According to another aspect of the present invention, the multi-layers of the inner post tubular insert include a first insert of copper and a second tubular insert of cadmium.

According to another aspect of the present invention, both layers of the multi-layer tubular liner inserted between the threads of the wellbore casing members have a modulus of elasticity less than the tubular members. According to another aspect of the present invention, the multi-layer tubular insert includes a first tubular insert providing a fluidic seal after radially expanding and plastically deforming the tubular liner assembly, and another, layer of the multi-layer insert provides a micro-fluidic seal after radially expanding and plastically deforming a tubular liner.

According to another aspect of the present invention, the multi-layer tubular liner includes a first, a second, and a third layer, each adjacent layer having a different modulus of elasticity.

According to another aspect of the present invention, the multi-layer tubular insert assembly includes a first, second, third, and fourth layer, each layer having a different modulus of elasticity from an adjacent layer.

According to another aspect of the present, invention, a method of forming a wellbore casing within a borehole that traverses a subterranean formation is provided that includes expanding joined tubular members, such as joined wellbore casings, having a layer of a metallic alloy that has a first melting temperature prior to exposure to heat and strain as a second higher melting temperature after exposure to heat and or strain (know as a eutectic material) interposed between the joint prior to radially expanding the jointed tubular members.

According to one aspect of the present invention, an assembly is provided that includes a first tubular member including external threads, and a second tubular member comprising internal threads coupled to the external threads of the first tubular member. At least one of the first and second tubular members define one or more stress concentrators. According to another aspect of the present invention, a method for forming a wellbore casing has been described that includes positioning any one, portion, or combination, of the exemplary embodiments of the assemblies of the present application within a borehole that traverses a subterranean formation, and radially expanding and plastically deforming the assembly within the borehole.

According to another aspect of the present invention, an apparatus is provided that includes a wellbore that traverses a subterranean formation, and a wellbore casing positioned within and coupled to the wellbore. The wellbore casing is coupled to the wellbore by a process including: positioning any one, portion, or combination, of the exemplary assemblies of the present application within the wellbore, and radially expanding and plastically deforming the assembly within the wellbore.

According to another aspect of the present invention, a system for forming a wellbore casing is provided that includes means for positioning any one, portion, or combination, of the exemplary assemblies of the present application within a borehole that traverses a subterranean formation, and means for radially expanding and plastically deforming the assembly within the borehole.

According to another aspect of the present invention, a method of providing a fluid tight seal between a pair of overlapping tubular members is provided that includes forming one or more stress concentrators within at least one of the tubular members, and radially expanding and plastically deforming the tubular members.

According to one embodiment, an assembly is provided that includes a first tubular member including external threads, and a second tubular member comprising internal threads coupled to the external threads of the first tubular member. At least one of the first and second tubular members define one or more stress concentrators.

According to another embodiment, a method for forming a wellbore casing has been described that includes positioning any one, portion, or combination, of the embodiments of the assemblies disclosed herein within a borehole that traverses a subterranean formation, and radially expanding and plastically deforming the assembly within the borehole.

According to another embodiment, an apparatus is provided that includes a wellbore that traverses a subterranean formation, and a wellbore casing positioned within and coupled to the wellbore. The wellbore casing is coupled to the wellbore by a process including: positioning any one, portion, or combination, of the assemblies disclosed herein within the wellbore, and radially expanding and plastically deforming the assembly within the wellbore.

According to another embodiment, a system for forming a wellbore casing is provided that includes means for positioning any one, portion, or combination, of the assemblies disclosed herein within a borehole that traverses a subterranean formation, and means for radially expanding and plastically deforming the assembly within the borehole.

According to another embodiment, a method of providing a fluid tight seal between a pair of overlapping tubular members is provided that includes forming one or more stress concentrators within at least one of the tubular members, and radially expanding and plastically deforming the tubular members.

According to one aspect of the present invention, a radially expandable multiple tubular member apparatus is provided that includes a first tubular member; a second tubular member engaged with the first tubular member forming a joint; a sleeve overlapping and coupling the first and second tubular members at the joint; the sleeve having opposite tapered ends and a flange engaged in a recess formed in an adjacent tubular member; and one of the tapered ends being a surface formed on the flange.

According to another aspect of the present invention, a method of joining radially expandable multiple tubular members is provided that includes providing a first tubular member; engaging a second tubular member with the first tubular member to form a joint; providing a sleeve having opposite tapered ends and a flange, one of the tapered ends being a surface formed on the flange; and mounting the sleeve for overlapping and coupling the first and second tubular members at the joint, wherein the flange is engaged in a recess formed in an adjacent one of the tubular members.

According to another aspect of the present invention, a radially expandable multiple tubular member apparatus is provided that includes a first tubular member; a second tubular member engaged with the first tubular member forming a joint; and a sleeve overlapping and coupling the first and second tubular members at the joint; wherein at least a portion of the sleeve is comprised of a frangible material.

According to another aspect of the present invention, a radially expandable multiple tubular member apparatus is provided that includes a first tubular member, a second tubular member engaged with the first tubular member forming a joint, and a sleeve overlapping and coupling the first and second tubular members at the joint; wherein the wall thickness of the sleeve is variable.

According to another aspect of the present invention, a method of joining radially expandable multiple tubular members is provided that includes providing a first tubular member; engaging a second tubular member with the first tubular member to form a joint; providing a sleeve comprising a frangible material; and mounting the sleeve for overlapping and coupling the first and second tubular members at the joint.

According to another aspect of the present invention, a method of joining radially expandable multiple tubular members is provided that includes providing a first tubular member; engaging a second tubular member with the first tubular member to form a joint; providing a sleeve comprising a variable wall thickness; and mounting the sleeve for overlapping and coupling the first and second tubular members at the joint.

According to another aspect of the present invention, an expandable tubular assembly is provided that includes a first tubular member; a second tubular member coupled to the first tubular member; and means for increasing the axial compression loading capacity of the coupling between the first and second tubular members before and after a radial expansion and plastic deformation of the first and second tubular members.

According to another aspect of the present invention, an expandable tubular assembly is provided that includes a first tubular member; a second tubular member coupled to the first tubular member; and means for increasing the axial tension loading capacity of the coupling between the first and second tubular members before and after a radial expansion and plastic deformation of the first and second tubular members.

According to another aspect of the present invention, an expandable tubular assembly is provided that includes a first tubular member; a second tubular member coupled to the first tubular member; and means for increasing the axial compression and tension loading capacity of the coupling between the first and second tubular members before and after a radial expansion and plastic deformation of the first and second tubular members.

According to another aspect of the present invention, an expandable tubular assembly is provided that includes a first tubular member; a second tubular member coupled to the first tubular member; and means for avoiding stress risers in the coupling between the first and second tubular members before and after a radial expansion and plastic deformation of the first and second tubular members.

According to another aspect of the present invention, an expandable tubular assembly is provided that includes a first tubular member; a second tubular member coupled to the first tubular member; and means for inducing stresses at selected portions of the coupling between the first and second tubular members before and after a radial expansion and plastic deformation of the first and second tubular members.

According to another aspect of the present invention, an expandable tubular assembly is provided that includes a first tubular member, a second tubular member coupled to the first tubular member, a first threaded connection for coupling a portion of the first and second tubular members, a second threaded connection spaced apart from the first threaded connection for coupling another portion of the first and second tubular members, a tubular sleeve coupled to and receiving end portions of the first and second tubular members, and a sealing element positioned between the first and second spaced apart threaded connections for sealing an interface between the first and second tubular member, wherein the sealing element is positioned within an annulus defined between the first and second tubular members.

According to another aspect of the present invention, a method of joining radially expandable multiple tubular members is provided that includes providing a first tubular member, providing a second tubular member, providing a sleeve, mounting the sleeve for overlapping and coupling the first and second tubular members, threadably coupling the first and second tubular members at a first location, threadably coupling the first and second tubular members at a second location spaced apart from the first location, and sealing an interface between the first and second tubular members between the first and second locations using a compressible sealing element.

According to another aspect of the present invention, an expandable tubular assembly is provided that includes a first tubular member, a second tubular member coupled to the first tubular member, a first threaded connection for coupling a portion of the first and second tubular members, a second threaded connection spaced apart from the first threaded connection for coupling another portion of the first and second tubular members, and a plurality of spaced apart tubular sleeves coupled to and receiving end portions of the first and second tubular members.

According to another aspect of the present invention, a method of joining radially expandable multiple tubular members is provided that includes providing a first tubular member, providing a second tubular member, threadably coupling the first and second tubular members at a first location, threadably coupling the first and second tubular members at a second location spaced apart from the first location, providing a plurality of sleeves, and mounting the sleeves at spaced apart locations for overlapping and coupling the first and second tubular members.

According to another aspect of the present invention, an expandable tubular assembly is provided that includes a first tubular member, a second tubular member coupled to the first tubular member, and a plurality of spaced apart tubular sleeves coupled to and receiving end portions of the first and second tubular members.

According to another aspect of the present invention, a method of joining radially expandable multiple tubular members is provided that includes providing a first tubular member, providing a second tubular member, providing a plurality of sleeves, coupling the first and second tubular members, and mounting the sleeves at spaced apart locations for overlapping and coupling the first and second tubular members.

According to another aspect of the present invention, an expandable tubular assembly is provided that includes a first tubular member, a second tubular member coupled to the first tubular member, a threaded connection for coupling a portion of the first and second tubular members, and a tubular sleeves coupled to and receiving end portions of the first and second tubular members, wherein at least a portion of the threaded connection is upset.

According to another aspect of the present invention, a method of joining radially expandable multiple tubular members is provided that includes providing a first tubular member, providing a second tubular member, threadably coupling the first and second tubular members, and upsetting the threaded coupling.

According to another aspect of the present invention, a radially expandable multiple tubular member apparatus is provided that includes a first tubular member, a second tubular member engaged with the first tubular member forming a joint, a sleeve overlapping and coupling the first and second tubular members at the joint, and one or more stress concentrators for concentrating stresses in the joint.

According to another aspect of the present invention, a method of joining radially expandable multiple tubular members is provided that includes providing a first tubular member, engaging a second tubular member with the first tubular member to form a joint, providing a sleeve having opposite tapered ends and a flange, one of the tapered ends being a surface formed on the flange, and concentrating stresses within the joint.

According to another aspect of the present invention, a system for radially expanding and plastically deforming a first tubular member coupled to a second tubular member by a mechanical connection is provided that includes means for radially expanding the first and second tubular members, and means for maintaining portions of the first and second tubular member in circumferential compression following the radial expansion and plastic deformation of the first and second tubular members.

According to another aspect of the present invention, a system for radially expanding and plastically deforming a first tubular member coupled to a second tubular member by a mechanical connection is provided that includes means for radially expanding the first and second tubular members; and means for concentrating stresses within the mechanical connection during the radial expansion and plastic deformation of the first and second tubular members.

According to another aspect of the present invention, a system for radially expanding and plastically deforming a first tubular member coupled to a second tubular member by a mechanical connection is provided that includes means for radially expanding the first and second tubular members; means for maintaining portions of the first and second tubular member in circumferential compression following the radial expansion and plastic deformation of the first and second tubular members; and means for concentrating stresses within the mechanical connection during the radial expansion and plastic deformation of the first and second tubular members.

According to one aspect of the present disclosure, an expandable tubular member is provided which includes a tubular member comprising an inner surface, an outer surface located opposite the inner surface, and a distal end, and a distal end securing member extending from the distal end and defining a distal end securing channel adjacent the inner surface.

According to another aspect of the present disclosure, an expandable tubular member is provided which includes a first tubular member comprising a distal end, and means on the first tubular member for preventing spring-back of the distal end of the first tubular member upon the coupling of the first tubular member to a second tubular member and radial expansion and plastic deformation of the first tubular member and the second tubular member.

According to another aspect of the present disclosure, an expandable tubular member is provided which includes a tubular member comprising a distal end, an outer surface, and an inner surface located opposite the outer surface, the inner surface defining a second tubular member coupling passageway extending from the distal end to a coupling passageway end located along the length of the tubular member, a distal end securing member extending from the tubular member adjacent the coupling passageway end, and a distal end securing channel defined by the tubular member and located between the distal end securing member and the outer surface.

According to another aspect of the present disclosure, an expandable tubular member is provided which includes a first tubular member, and means on the first tubular member for preventing spring-back of a distal end of a second tubular member upon the coupling of the first tubular member to the second tubular member and radial expansion and plastic deformation of the first tubular member and the second tubular member.

According to another aspect of the present disclosure, an expandable tubular member is provided which includes a first tubular member defining a second tubular member coupling passageway and defining a distal end securing channel located adjacent the second tubular member coupling passageway, and a second tubular member positioned in the second tubular member coupling passageway and coupled to the first tubular member, whereby the second tubular member comprises a distal end securing member positioned in the distal end securing channel.

According to another aspect of the present disclosure, an expandable tubular member is provided which includes a first tubular member, a second tubular member comprising a distal end and coupled to the first tubular member, and means on the first tubular member and the second tubular member for preventing spring-back of the distal end of the second tubular member upon the radial expansion and plastic deformation of the first tubular member and the second tubular member.

According to another aspect of the present disclosure, a method for coupling expandable tubular members is provided which includes providing a first tubular member defining a second tubular member coupling passageway and defining a distal end securing channel located adjacent the second tubular member coupling passageway, providing second tubular member comprising a distal end and a distal end securing member extending from the distal end, and coupling the first tubular member to the second tubular member, whereby the distal end securing member is positioned in the distal end securing channel.

According to another aspect of the present disclosure, an expandable tubular member is provided which includes a pin-thread tubular member comprising an inner surface, an outer surface located opposite the inner surface, and a distal end, a tubular member passageway defined by the inner surface, a distal end securing member extending from the distal end and defining a annular distal end securing channel adjacent the inner surface, whereby the annular distal end securing channel is located between the distal end securing member and the tubular member passageway, an interference fit notch defined by the distal end securing member and located on a terminating end of the distal end securing member, a sealing member engagement surface located on an opposite side of the distal end securing member from the distal end securing channel, a plurality of threads extending from the outer surface of the tubular member, the plurality of threads defining a plurality of thread channels, and a lubricating material on the inner surface of the tubular member.

According to another aspect of the present disclosure, an expandable tubular member is provided which includes a box-thread tubular member comprising a distal end, an outer surface, and an inner surface located opposite the outer surface, the inner surface defining a second tubular member coupling passageway extending from the distal end to a coupling passageway end located along the length of the tubular member, a distal end securing member extending from the tubular member adjacent the coupling passageway end, an annular distal end securing channel defined by the tubular member and located between the distal end securing member and the outer surface, an interference fit member extending from the distal securing channel, a sealing member channel defined by the tubular member and located adjacent the distal end securing channel, a plurality of threads extending from the inner surface of the tubular member and located in the second tubular member coupling passageway, the plurality of threads defining a plurality of thread channels, and a lubricating material on the inner surface of the tubular member.

According to another aspect of the present disclosure, an expandable tubular member is provided which includes a first tubular member comprising a first tubular member distal end, a first tubular member outer surface, and a first tubular member inner surface located opposite the first tubular member outer surface, the first tubular member inner surface defining a second tubular member coupling passageway extending from the first tubular member distal end to a coupling passageway end located along the length of the first tubular member, a first tubular member distal end securing member extending from the first tubular member adjacent the coupling passageway end, a first tubular member distal end securing channel defined by the first tubular member and located between the first tubular member distal end securing member and the first tubular member outer surface, a second tubular member coupled to the first tubular member, the second tubular member comprising an second tubular member inner surface, a second tubular member outer surface located opposite the second tubular member inner surface, and a second tubular member distal end; and a second tubular member distal end securing member extending from the second tubular member distal end and defining a second tubular member distal end securing channel adjacent the second tubular member inner surface, whereby the second tubular member distal end securing member is positioned in the first tubular member distal end securing channel, and the first tubular member distal end securing member is positioned in the second tubular member distal end securing channel.

According to another aspect of the present disclosure, a method for coupling expandable tubular members is provided which includes providing a first tubular member defining a second tubular member coupling passageway and defining a distal end securing channel located adjacent the second tubular member coupling passageway, providing second tubular member comprising a distal end and a distal end securing member extending from the distal end, coupling the first tubular member to the second tubular member, whereby the distal end securing member is positioned in the distal end securing channel, positioning the first tubular member and the second tubular member in a preexisting structure, providing a seal between the first tubular member and the second tubular member, and radially expanding and plastically deforming the first tubular member and the second tubular member, wherein the positioning of the distal end securing member in the distal end securing channel prevents spring-back of the distal end on the second tubular member and maintains the seal between the first tubular member and the second tubular member before, during, and after radial expansion and plastic deformation of the first tubular member and the second tubular member.

### BRIEF DESCRIPTION OF THE DRAWINGS

FIG. 1 is a cross sectional view illustrating an exemplary embodiment of a wellbore.

FIG. 2 is a cross sectional view illustrating an exemplary embodiment of an expandable tubular member.

FIG. 3 is a cross sectional view illustrating an exemplary embodiment of an expandable tubular member used with the expandable tubular member of FIG. 2.

FIG. 4 is a cross sectional view illustrating an exemplary embodiment of a connection member used with the expandable tubular members of FIG. 2 and FIG. 3.

FIG. 5a is a flow chart illustrating an exemplary embodiment of a method for coupling expandable tubular members.

FIG. 5b is a cross sectional view illustrating an exemplary embodiment of the expandable tubular members of FIG. 2 and FIG. 3 coupled together by the connection member of FIG. 4.

FIG. 5c is a cross sectional view illustrating an exemplary embodiment of the expandable tubular members of FIG. 2 and FIG. 3 coupled together by the connection member of FIG. 4 and including a protective sleeve coupled to the connection member.

FIG. 5d is a cross sectional view illustrating an exemplary embodiment of the expandable tubular members and the connection member of FIG. 5b positioned in the wellbore of FIG. 1.

FIG. 5e is a cross sectional view illustrating an exemplary embodiment of the expandable tubular members and the connection member positioned in the wellbore of FIG. 5d and being radially expanded and plastically deformed.

FIG. 5f is a cross sectional view illustrating an exemplary embodiment of the expandable tubular members and the connection member positioned in the wellbore of FIG. 5d and radially expanded and plastically deformed.

FIG. 5g is a cross sectional view illustrating an exemplary embodiment of the expandable tubular members and the connection member positioned in the wellbore of FIG. 5f and being radially expanded and plastically deformed.

FIG. 6a is a side view illustrating an exemplary embodiment of an expandable tubular member.

FIG. 6b is a cross sectional view illustrating an exemplary embodiment of the expandable tubular member of FIG. 6a.

FIG. 7 is a cross sectional view illustrating an exemplary embodiment of an expandable tubular member used with the expandable tubular member of FIG. 6b.

FIG. 8a is a flow chart illustrating an exemplary embodiment of a method for coupling expandable tubular members.

FIG. 8b is a side view illustrating an exemplary embodiment of the expandable tubular members of FIG. 6b and FIG. 7 coupled together.

FIG. 8c is a cross sectional view illustrating an exemplary embodiment of the expandable tubular members of FIG. 6b and FIG. 7 coupled together.

FIG. 8d is a cross sectional view illustrating an exemplary embodiment of the expandable tubular members of FIG. 8c positioned in the wellbore of FIG. 1.

FIG. 8e is a cross sectional view illustrating an exemplary embodiment of the expandable tubular members positioned in the wellbore of FIG. 8d and being radially expanded and plastically deformed.

FIG. 8f is a cross sectional view illustrating an exemplary embodiment of the expandable tubular members positioned in the wellbore of FIG. 5d and radially expanded and plastically deformed.

FIG. 8g is a schematic view illustrating an exemplary embodiment of the stress concentrations on the expandable tubular members of FIG. 8e.

FIG. 9a is a side view illustrating an exemplary embodiment of a connection sleeve.

FIG. 9b is a cross sectional view illustrating an exemplary embodiment of the connection sleeve of FIG. 9a.

FIG. 10a is a flow chart illustrating an exemplary embodiment of a method for coupling expandable tubular members.

FIG. 10b is a side view illustrating an exemplary embodiment of the expandable tubular members of FIG. 6a and FIG. 7 coupled together and with the connection sleeve of FIG. 9a coupled to the expandable tubular member of FIG. 6a.

FIG. 10c is a cross sectional view illustrating an exemplary embodiment of the expandable tubular members of FIG. 6b and FIG. 7 coupled together and with the connection sleeve of FIG. 9a coupled to the expandable tubular member of FIG. 6b.

FIG. 10d is a side view illustrating an exemplary embodiment of the expandable tubular members and the connection sleeve of FIG. 10c positioned in the wellbore of FIG. 1.

FIG. 10e is a fragmentary cross sectional view illustrating an exemplary embodiment of the expandable tubular members and the connection sleeve positioned in the wellbore of FIG. 10d and being radially expanded and plastically deformed.

FIG. 10f is a cross sectional view illustrating an exemplary embodiment of the expandable tubular members and the connection sleeve positioned in the wellbore of FIG. 10d and radially expanded and plastically deformed.

FIG. 10g is a schematic view illustrating an exemplary embodiment of the stress concentrations on the expandable tubular members of FIG. 10e.

FIG. 10h is a graph of the results of an experimental embodiment of the method illustrated in FIGS. 10a, 10b, 10c, 10d, 10e and 10f.

FIG. 11 is a cross sectional view illustrating an exemplary embodiment of an expandable tubular member.

FIG. 12 is a cross sectional view illustrating an exemplary embodiment of an expandable tubular member used with the expandable tubular member of FIG. 11.

FIG. 13a is a flow chart illustrating an exemplary embodiment of a method for coupling expandable tubular members.

FIG. 13b is a side cross sectional view illustrating an exemplary embodiment of the expandable tubular members of FIG. 11 and FIG. 12 coupled together with a resilient member positioned between them.

FIG. 13c is a top cross sectional view illustrating an exemplary embodiment of the expandable tubular members of FIG. 11 and FIG. 12 coupled together with a resilient member positioned between them.

FIG. 13d is a cross sectional view illustrating an exemplary embodiment of the expandable tubular members of FIG. 13b positioned in the wellbore of FIG. 1 and being radially expanded and plastically deformed.

FIG. 13e is a cross sectional view illustrating an exemplary embodiment of the expandable tubular members of FIG. 13c positioned in the wellbore of FIG. 1 and radially expanded and plastically deformed.

FIG. 14a is a flow chart illustrating an exemplary embodiment of a method for coupling expandable tubular members.

FIG. 14b is a cross sectional view illustrating an exemplary embodiment of the expandable tubular members of FIG. 11 and FIG. 12 coupled together with a resilient member positioned between them.

FIG. 14c is a cross sectional view illustrating an exemplary embodiment of the expandable tubular members of FIG. 11 and FIG. 12 coupled together with a resilient member positioned between them.

FIG. 14d is a cross sectional view illustrating an exemplary embodiment of the expandable tubular members of FIG. 14b positioned in the wellbore of FIG. 1 and being radially expanded and plastically deformed.

FIG. 14e is a cross sectional view illustrating an exemplary embodiment of the expandable tubular members of FIG. 14c positioned in the wellbore of FIG. 1 and radially expanded and plastically deformed.

FIG. 15a is a flow chart illustrating an exemplary embodiment of a method for coupling expandable tubular members.

FIG. 15b is a cross sectional view illustrating an exemplary embodiment of the expandable tubular members of FIG. 11 and FIG. 12 coupled together with a resilient member positioned between them.

FIG. 15c is a cross sectional view illustrating an exemplary embodiment of the expandable tubular members of FIG. 11 and FIG. 12 coupled together with a resilient member positioned between them.

FIG. 15d is a cross sectional view illustrating an exemplary embodiment of the expandable tubular members of FIG. 15b positioned in the wellbore of FIG. 1 and being radially expanded and plastically deformed.

FIG. 15e is a cross sectional view illustrating an exemplary embodiment of the expandable tubular members of FIG. 15c positioned in the wellbore of FIG. 1 and radially expanded and plastically deformed.

FIG. 16 is a cross sectional view illustrating an exemplary embodiment of an expandable tubular member.

FIG. 17a is a flow chart illustrating an exemplary embodiment of a method for coupling expandable tubular members.

FIG. 17b is a cross sectional view illustrating an exemplary embodiment of the expandable tubular members of FIG. 12 and FIG. 16 coupled together.

FIG. 17c is a cross sectional view illustrating an exemplary embodiment of the expandable tubular members of FIG. 12 and FIG. 16 coupled together.

FIG. 17d is a cross sectional view illustrating an exemplary embodiment of the expandable tubular members of FIG. 17b positioned in the wellbore of FIG. 1 and being radially expanded and plastically deformed.

FIG. 17e is a cross sectional view illustrating an exemplary embodiment of the expandable tubular members of FIG. 17c positioned in the wellbore of FIG. 1 and radially expanded and plastically deformed.

FIG. 18 is a cross sectional view illustrating an exemplary embodiment of an expandable tubular member.

FIG. 19 is a cross sectional view illustrating an exemplary embodiment of an expandable tubular member used with the expandable tubular member of FIG. 18.

FIG. 20 is a cross sectional view illustrating an exemplary embodiment of a connection member used with the expandable tubular members of FIG. 18 and FIG. 19.

FIG. 21a is a flow chart illustrating an exemplary embodiment of a method for coupling expandable tubular members.

FIG. 21b is a cross sectional view illustrating an exemplary embodiment of the expandable tubular members of FIG. 18 and FIG. 19 coupled together with the connection member of FIG. 20.

FIG. 21c is a cross sectional view illustrating an exemplary embodiment of the expandable tubular members of FIG. 18 and FIG. 19 coupled together with the connection member of FIG. 20.

FIG. 21d is a cross sectional view illustrating an exemplary embodiment of the expandable tubular members of FIG. 21b positioned in the wellbore of FIG. 1 and being radially expanded and plastically deformed.

FIG. 21e is a cross sectional view illustrating an exemplary embodiment of the expandable tubular members of FIG. 21c positioned in the wellbore of FIG. 1 and radially expanded and plastically deformed.

FIG. 22 is a fragmentary cross-sectional schematic illustration of a first tubular member, such as a first wellbore casing, for placement within a borehole that traverses a subterranean formation.

FIG. 23 is a fragmentary cross-sectional schematic illustration of the first tubular member, such as the first wellbore casing as in FIG. 22 and an aligned second tubular member, such as a second wellbore casing in position for coupling together and for placing the first and second tubular members, such as the depicted wellbore casings within a borehole.

FIG. 24 is a fragmentary cross-sectional schematic illustration of first and second wellbore casings of FIG. 23 after overlapping coupling as with the first female threads and second male threads providing a substantially continuous wellbore that may be radially expanded and plastically deformed at the overlapping portions of the first and second wellbore casings.

FIG. 25 is a fragmentary cross-sectional schematic illustration of the coupling joint of FIG. 24 after placing a tubular sleeve axially aligned with the first and second wellbore casings, and overlappingly positioned at the joint formed by coupling the first and second wellbore casings.

FIG. 26 is a fragmentary cross-sectional schematic illustration of the first and second wellbore casings and of the tubular sleeve of FIG. 25 and further schematically depicting one illustration of a magnetic impulse apparatus positioned at the tubular sleeve for externally applying the tubular sleeve for improved sealing of the joint formed by coupling the wellbore casings together.

FIG. 27 is a fragmentary cross-sectional schematic illustration of the apparatus of FIG. 26, after applying magnetic impulse force to the tubular sleeve for improved sealing of the joint formed by coupling the first and second wellbore casings of FIG. 26.

FIG. 28 is a fragmentary cross-sectional schematic illustration of a joint of a first and second tubular member, such as a first and second wellbore casing, having a tubular sleeve externally applied to the adjacent external surfaces of the first and second tubular members at the overlapping joint there between prior to expanding the first and second tubular members at the area of the joint, according to one aspect of the present invention.

FIG. 29 is a fragmentary cross-sectional schematic illustration of the apparatus of FIG. 28, after the coupled portion of the first and second tubular member wellbore casings and the externally applied tubular sleeve have been radially expanded and plastically deformed according to one aspect of the present invention.

FIG. 30 is a fragmentary cross-sectional schematic illustration of the first female coupling and second male coupling and overlapping tubular sleeve with raised ridges interposed between the couplings to increase the surface to surface contact stress for maintaining sealing contact upon expanding and plastically deforming the coupling and tubular sleeve at the overlapping portions of the first and second tubular members.

FIG. 31 is a fragmentary cross-sectional schematic illustration of an alternative embodiment of the invention in which an interior tubular sleeve is aligned with the coupling joint between tubular members and the interior tubular sleeve is forced outward and applied to the interior surfaces of the tubular members by a magnetic impulse device.

FIG. 32 is a fragmentary cross-sectional schematic illustration of a first tubular member, such as a first wellbore casing, for placement within a borehole that traverses a subterranean formation.

FIG. 33 is a fragmentary cross-sectional schematic illustration of a second tubular member, such as a second wellbore casing having a second threading coupling portion formed thereon for threaded coupling with the first tubular member or wellbore casing as depicted in FIG. 32.

FIG. 34 is a fragmentary cross-sectional illustration of the first and second wellbore casings of FIGS. 32 and 33 threadably coupled with a tubular insert interproposed between the first threaded coupling and portion and the second threaded coupling portion.

FIG. 35 is a fragmentary cross-section of the first threaded coupling of FIG. 32. The tubular insert material formed inside and coupled to the first threaded portion of the first tubular member.

FIG. 36 is a fragmentary cross sectional schematic illustration of a second tubular member with the second threaded coupling having a tubular insert applied to the exterior of the second threaded coupling.

FIG. 37 is a fragmentary cross-sectional schematic illustration of the first and second tubular members coupled together with a tubular insert assembly engaged between the threads and further showing the progressive operation of an expansion cone for expanding and plastically deforming the tubular liner formed by coupling the first and second wellbore casings.

FIG. 38 is a fragmentary cross sectional schematic illustration of a multi-layer tubular insert with two layers of materials.

FIG. 39 is a fragmentary cross sectional schematic illustration of another embodiment of a tubular insert assembly, including a first, second, and third layer of material.

FIG. 40 is a fragmentary cross sectional schematic illustration of a multi-layer tubular insert assembly having four layers of material.

FIG. 41 is a schematic cross sectional illustration of a method step of expanding the tubular member, with an expansion cone progressing toward the coupled portion of the first and second tubular member wellbore casings and the multi-layer tubular insert according to one aspect of the present invention.

FIG. 42 is a schematic cross sectional illustration of a method step of expanding the tubular member, with an expansion cone progressing past the coupled portion of the first and second tubular member wellbore casings and the multi-layer tubular insert according to one aspect of the present invention.

FIG. 43 is a fragmentary cross-sectional illustration of a first tubular threadably coupled to a second tubular.

FIG. 44 is a fragmentary cross-sectional illustration of a first tubular threadably coupled to a second tubular.

FIG. 45 illustrates a system for radially expanding a tubular member that includes a tubular assembly having first and second tubulars that are threadably coupled.

FIG. 46a is a cross-sectional illustration of the tubular assembly of the system of FIG. 1.

FIG. 46b is a front view of the tubular assembly of FIG. 46a.

FIG. 47 is a graphical illustration of the pressure integrity of the threaded connection of the tubular assembly of FIGS. 46a and 46b before, during, and after being radially expanded and plastically deformed using the system of FIG. 45.

FIG. 48 is a cross-sectional illustration of an alternative embodiment of the tubular assembly of FIG. 46a.

FIG. 49 is a cross-sectional illustration of another alternative embodiment of the tubular assembly of FIG. 46a.

FIG. 50a is a cross-sectional illustration of another alternative embodiment of the tubular assembly of FIG. 46a.

FIG. 50b is a front view of the tubular assembly of FIG. 50a.

FIG. 51 is a fragmentary cross-sectional view illustrating an embodiment of the radial expansion and plastic deformation of a portion of a first tubular member having an internally threaded connection at an end portion, an embodiment of a tubular sleeve supported by the end portion of the first tubular member, and a second tubular member having an externally threaded portion coupled to the internally threaded portion of the first tubular member and engaged by a flange of the sleeve. The sleeve includes the flange at one end for increasing axial compression loading.

FIG. 52 is a fragmentary cross-sectional view illustrating an embodiment of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes flanges at opposite ends for increasing axial tension loading.

FIG. 53 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes flanges at opposite ends for increasing axial compression/tension loading.

FIG. 54 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes flanges at opposite ends having sacrificial material thereon.

FIG. 55 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes a thin walled cylinder of sacrificial material.

FIG. 56 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes a variable thickness along the length thereof.

FIG. 57 is a fragmentary cross-sectional illustration of the radial expansion and plastic deformation of a portion of a first tubular member having an internally threaded connection at an end portion, a second tubular member having an externally threaded portion coupled to the internally threaded portion of the first tubular member, and an embodiment of a tubular sleeve supported by the end portion of both tubular members. The sleeve includes a member coiled onto grooves formed in the sleeve for varying the sleeve thickness.

FIG. 58 is a fragmentary cross-sectional illustration of an exemplary embodiment of an expandable connection.

FIGS. 59a-59c are fragmentary cross-sectional illustrations of exemplary embodiments of expandable connections.

FIG. 60 is a fragmentary cross-sectional illustration of an exemplary embodiment of an expandable connection.

FIGS. 61a and 61b are fragmentary cross-sectional illustrations of the formation of an exemplary embodiment of an expandable connection.

FIG. 62 is a fragmentary cross-sectional illustration of an exemplary embodiment of an expandable connection.

FIGS. 63a, 63b and 63c are fragmentary cross-sectional illustrations of an exemplary embodiment of an expandable connection.

FIG. 64 is a partial cross sectional view illustrating an exemplary embodiment of a preexisting structure.

FIG. 65 is a cross sectional view illustrating an exemplary embodiment of a first tubular member used with the preexisting structure of FIG. 64.

FIG. 66 is a cross sectional view illustrating an exemplary embodiment of a second tubular member used with the preexisting structure of FIG. 64 and the first tubular member of FIG. 65.

FIG. 67a is a flow chart illustrating an exemplary embodiment of a method for coupling expandable tubular members.

FIG. 67b is a cross sectional view illustrating an exemplary embodiment of the first tubular member of FIG. 65 coupled to the second tubular member of FIG. 66.

FIG. 67c is a cross sectional view illustrating an exemplary embodiment of the first tubular member and the second tubular member of FIG. 67b positioned in the preexisting structure of FIG. 64.

FIG. 67d is a cross sectional view illustrating an exemplary embodiment of the first tubular member and the second tubular member of FIG. 67c being expanded into engagement with the preexisting structure.

FIG. 67e is a cross sectional view illustrating an exemplary embodiment of the first tubular member and the second tubular member of FIG. 67c being expanded into engagement with the preexisting structure.

FIG. 68 is a cross sectional view illustrating an alternative embodiment of the first tubular member of FIG. 65 including an interference fit feature.

FIG. 69 is a cross sectional view illustrating an alternative embodiment of the second tubular member of FIG. 66 including an interference fit feature.

FIG. 70 is a cross sectional view illustrating an exemplary embodiment of the first tubular member of FIG. 68 coupled to the second tubular member of FIG. 69.

FIG. 71 is a cross sectional view illustrating an exemplary embodiment of the first tubular member of FIG. 65 including an insert.

FIG. 72 is a cross sectional view illustrating an exemplary embodiment of the first tubular member of FIG. 71 coupled to the second tubular member of FIG. 66.

### DETAILED DESCRIPTION OF THE ILLUSTRATIVE EMBODIMENTS

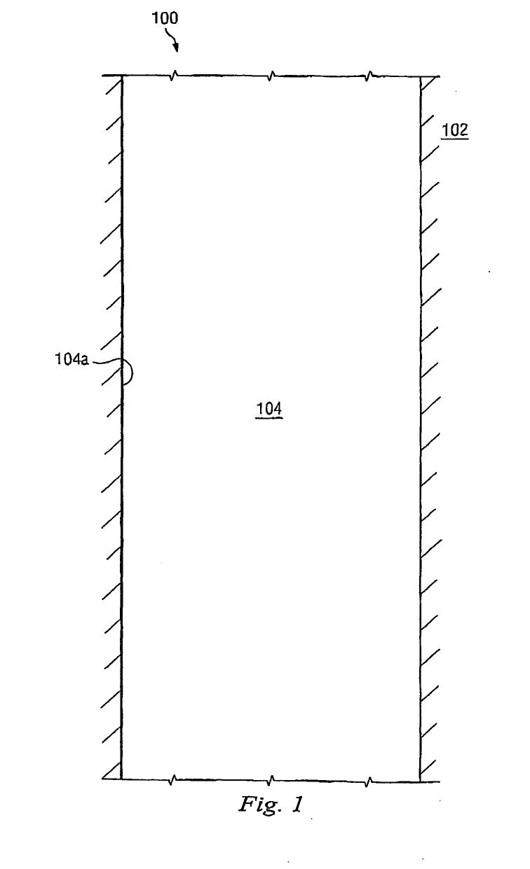

Referring now to FIG. 1, a wellbore 100 is illustrated. Wellbore 100 includes a volume of earth 102 which defines a passageway 104 extending through the earth 102. The passageway 104 includes passageway surface 104a which defines an outer edge of the passageway 104. In an exemplary embodiment, the wellbore 100 is formed using conventional drilling methods known in the art. In an exemplary embodiment, the wellbore 100 may be a cased hole.

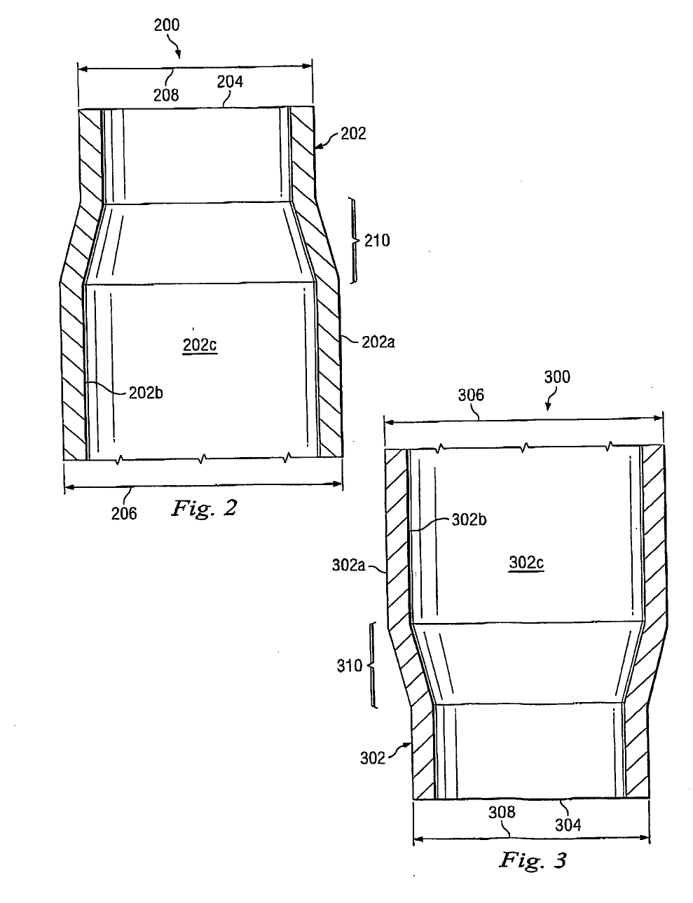

Referring now to FIG. 2, an expandable tubular member 200 is illustrated. The expandable tubular member 200 includes a base 202 having an outer surface 202a, an inner surface 202b located opposite the outer surface 202a, and defining a passageway 202c extending along the length of the base 202. Expandable tubular member 200 includes a connection end 204 located on a distal end of the base 202. Expandable tubular member 200 has an outside diameter which decreases from a maximum outside diameter 206 along a length of the base 202 to an outside diameter 208 located adjacent the connection end 204. In an embodiment, the expandable tubular member 200 decreases in diameter over a length 210 of the base 202. In an exemplary embodiment, the expandable tubular member 200 is fabricated from a metal material.

Referring now to FIG. 3, an expandable tubular member 300 is illustrated. The expandable tubular member 300 includes a base 302 having an outer surface 302a, an inner surface 302b located opposite the outer surface 302a, and defining a passageway 302c extending along the length of the base 302. Expandable tubular member 300 includes a connection end 304 located on a distal end of the base 302. Expandable tubular member 300 has an outside diameter which decreases from a maximum outside diameter 306 along a length of the base 302 to an outside diameter 308 located adjacent the connection end 304. In an embodiment, the expandable tubular member 300 decreases in diameter over a length 310 of the base 302. In an exemplary embodiment, the expandable tubular member 300 is fabricated from a metal material.

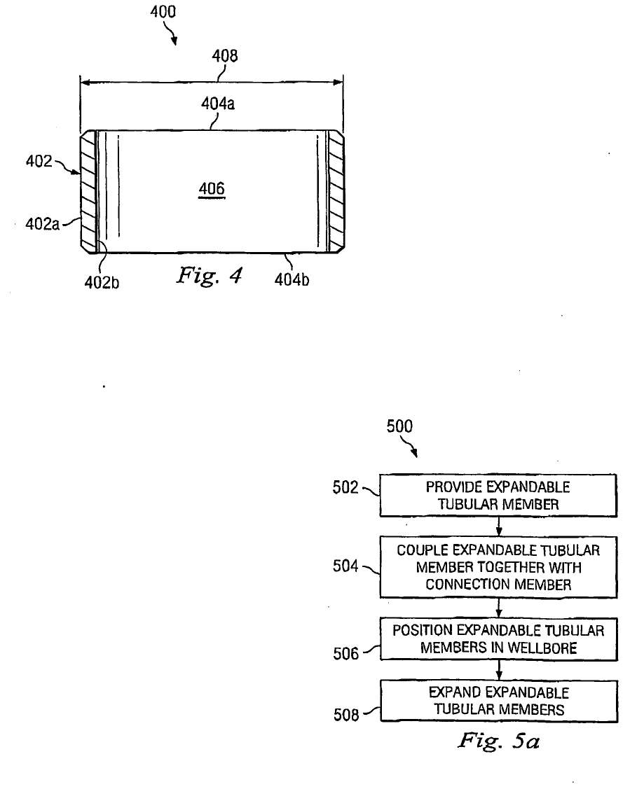

Referring now to FIG. 4, a connection member 400 is illustrated. Connection member 400 includes a tubular base 402 having an outer surface 402a and an inner surface 402b located opposite the outer surface 402a. A pair of opposing distal ends 404a and 404b are included on opposite sides of the tubular base 402. A passageway 406 is defined by the tubular base 402 and located along the length of the tubular base 402 between distal ends 404a and 404b. The tubular base 402 has a connection member diameter 408 along the length of the tubular base 402. In an exemplary embodiment, the connection member 400 may be a variety of conventional connection members known in the art for coupling expandable tubular members. In an exemplary embodiment, the connection member 400 is fabricated from a metal material.

Referring now to FIGS. 2, 3, 4, 5a, 5b, and 5c, a method 500 for coupling expandable tubular members is illustrated. The method 500 begins at step 502 where the expandable tubular member 200 and the expandable tubular member 300 are provided. The expandable tubular member 200 is positioned adjacent the expandable tubular member 300 such that the connection end 204 on expandable tubular member 200 is adjacent the connection end 304 on expandable tubular member 300.

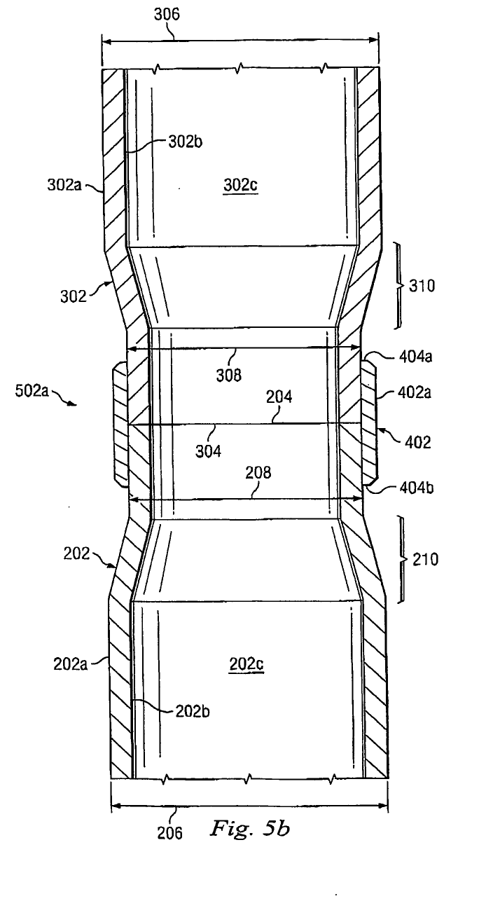

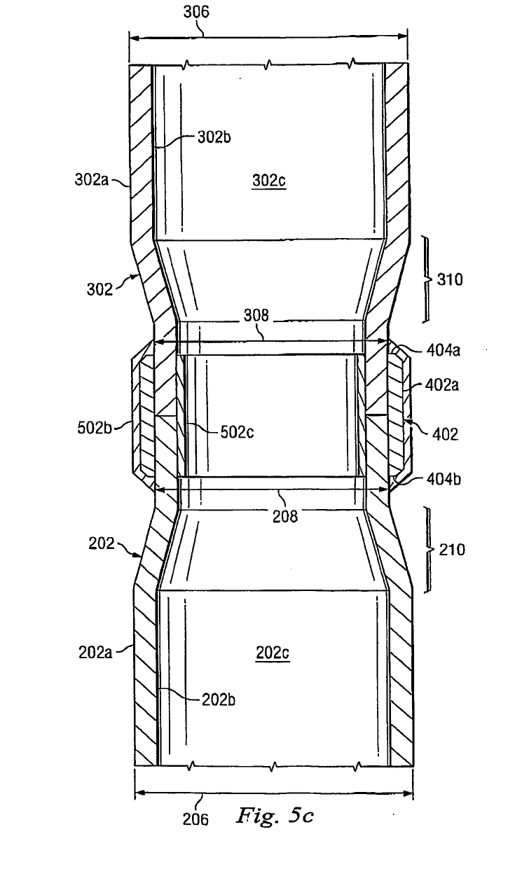

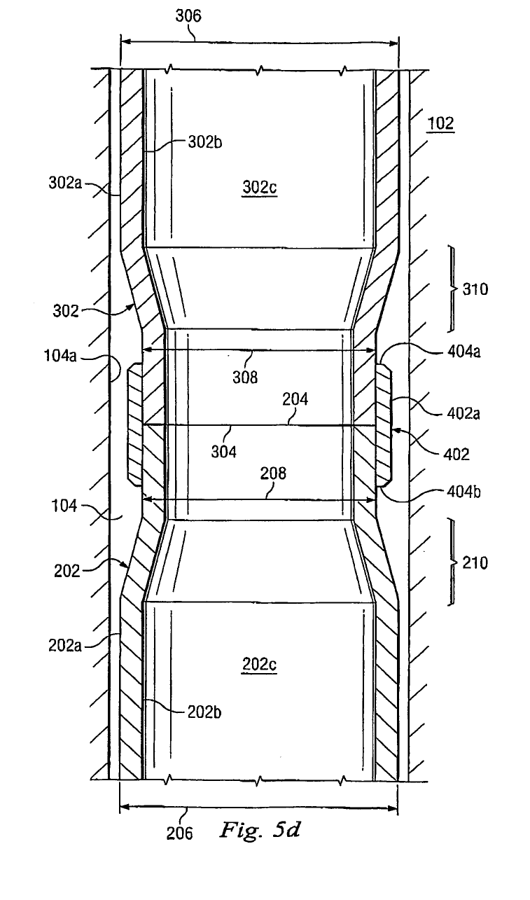

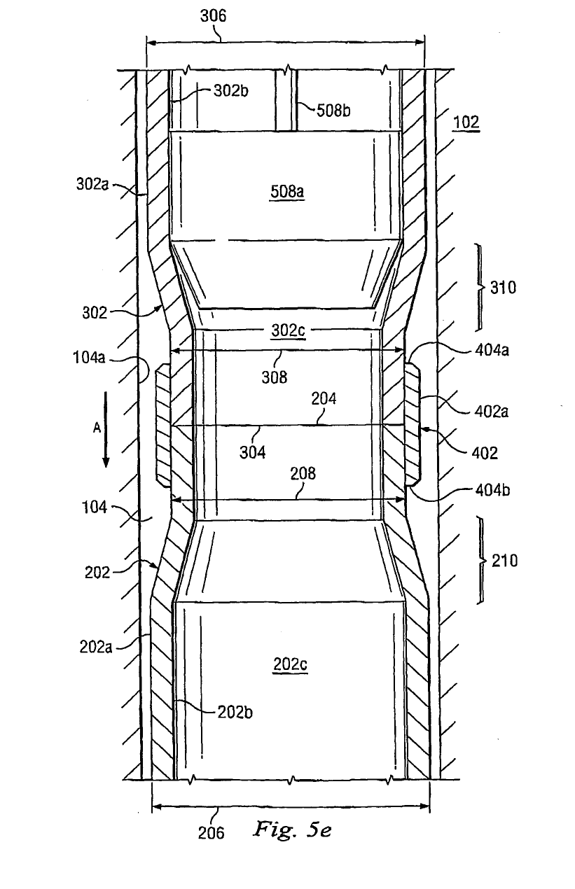

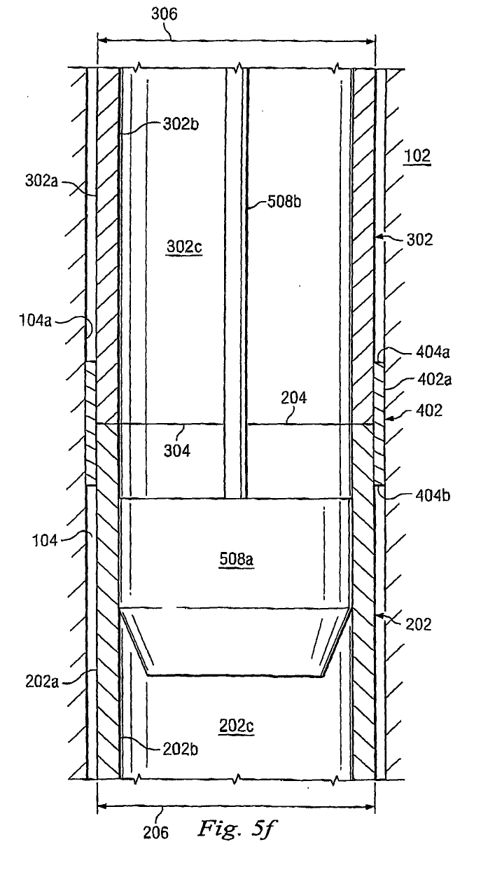

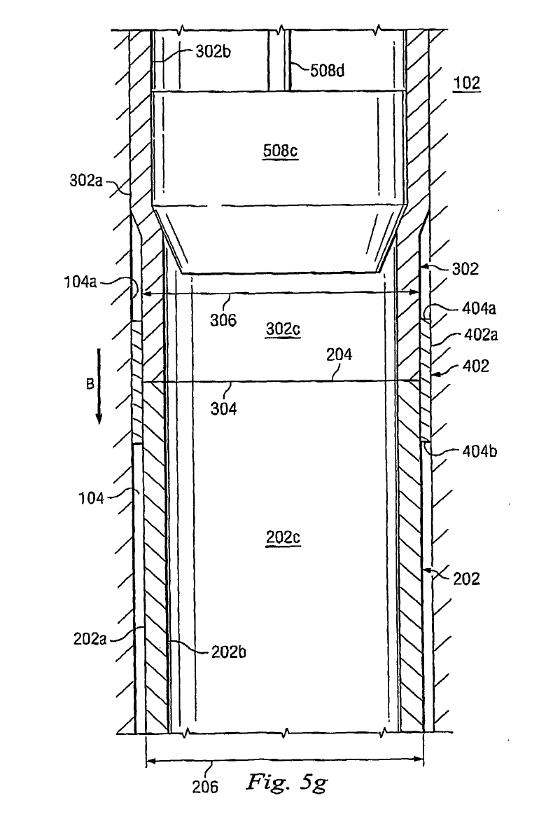

The method 500 then proceeds to step 504 where the expandable tubular members 200 and 300 are coupled together with the connection member 400. The connection member 400 is engaged with the expandable tubular member 200 such that the inner surface 402b of the connection member 400 engages the outer surface 202a of the expandable tubular member 200 adjacent the connection end 204. The connection member 400 is then engaged with the expandable tubular member 300 such that the inner surface 402b of the connection member 400 engages the outer surface 302a of the expandable tubular member 300 adjacent the connection end 304. With the connection member 400 engaging the expandable tubular members 200 and 300, the connection ends 204 and 304 or expandable tubular members 200 and 300, respectively, are positioned in the passageway 406 on connection member 400 and engage each other, as illustrated in FIG. 5b. In an exemplary embodiment, the expandable tubular members 200 and 300 are coupled together by the engagement of the connection ends 204 and 304, respectively, such as, for example, using a convention threaded connection, and/or the engagement of the connection member 400 with the expandable tubular members 200 and 300 using convention methods known in the art. In an exemplary embodiment, the engagement of the expandable tubular members 200 and 300 and the connection member 400 provides a gas and liquid tight seal between the expandable tubular members 200 and 300 and the connection member 400. In an exemplary embodiment, the engagement of the expandable tubular members 200 and 300 and the connection member 400 provides a metal to metal seal between the expandable tubular members 200 and 300 and the connection member 400.

With the connection member 400 engaging the expandable tubular members 200 and 300, an expandable tubular member 502a is provided in which the connection member diameter 408 is not substantially greater than the maximum outside diameter 206 on the expandable tubular member 200 or the maximum outside diameter 306 on the expandable tubular member 300. Thus, an expandable tubular member 502a is provided which has a maximum diameter that is the maximum diameter of the expandable tubular members 200 or 300 which are coupled together to form the expandable tubular member 502a, rather than the diameter of the connection member 400 which couples together the expandable tubular members 200 and 300. In an exemplary embodiment, an outer protective sleeve 502b may be coupled to the outer surface 402a of the connection member 400 and an inner protective sleeve 502c may be coupled to the inner surfaces 202b and 302b of the expandable tubular members 200 and 300, respectively, adjacent the connection ends 204 and 304, respectively, as illustrated in FIG. 5c.

Referring now to FIGS. 1, 5a, 5b, and 5d, the method 500 proceeds to step 506 where the expandable tubular members 200 and 300 are positioned in the wellbore 100. The expandable tubular member 502a is positioned in the passageway 104 on wellbore 100, as illustrated in FIG. 5d. The passageway 104 may be dimensioned such that there is only a small amount of space between the passageway surface 104a and the outer surfaces 202a, 302a, and 402a of the expandable tubular member 200, the expandable tubular member 300, and the connection member 400, respectively. However, relatively large diameter expandable tubular members 200 and 300 may be used with the wellbore 100 because the coupling of the expandable tubular members 200 and 300 with the connection member 400 does not increase the outside diameter of the expandable tubular member 502a. This allows larger diameter expandable tubular members 200 and 300 to be coupled together and used in the wellbore 100 than is possible using conventional coupling methods.

Referring now to FIGS. 1, 5a, 5b, 5e, 5f, and 5g, the method proceeds to step 508 where the expandable tubular members 200 and 300 are radially expanded and plastically deformed. An expansion device 508a which is coupled to a drill string 508b is provided which has larger outside diameter than the inside diameters of the portions of the expandable tubular members 200 and 300 with outside diameters 208 and 308, respectively. The expansion device 508a is positioned in the expandable tubular member 502b and moved in a direction A, as illustrated in FIG. 5e. Movement of the expansion device 508a in direction A expands the length 310 of the expandable tubular member 300 and the portion of the expandable tubular member 300 with outside diameter 308 to a inside diameter equal to the outside diameter of the expansion device 508a.

Continued movement of the expansion device 508a in direction A expands the length 210 of the expandable tubular member 200 and the portion of the expandable tubular member 200 with outside diameter 208 to a inside diameter equal to the outside diameter of the expansion device 508a, as illustrated in FIG. 5f. In an exemplary embodiment, the expansion device 508a may be a fixed diameter expansion device, a rotary expansion device, a hydroforming device, combinations thereof, and/or a variety of other expansion devices known in the art.

Thus, the expandable tubular member 502a may be positioned in a wellbore 100 with tight clearance between the expandable tubular member 502a and the passageway surface 104a and then radially expanded and plastically deformed to a monodiameter tubular member. In an exemplary embodiment, an expansion device 508c which is coupled to a drill string 50db is provided which has larger outside diameter than the inside diameters of the portions of the expandable tubular members 200 and 300 with maximum outside diameters 206 and 306, respectively. The expansion device 508c is then moved in a direction B, radially expanding and plastically deforming the expandable tubular member 502a into engagement with the passageway surface 104a of wellbore 100, as illustrated in FIG. 5g. In an exemplary embodiment, the expansion device 508c may be a fixed diameter expansion device, a rotary expansion device, a hydroforming device, combinations thereof, and/or a variety of other expansion devices known in the art. Thus, the expandable tubular member 502a may be positioned in a wellbore 100 with tight clearance between the expandable tubular member 502a and the passageway surface 104a and then radially expanded and plastically deformed into engagement with the passageway surface 104a of the wellbore 104.

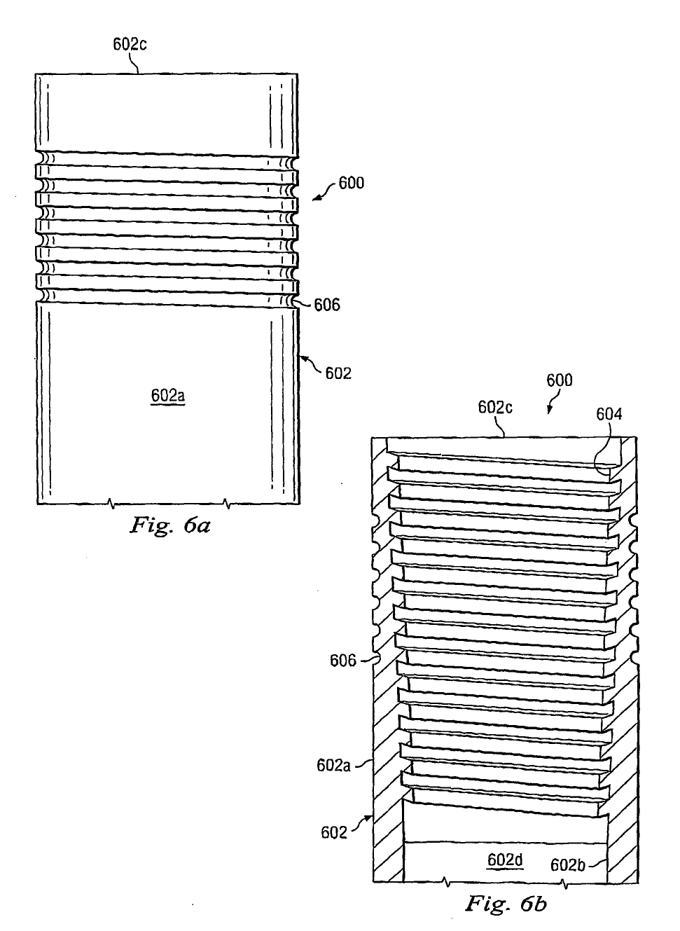

Referring now to FIGS. 6a and 6b, an expandable tubular member 600 is illustrated. The expandable tubular member 600 includes a tubular base 602 having an outer surface 602a, and inner surface 602b located opposite the outer surface 602a, a distal end 602c, and defining a passageway 602d extending along its length of the tubular base 602 to the distal end 602c. A plurality of thread members, which may be conventional thread members known in the art, such as, for example, thread member 604, extend from the inner surface 602b of the tubular base 602 into the passageway 602d and are located circumferentially about the inner surface 602b. A stress concentrator is provided on the expandable tubular member 600 and may include a plurality of expansion channels such as, for example, expansion channel 606, which are defined by the tubular base 602 and located helically about the outer surface 602a and adjacent the plurality of thread members such as, for example, the thread member 604. In an embodiment, the expandable tubular member 600 is fabricated from a metal material.

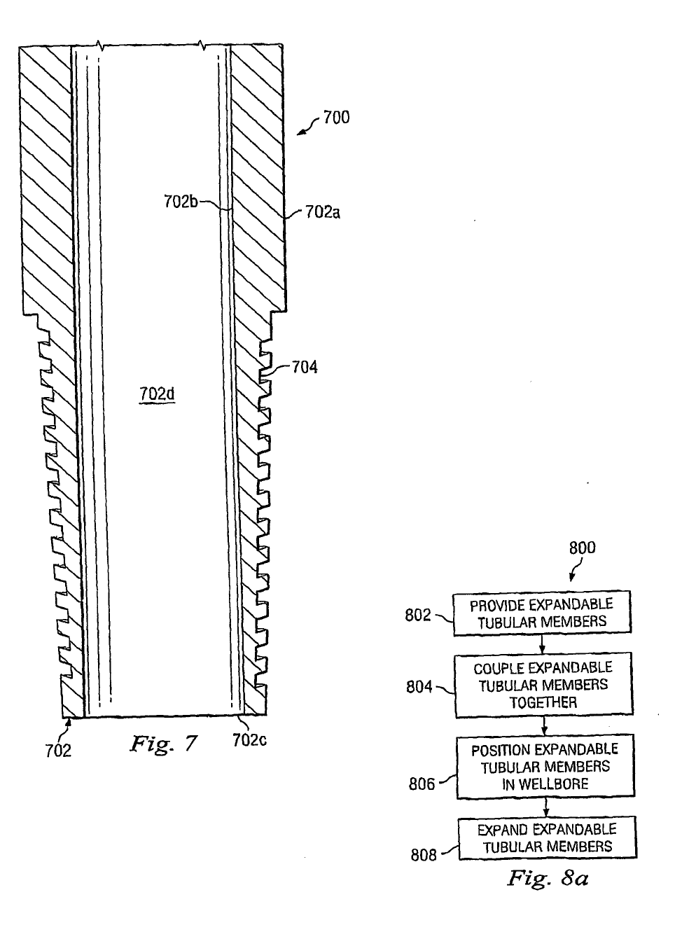

Referring now to FIG. 7, an expandable tubular member 700 is illustrated. Expandable tubular member 700 includes a tubular base 702 having an outer surface 702a, an inner surface 702b located opposite the outer surface 702a, a distal end 702c, and defining a passageway 702d which extends from the distal end 702c and along the length of the tubular base 702. A plurality of thread channels, which may be conventional thread channels known in the art, such as, for example, the thread channel 704, are defined by the tubular base 702 and located circumferentially about the outer surface 702a. In an embodiment, the expandable tubular member 700 is fabricated from a metal material.

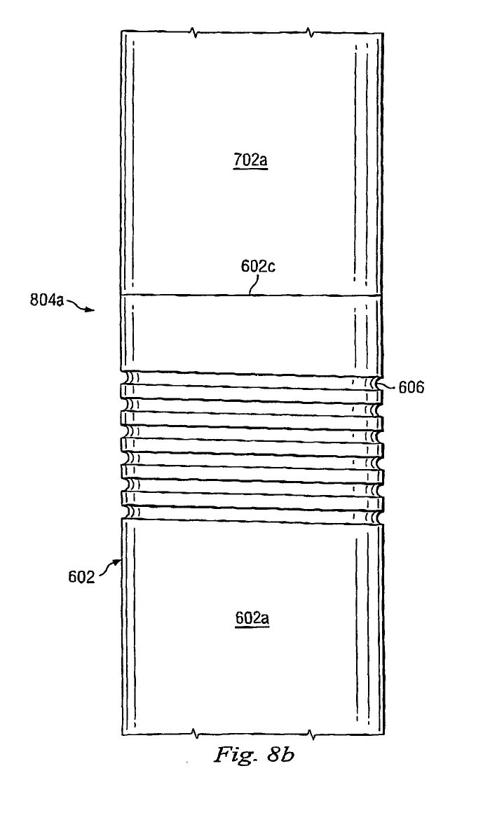

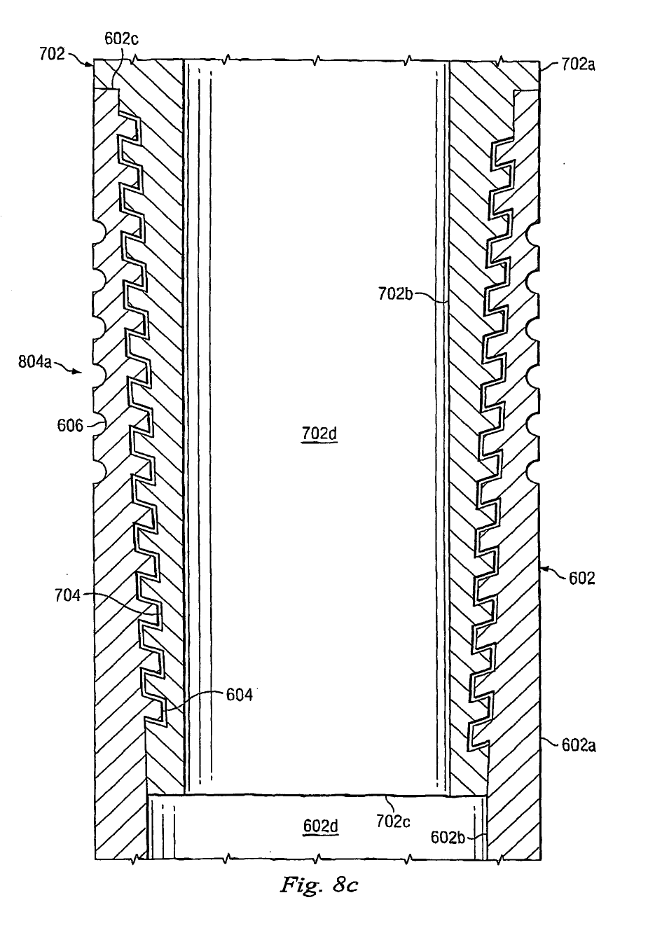

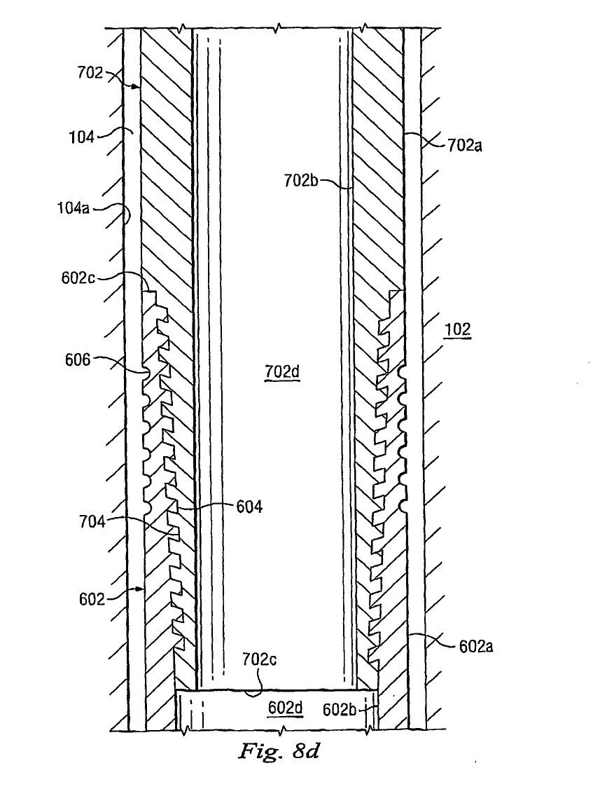

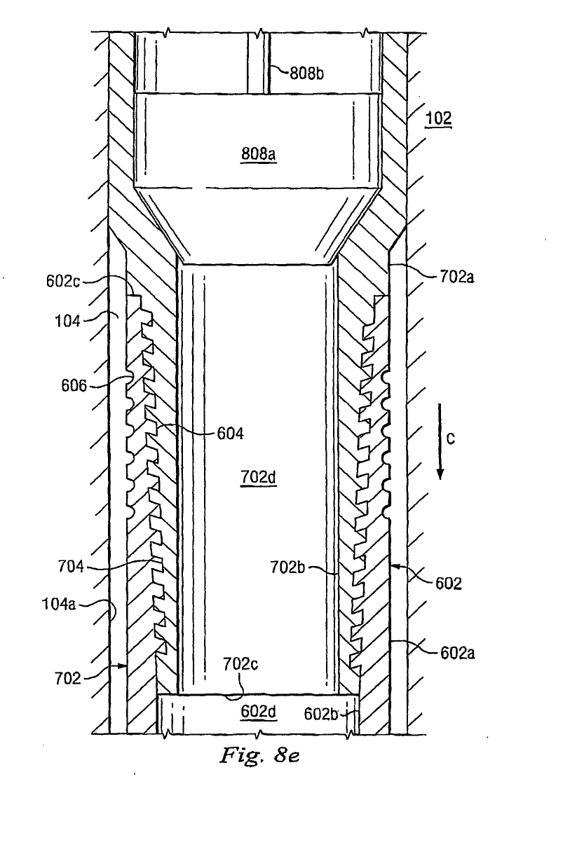

Referring now to FIGS. 6a, 6b, 7, 8a, 8b, and 8c, a method 800 for coupling expandable tubular members is illustrated. The method 800 begins at step 802 where the expandable tubular members 600 and 700, illustrated in FIGS. 6a, 6b, and 7, are provided. The method 800 then proceeds to step 804 where the expandable tubular members 600 and 700 are coupled together. The expandable tubular member 600 is positioned adjacent the expandable tubular member 700 such that the distal end 602c on expandable tubular member 600 is adjacent the distal end 702c on expandable tubular member 700. The distal end 702c on expandable tubular member 700 is then positioned in the passageway 602d on expandable tubular member 600 such that the plurality of thread members such as, for example, the thread member 604, engage the plurality of thread channels such as, for example, the thread channel 704, as illustrated in FIG. 8c, providing an expandable tubular member 804a.

Referring now to FIGS. 1, 8a, and 8d, the method 800 then proceeds to step 806 where the expandable tubular members 600 and 700 are positioned in the wellbore 100. The expandable tubular member 804a is positioned in the passageway 104 of wellbore 100 such that the outer surfaces 602a and 702a of the expandable tubular members 600 and 700, respectively, are positioned adjacent the passageway surface 104a, as illustrated in FIG. 8d.

Referring now to FIGS. 8a, 8b, 8e, 8f, and 8g, the method 800 proceeds to step 808 where the expandable tubular members 600 and 700 are radially expanded and plastically deformed. An expansion device 808a which is coupled to a drill string 808b is provided which has larger outside diameter than the inside diameters of the expandable tubular members 600 and 700. The expansion device 808a is positioned in the expandable tubular member 804a and moved in a direction C, as illustrated in FIG. 8e. Movement of the expansion device 808a in direction C expands the expandable tubular members 600 and 700 such that the outer surfaces 602a and 702a, respectively, engage the passageway surface 104a of the wellbore 100. In an exemplary embodiment, the expansion device 808a may be a fixed diameter expansion device, a rotary expansion device, a hydroforming device, combinations thereof, and/or a variety of other expansion devices known in the art. Furthermore, the expansion of the expandable tubular member 804a between the distal ends 602c and 702c on expandable tubular members 600 and 700, respectively, results in the deformation of the plurality of thread members in the plurality of thread channels.

With the provision of the stress concentrator, shown as the plurality of expansion channels in this embodiment, the deformation of the plurality of thread members in the plurality of thread channels is increased relative to the deformation of a thread member in a thread channel without the stress concentrator. For example, during deformation, the expansion channel 606 allows increased deformation of the thread member 604 in the thread channel 704 by increasing the stress experienced by the thread member 604 during radial expansion and plastic deformation of the expandable tubular members 600 and 700 and increasing the deformation of the thread member 604, as illustrated in FIG. 8f, which provides a gas and liquid tight seal between the expandable tubular members 600 and 700. In an exemplary embodiment, the gas and liquid tight seal provided between the expandable tubular members 600 and 700 is a metal to metal seal.

Thus, a method and apparatus are provided which provide stress concentrations on the expandable tubular members 600 and 700 in order increase the deformation of thread members in thread channels such as, for example, the thread member 604 in the thread channel 704, to provide a seal between the thread member 604 and the thread channel 704 after the expansion of coupled together expandable tubular members 600 and 700. In an exemplary embodiment, the stress concentrator provided on the expandable tubular member 804a is a circumferential and helical stress concentration 810, as illustrated in FIG. 8g. In an exemplary embodiment, the stress concentrator may provide a variety of stress concentrations with different geometries such as, for example, point to point stress concentrations, discrete stress concentrations, and/or continuous stress concentrations.

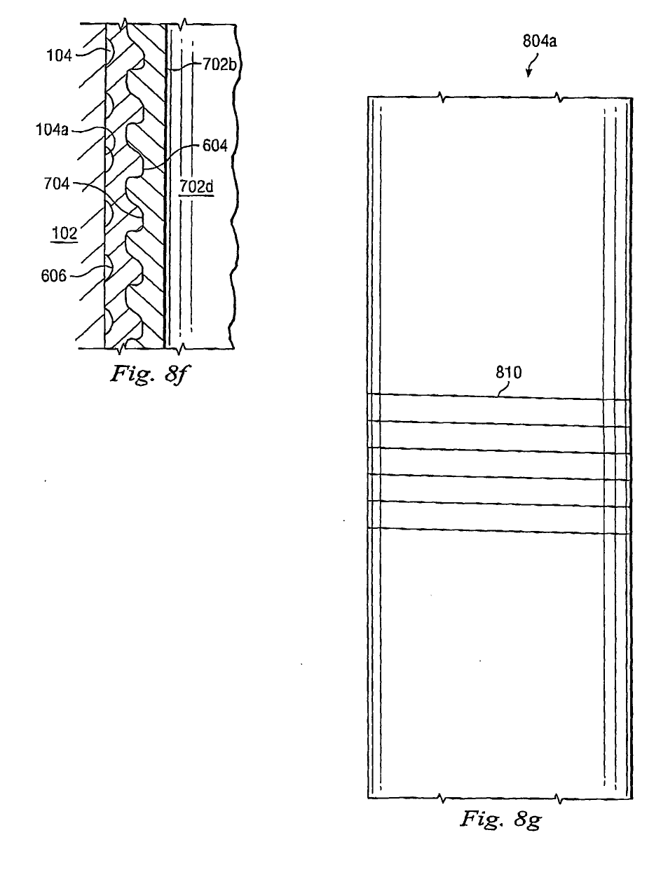

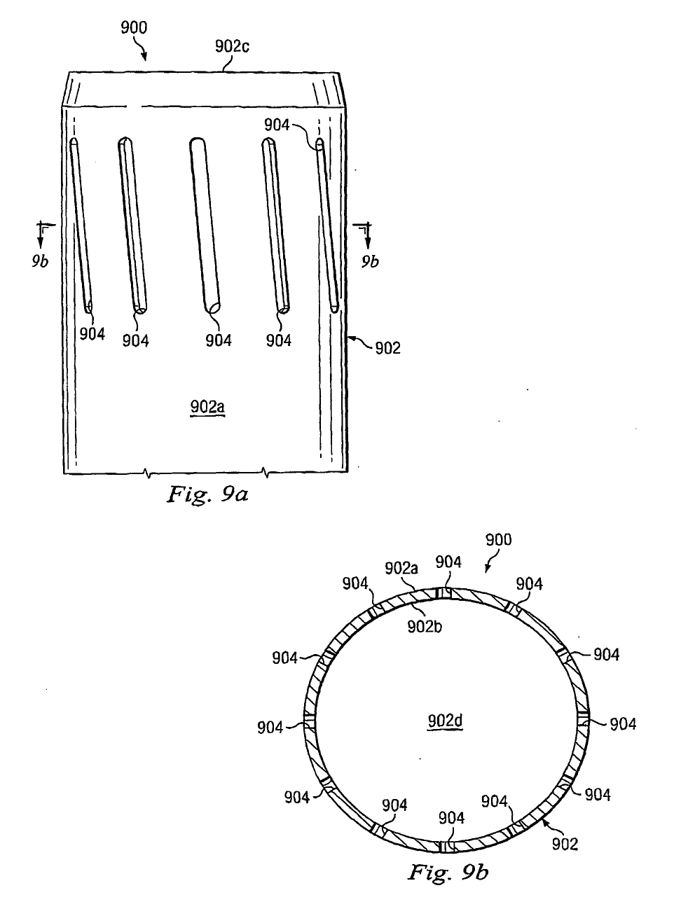

Referring now to FIGS. 9a and 9b, a connection sleeve 900 is illustrated. The connection sleeve 900 includes a tubular base 902 having an outer surface 902a, an inner surface 902b located opposite the outer surface 902a, a distal end 902c, and a passageway 902d which extends from the distal end 902c and along the length of the tubular base 902. A stress concentrator is provided on the connection sleeve 900 and may include a plurality of expansion slots 904 defined by the tubular base 902, extending from the outer surface 902a to the inner surface 902b, and located in a substantially axially orientation with respect to the tubular base 902 and spaced apart circumferentially about the tubular base 902. In an exemplary embodiment, the connection sleeve 900 is fabricated from a metal material.

Referring now to FIGS. 6a, 6b, 7, 9a, 9b, 10a, and 10b, a method 1000 for coupling expandable tubular members is illustrated. The method 1000 begins at step 1002 where the expandable tubular members 600 and 700 and the connection sleeve, illustrated in FIGS. 6a, 6b, 7, 9a and 9b, are provided.

The method 1000 then proceeds to step 1004 where the expandable tubular members 600 and 700 are coupled together. The distal end 602c of expandable tubular member 600 is positioned in the passageway 902d on the connection sleeve 900 such that the inner surface 902b of the connection sleeve 900 engages the outer surface 602a of the expandable tubular member 600. With the connection sleeve 900 coupled to the expandable tubular member 600, the expansion slots 904 on connection sleeve 900 are oriented substantially perpendicularly to the plurality of expansion channels such as, for example, expansion channel 606 on expandable tubular member 600. Coupling the connection sleeve 900 to the expandable tubular member 600 provides a plurality of discrete point stress concentrators located at the intersection of the expansion slots 904 and the expansion channels.

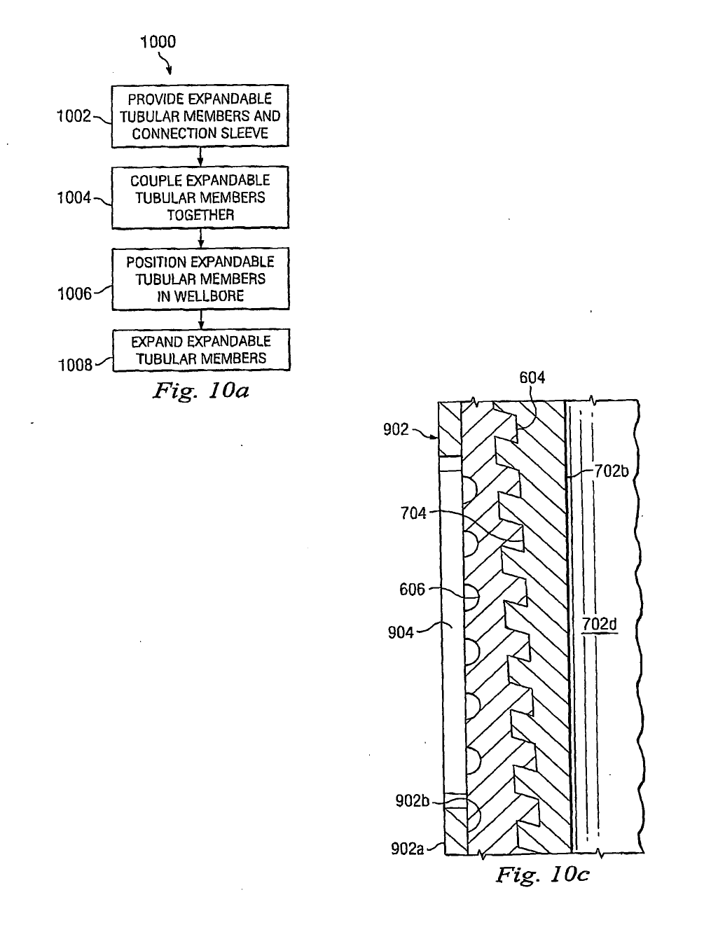

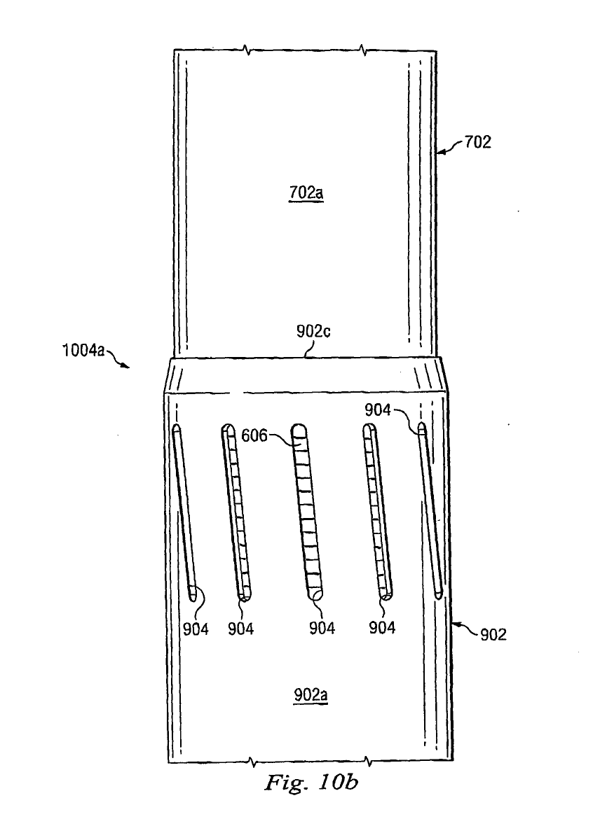

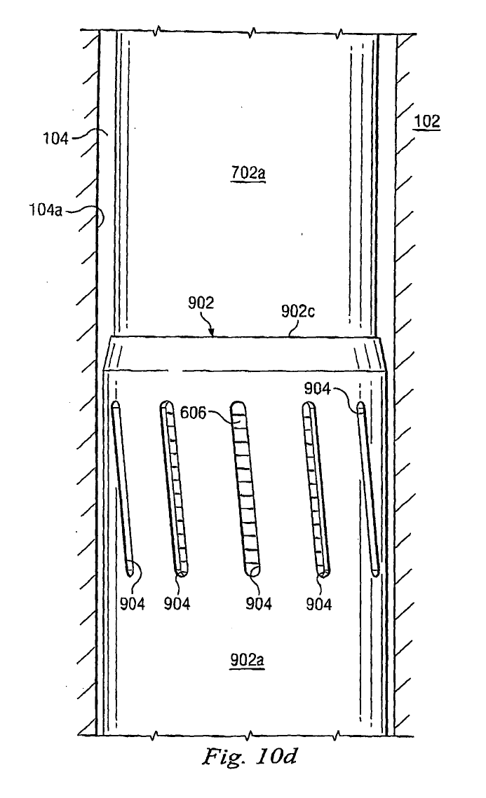

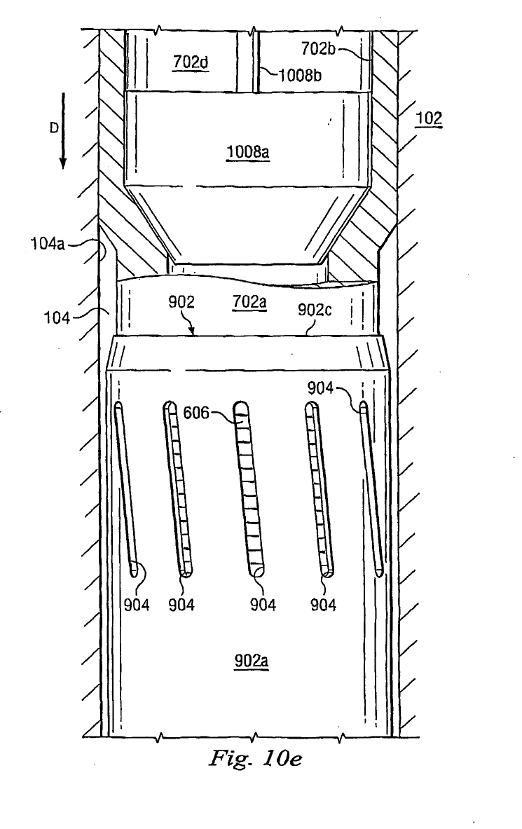

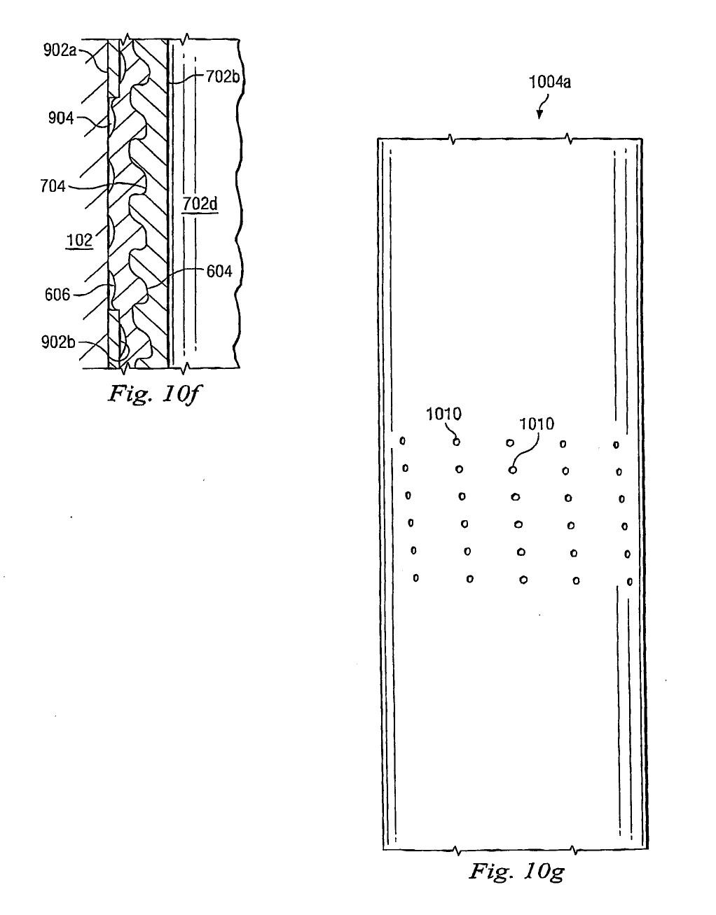

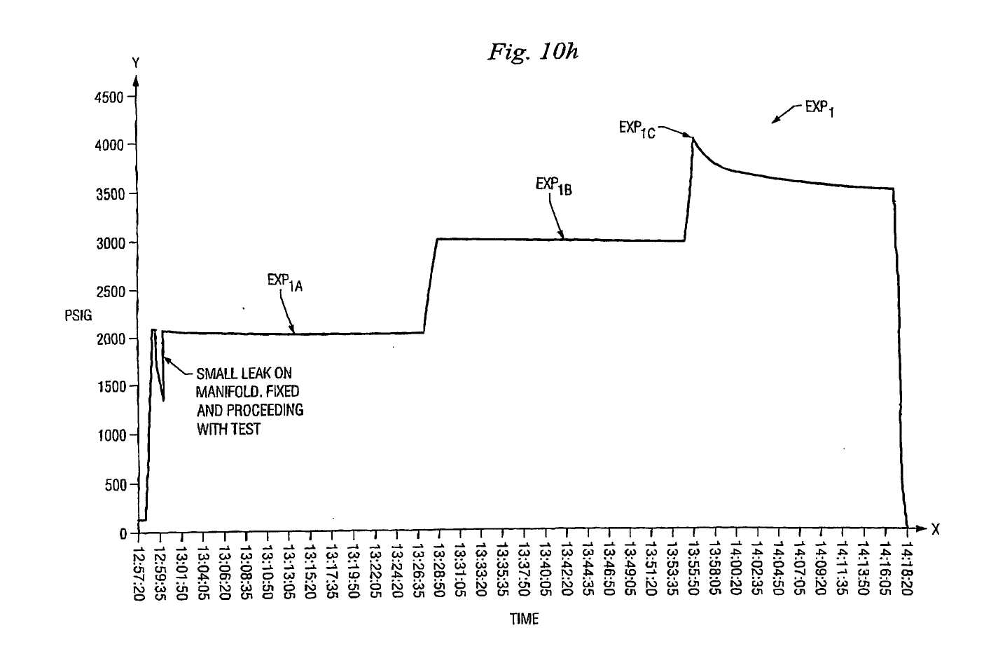

The expandable tubular member 600 and connection sleeve 900 are then positioned adjacent the expandable tubular member 700 such that the distal ends 602c and 902c on the expandable tubular member 600 and connection sleeve 900, respectively, are adjacent the distal end 702c on expandable tubular member 700. The distal end 702c on expandable tubular member 700 is then positioned in the passageway 602d on expandable tubular member 600 such that the plurality of thread members such as, for example, the thread member 604, engage the plurality of thread channels such as, for example, the thread channel 704, and are positioned adjacent the expansion slot 904, as illustrated in FIG. 10c, providing an expandable tubular member 1004a.

Referring now to FIGS. 1, 10a, and 10d, the method 1000 then proceeds to step 1006 where the expandable tubular members 600 and 700 and the connection sleeve 900 are positioned in the wellbore 100. The expandable tubular member 1004a is positioned in the passageway 104 of wellbore 100 such that the outer surface 902a of the connection sleeve 900 and the outer surfaces 602a and 702a of the expandable tubular members 700, respectively, are positioned adjacent the passageway surface 104a, as illustrated in FIG. 10d.

Referring now to FIGS. 10a, 10b, 10e, 10f, and 10g, the method 1000 proceeds to step 1008 where the expandable tubular members 600 and 700 and the connection sleeve 900 are radially expanded and plastically deformed. An expansion device 1008a which is coupled to a drill string 1008b is provided which has larger outside diameter than the inside diameters of the expandable tubular members 600 and 700. The expansion device 1008a is positioned in the expandable tubular member 1004a and moved in a direction D, as illustrated in FIG. 10e. Movement of the expansion device 1008a in direction D expands the expandable tubular members 600 and 700 and the connection sleeve 900 such that the outer surfaces 602a, 702a, and 902a, respectively, engage the passageway surface 104a of the wellbore 100. In an exemplary embodiment, the expansion device 808a may be a fixed diameter expansion device, a rotary expansion device, a hydroforming device, combinations thereof, and/or a variety of other expansion devices known in the art. Furthermore, the expansion of the expandable tubular member 1004a between the distal ends 902c and 702c on the connection sleeve 900 and the expandable tubular member 700, respectively, results in the deformation of the plurality of thread members in the plurality of thread channels.

With the provision of the discrete point stress concentrators, shown as the intersection of the expansion slots 904 and the expansion channels, the deformation of the plurality of thread members in the plurality of thread channels is increased relative to the deformation of a thread member in a thread channel without the discrete point stress concentrators. For example, during deformation, the expansion channel 606 and the expansion slot 904 allow increased deformation of the thread member 604 in the thread channel 704 by increasing the stress experienced by the thread member 604 during radial expansion and plastic deformation of the expandable tubular members 600 and 700 and increasing the deformation of the thread member 604, as illustrated in FIG. 10f, which provides a gas and liquid tight seal between the expandable tubular members 600 and 700. In an exemplary embodiment, the gas and liquid tight seal provided between the expandable tubular members 600 and 700 is a metal to metal seal.

Thus, a method and apparatus are provided which provide stress concentrations on the expandable tubular member 1004a in order increase the deformation of thread members in thread channels such as, for example, the thread member 604 in the thread channel 704, to provide a seal between the thread member 604 and the thread channel 704 after the expansion of coupled together expandable tubular members 600 and 700. In an exemplary embodiment, the stress concentrator may provide stress concentrations on the expandable tubular member 1004a in discrete point stress concentrations 1010, illustrated in FIG. 10g. In an exemplary embodiment, the stress concentrator may provide stress concentrations on the expandable tubular member 1004a in variety of different manners on the expandable tubular members such as circumferential stress concentrations, point to point stress concentrations, discrete stress concentrations, and/or continuous stress concentrations. In an exemplary embodiment, the connection sleeve 900 increases the compression limits of the connection between the expandable tubular members 600 and 700 between thread member 604 and the thread channel 704.

Referring now to FIG. 10h, in an experimental embodiment EXP₁, an expandable tubular member substantially similar to the expandable tubular member 1004a, described above with reference to FIGS. 10b, 10c, 10d, 10e, 10f and 10g, was provided and radially expanded and plastically deformed in substantially the same manner as described above. The ends of the expandable tubular members 600 and 700 were capped, and the pressure in the passageways 602a and 702a of expandable tubular members 600 and 700, respectively, was increased to test the gas and liquid tight seal between the thread member 604 and the thread channel 704 on the expandable tubular members 600 and 700, respectively. The pressure was first increased to a pressure EXP_{1A}, which was approximately 2000 psig, and the pressure held constant for a time period. The pressure was then increased to a pressure EXP_{1B}, which was approximately 3000 psig, and the pressure held constant for a time period. This was an unexpected result, as seal failure was expected for this combination of expandable tubular members 600 and 700 including the connection sleeve 900 at 3000 psig. The pressure was then increased to a pressure EXP_{1C}, which was approximately 4000 psig, above which the seal failed. Thus, a method and apparatus have been provided which provides a seal between coupled and radially expanded and plastically deformed expandable tubular members 600 and 700 and connection sleeve 900 that can withstand increased pressure without failing relative to conventional coupling methods.

Referring now to FIG. 11, an expandable tubular member 1100 is illustrated. The expandable tubular member 1100 includes a tubular base 1102 having an outer surface 1102a, and inner surface 1102b located opposite the outer surface 1102a, a distal end 1102c, and defining a passageway 1102d extending along its length of the tubular base 1102 to the distal end 1102c. A plurality of flange members 1104 extend from the inner surface 1102b of the tubular base 1102 and into the passageway 1102d. In an exemplary embodiment, the expandable tubular member 1100 is fabricated from metal material.

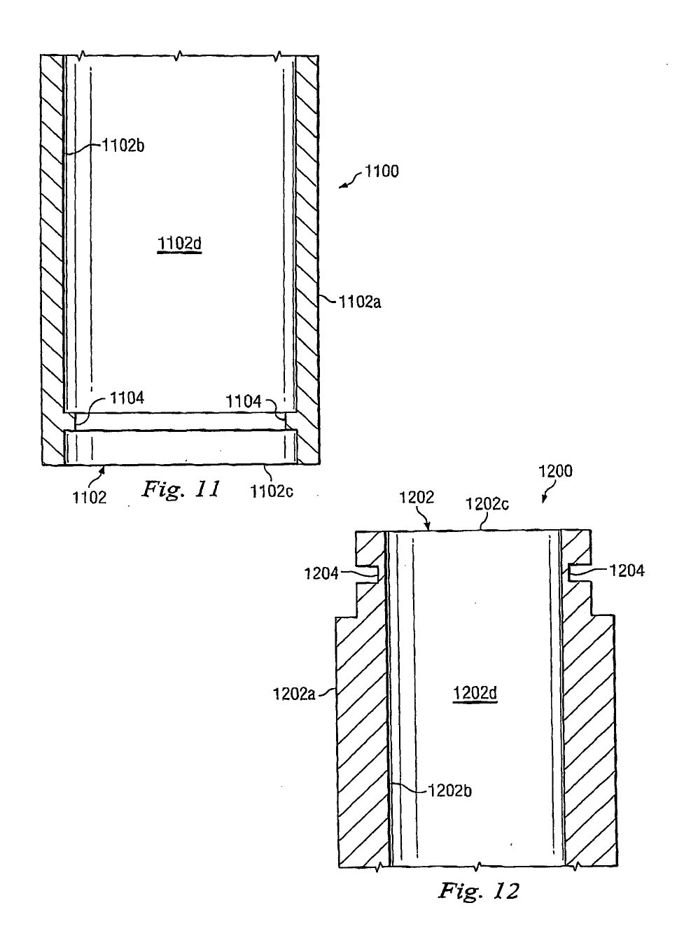

Referring now to FIG. 12, an expandable tubular member 1200 is illustrated. The expandable tubular member 1200 includes a tubular base 1202 having an outer surface 1202a, and inner surface 1202b located opposite the outer surface 1202a, a distal end 1202c, and defining a passageway 1202d extending along its length of the tubular base 1202 to the distal end 1202c. A plurality of flange channels 1204 are defined by the tubular base 1202 and located on the outer surface 1202a of the tubular base 1202. In an exemplary embodiment, the expandable tubular member 1200 is fabricated from metal material.

Referring now to FIGS. 11, 12, 13a, 13b, and 13c, a method 1300 for coupling expandable tubular members is illustrated. The method 1300 begins at step 1302 where the expandable tubular members 1100 and 1200, illustrated in FIGS. 11 and 12, are provided. The method 1300 then proceeds to step 1304 where the expandable tubular members 1100 and 1200 are coupled together. A wave spring resilient member 1304a is positioned in the flange channels 1204 and about the circumference of the expandable tubular member 1200. In an exemplary embodiment, the wave spring resilient member 1304a is fabricated from a metal material.

The expandable tubular member 1100 is then coupled to the expandable tubular member 1200 by positioning the flange members 1104 in the flange channels 1204. In an exemplary embodiment, the flange members 1104 are positioned in the flange channels 1204 by heating the expandable tubular member 1100, causing the expandable tubular member 1100 to expand, which increases the diameter of the passageway 1102d and allows the distal end of expandable tubular member 1200 to be positioned in the passageway 1102d of the expandable tubular member 1100. In an exemplary embodiment, the flange members 1104 are positioned in the flange channels 1204 by forcing the distal end of expandable tubular member 1200 into the passageway 1102d of the expandable tubular member 1100, causing the expandable tubular member 1100 to elastically deform to allow the distal end of expandable tubular member 1200 to be positioned in the passageway 1102d of the expandable tubular member 1100. In an exemplary embodiment, the flange members 1104 are conventional thread members known in the art and the flange channels 1204 are conventional thread channels known in the art, and the flange members 1104 are positioned in the flange channels 1204 by threading the thread members into the thread channels. In an exemplary embodiment, the flange members 1104 may be positioned in the flange channels 1204 using a variety of other conventional methods known in the art.

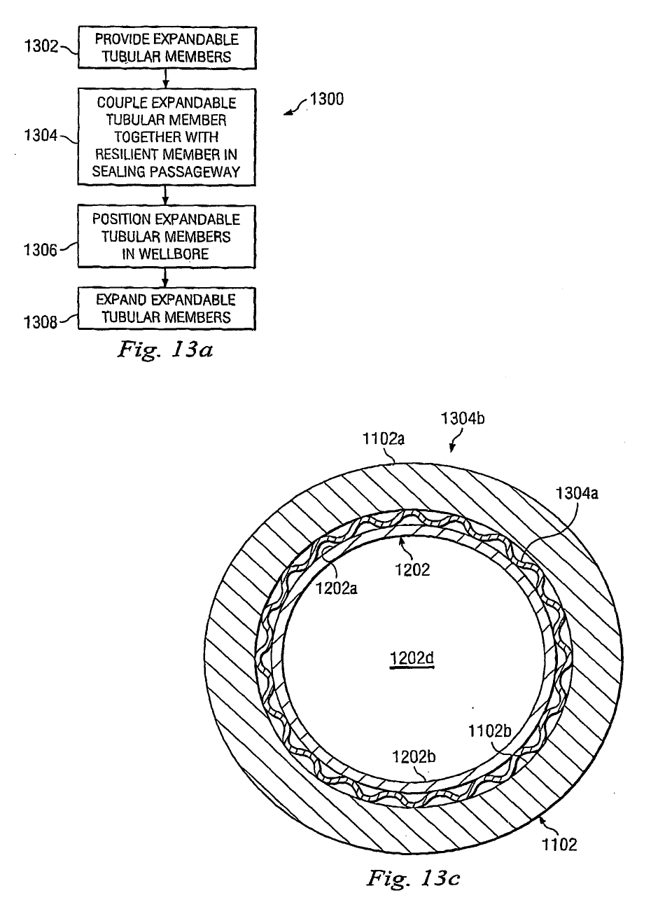

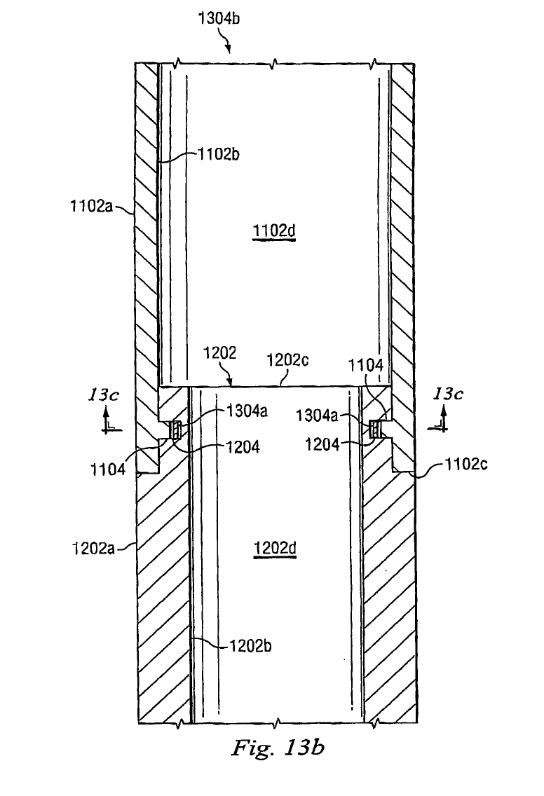

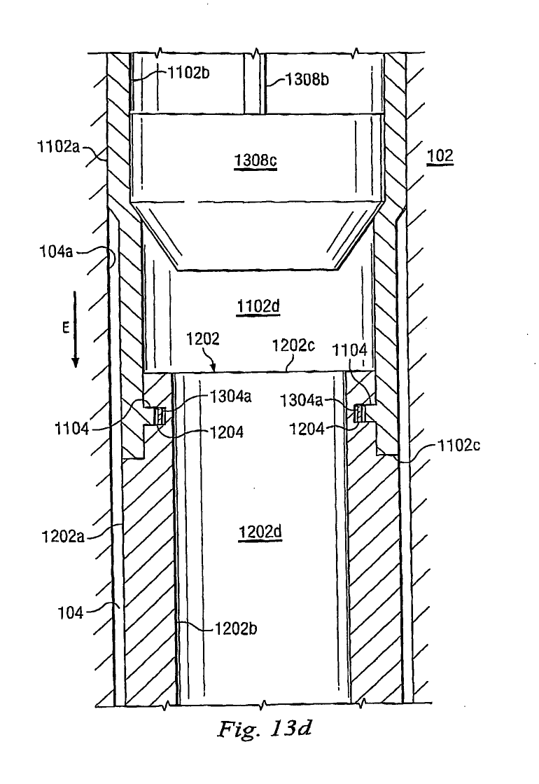

With the expandable tubular member 1200 coupled to the expandable tubular member 1100, a sealing channel is defined between the flange member 1104 and the flange channel 1204 and the wave spring resilient member 1304a is positioned in the sealing channel, as illustrated in FIGS. 13b and 13c. With the expandable tubular member 1100 coupled to the expandable tubular member 1200, an expandable tubular member 1304b is provided.

Referring now to FIGS. 1, 13a, 13d, and 13e, the method 1300 then proceeds to step 1306 where the expandable tubular members 1100 and 1200 are positioned in the wellbore 100. The expandable tubular member 1304b is positioned in the passageway 104 of wellbore 100 such that outer surfaces 1102a and 1202a of the expandable tubular members 1100 and 1200, respectively, are positioned adjacent the passageway surface 104a, as illustrated in FIG. 13d.

The method 1300 proceeds to step 1308 where the expandable tubular members 1100 and 1200 are radially expanded and plastically deformed. An expansion device 1308a which is coupled to a drill string 1308b is provided which has larger outside diameter than the inside diameters of the expandable tubular members 1100 and 1200. The expansion device 1308a is positioned in the expandable tubular member 1304b and moved in a direction E, as illustrated in FIG. 13d. Movement of the expansion device 1308a in direction E expands the expandable tubular members 1100 and 1200 such that the outer surfaces 1102a and 1202a, respectively, engage the passageway surface 104a of the wellbore 100. In an exemplary embodiment, the expansion device 1308a may be a fixed diameter expansion device, a rotary expansion device, a hydroforming device, combinations thereof, and/or a variety of other expansion devices known in the art. Furthermore, the expansion of the expandable tubular member 1304b adjacent the flange member 1104 and the flange channel 1204 results in the deformation of the wave spring resilient member 1304a. Deformation of the wave spring resilient member 1304a provides a gas and liquid tight seal between the expandable tubular members 1100 and 1200. In an exemplary embodiment, the gas and liquid tight seal provided between the expandable tubular members 1100 and 1200 is a metal to metal seal. Thus, a method and apparatus are provided which provide a gas and liquid tight seal between two expandable tubular members 1100 and 1200 which are coupled together and radially expanded and plastically deformed.

Referring now to FIGS. 11, 12, 14a, 14b, and 14c, a method 1400 for coupling expandable tubular members is illustrated. The method 1400 begins at step 1402 where the expandable tubular members 1100 and 1200, illustrated in FIGS. 11 and 12, are provided. The method 1400 then proceeds to step 1404 where the expandable tubular members 1100 and 1200 are coupled together. A wave spring resilient member 1404a is positioned in the flange channels 1204 and about the circumference of the expandable tubular member 1200. In an exemplary embodiment, the wave spring resilient member 1404a is fabricated from a metal material.

The expandable tubular member 1100 is then coupled to the expandable tubular member 1200 by positioning the flange members 1204 in the flange channels 1204. In an exemplary embodiment, the flange members 1104 are positioned in the flange channels 1204 by heating the expandable tubular member 1100, causing the expandable tubular member 1100 to expand, which increases the diameter of the passageway 1202d and allows the distal end of expandable tubular member 1200 to be positioned in the passageway 1202d of the expandable tubular member 1100. In an exemplary embodiment, the flange members 1104 are positioned in the flange channels 1204 by forcing the distal end of expandable tubular member 1200 into the passageway 1202d of the expandable tubular member 1100, causing the expandable tubular member 1100 to elastically deform to allow the distal end of expandable tubular member 1200 to be positioned in the passageway 1202d of the expandable tubular member 1100. In an exemplary embodiment, the flange members 1104 are conventional thread members known in the art and the flange channels 1204 are conventional thread channels known in the art, and the flange members 1104 are positioned in the flange channels 1204 by threading the thread members into the thread channels. In an exemplary embodiment, the flange members 1104 may be positioned in the flange channels 1204 using a variety of other conventional methods known in the art.

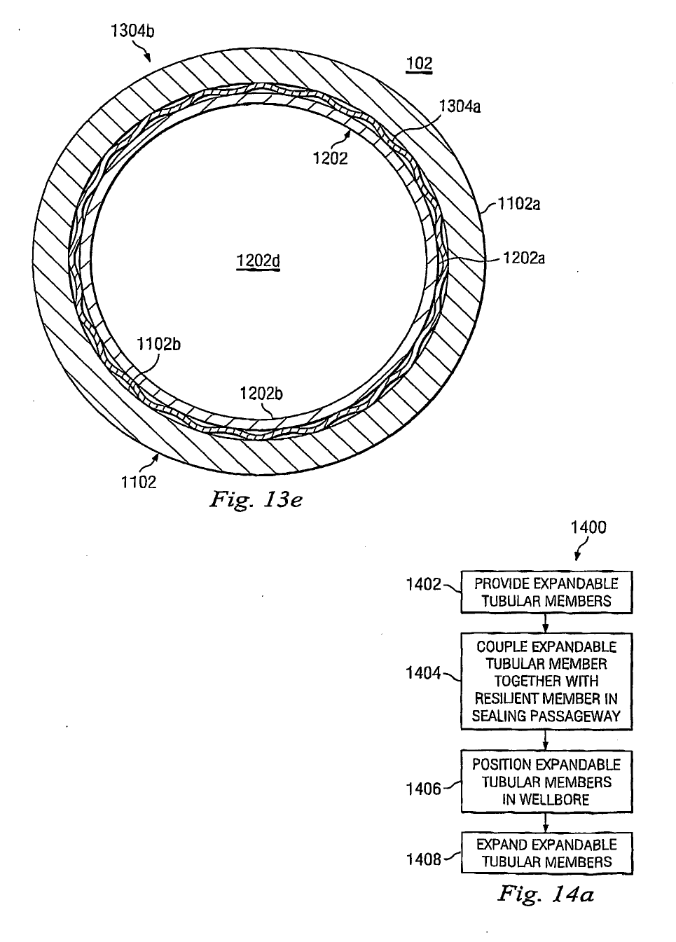

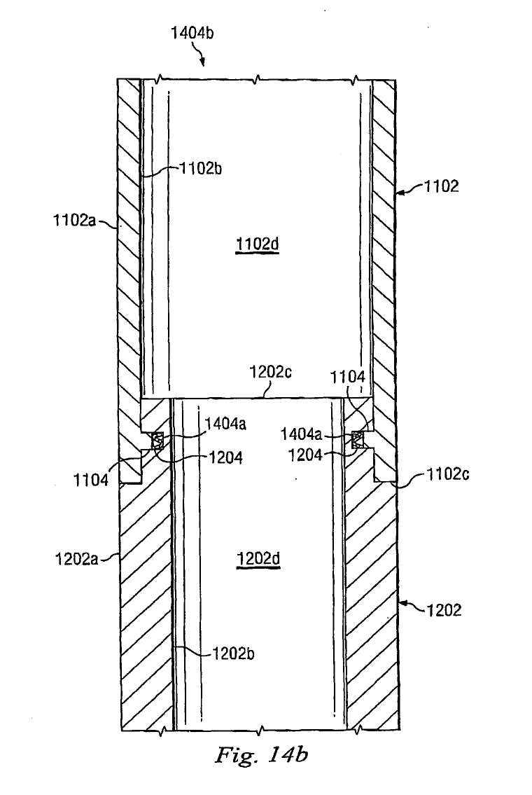

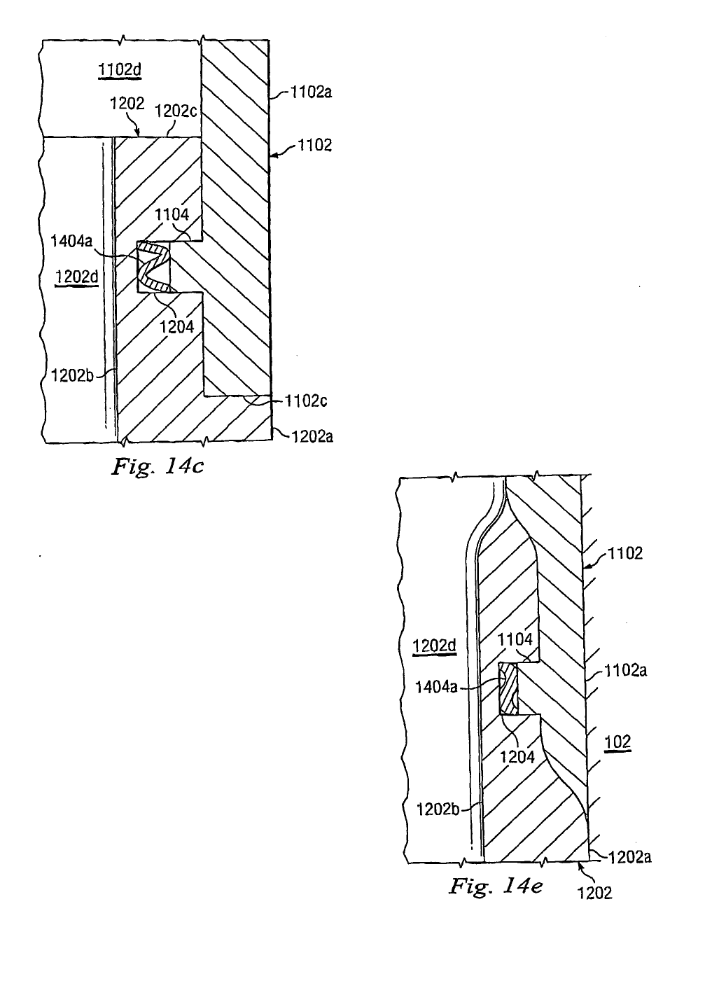

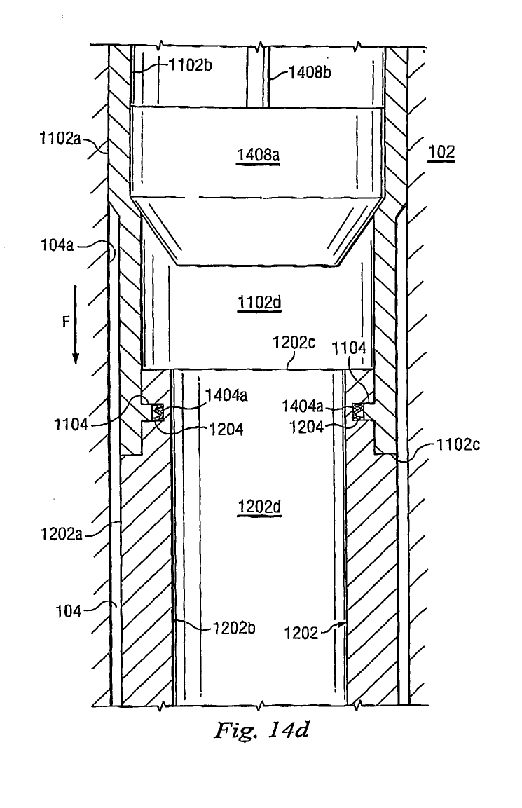

With the expandable tubular member 1200 coupled to the expandable tubular member 1100, a sealing channel is defined between the flange member 1104 and the flange channel 1204 and the wave spring resilient member 1404a is positioned in the sealing channel, as illustrated in FIGS. 14b and 14c. With the expandable tubular member 1100 coupled to the expandable tubular member 1200, an expandable tubular member 1404b is provided.

Referring now to FIGS. 1, 14a, 14d, and 14e, the method 1400 then proceeds to step 1406 where the expandable tubular members 1100 and 1200 are positioned in the wellbore 100. The expandable tubular member 1404b is positioned in the passageway 104 of wellbore 100 such that outer surfaces 1102a and 1202a of the expandable tubular members 1100 and 1200, respectively, are positioned adjacent the passageway surface 104a, as illustrated in FIG. 14d.

The method 1400 proceeds to step 1408 where The expandable tubular members 1100 and 1200 are radially expanded and plastically deformed. An expansion device 1408a which is coupled to a drill string 1408b is provided which has larger outside diameter than the inside diameters of the expandable tubular members 1100 and 1200. The expansion device 1408a is positioned in the expandable tubular member 1404b and moved in a direction F, as illustrated in FIG. 14d. Movement of the expansion device 1408a in direction F expands the expandable tubular members 1100 and 1200 such that the outer surfaces 1102a and 1202a, respectively, engage the passageway surface 104a of the wellbore 100. In an exemplary embodiment, the expansion device 1408a may be a fixed diameter expansion device, a rotary expansion device, a hydroforming device, combinations thereof, and/or a variety of other expansion devices known in the art. Furthermore, the expansion of the expandable tubular member 1404b adjacent the flange member 1104 and the flange channel 1204 results in the deformation of the wave spring resilient member 1404a. Deformation of the wave spring resilient member 1404a provides a gas and liquid tight seal between the expandable tubular members 1100 and 1200. In an exemplary embodiment, the gas and liquid tight seal provided between the expandable tubular members 1100 and 1200 is a metal to metal seal. Thus, a method and apparatus are provided which provide a gas and liquid tight seal between two expandable tubular members 1100 and 1200 which are coupled together and radially expanded and plastically deformed.

Referring now to FIGS. 11, 12, 15a, 15b, and 15c, a method 1500 for coupling expandable tubular members is illustrated. The method 1500 begins at step 1502 where the expandable tubular members 1100 and 1200, illustrated in FIGS. 11 and 12, are provided. The method 1500 then proceeds to step 1504 where the expandable tubular members 1100 and 1200 are coupled together. An O-ring resilient member 1504a is positioned in the flange channels 1204 and about the circumference of the expandable tubular member 1200. In an exemplary embodiment, the O-ring resilient member 1504a is fabricated from a metal material.

The expandable tubular member 1100 is then coupled to the expandable tubular member 1200 by positioning the flange members 1104 in the flange channels 1204. In an exemplary embodiment, the flange members 1104 are positioned in the flange channels 1204 by heating the expandable tubular member 1100, causing the expandable tubular member 1100 to expand, which increases the diameter of the passageway 1102d and allows the distal end of expandable tubular member 1200 to be positioned in the passageway 1102d of the expandable tubular member 1100. In an exemplary embodiment, the flange members 1104 are positioned in the flange channels 1204 by forcing the distal end of expandable tubular member 1200 into the passageway 1102d of the expandable tubular member 1100, causing the expandable tubular member 1100 to elastically deform to allow the distal end of expandable tubular member 1200.to be positioned in the passageway 1102d of the expandable tubular member 1100. In an exemplary embodiment, the flange members 1104 are conventional thread members known in the art and the flange channels 1204 are conventional thread channels known in the art, and the flange members 1104 are positioned in the flange channels 1204 by threading the thread members into the thread channels. In an exemplary embodiment, the flange members 1104 may be positioned in the flange channels 1204 using a variety of other conventional methods known in the art.

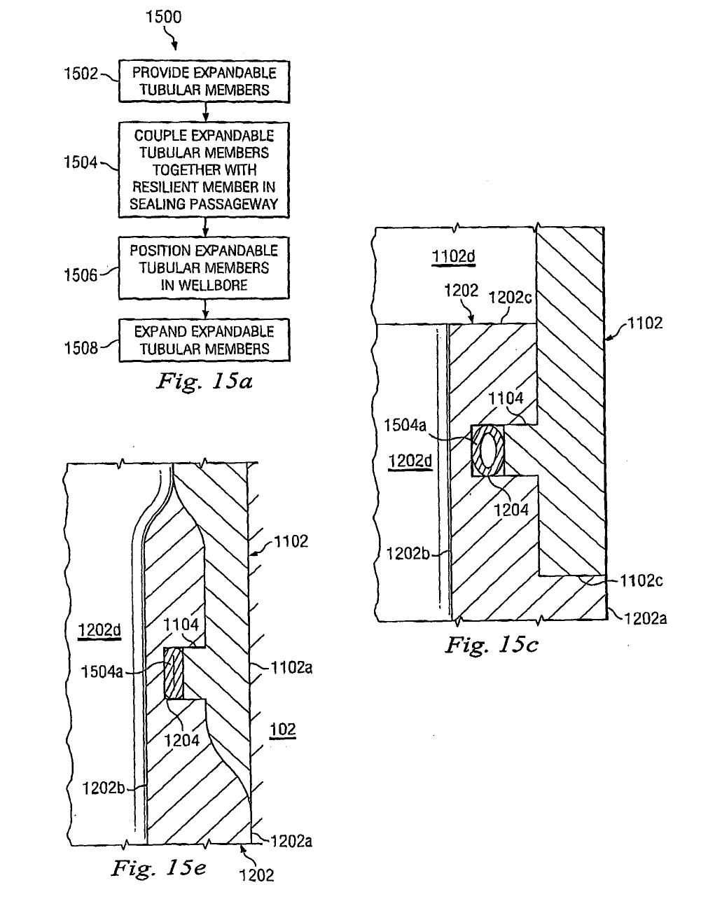

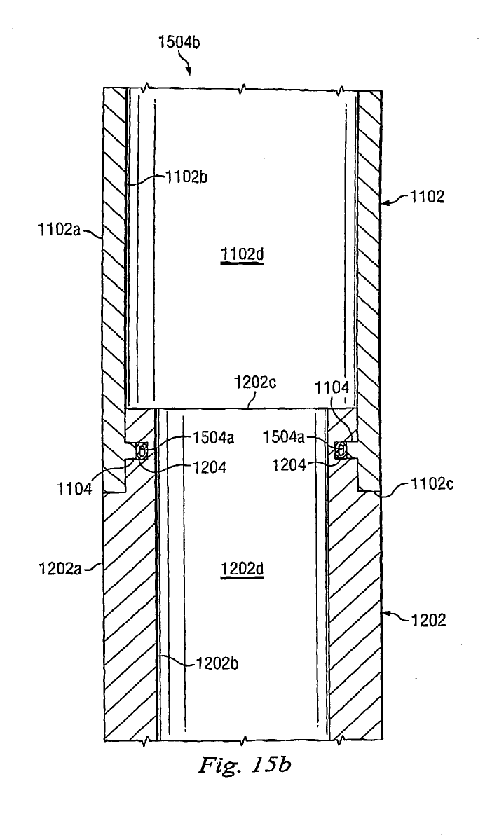

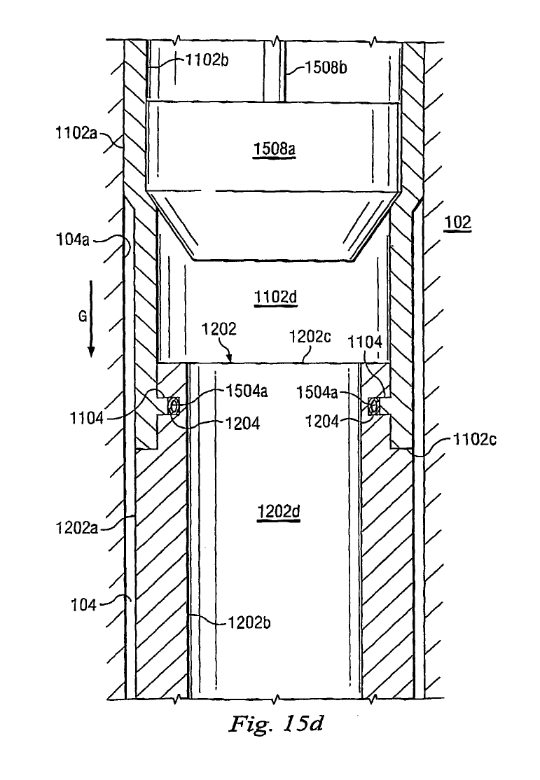

With the expandable tubular member 1200 coupled to the expandable tubular member 1100, a sealing channel is defined between the flange member 1104 and the flange channel 1204 and the O-ring resilient member 1504a is positioned in the sealing channel, as illustrated in FIGS. 15b and 15c. With the expandable tubular member 1100 coupled to the expandable tubular member 1200, an expandable tubular member 1504b is provided.

Referring now to FIGS. 1, 15a, 15d, and 15e, the method 1500 then proceeds to step 1506 where the expandable tubular members 1100 and 1200 are positioned in the wellbore 100. The expandable tubular member 1504b is positioned in the passageway 104 of wellbore 100 such that outer surfaces 1102a and 1202a of the expandable tubular members 1100 and 1200, respectively, are positioned adjacent the passageway surface 104a, as illustrated in FIG. 15d. The method 1500 proceeds to step 1508 where the expandable tubular members 1100 and 1200 are radially expanded and plastically deformed. An expansion device 1508a which is coupled to a drill string 1508b is provided which has larger outside diameter than the inside diameters of the expandable tubular members 1100 and 1200. The expansion device 1508a is positioned in the expandable tubular member 1504b and moved in a direction G, as illustrated in FIG. 15d. Movement of the expansion device 1508a in direction G expands the expandable tubular members 1100 and 1200 such that the outer surfaces 1102a and 1202a, respectively, engage the pasageway surface 104a of the wellbore 100. In an exemplary embodiment, the expansion device 1508a may be a fixed diameter expansion device, a rotary expansion device, a hydroforming device, combinations thereof, and/or a variety of other expansion devices known in the art. Furthermore, the expansion of the expandable tubular member 1504b adjacent the flange member 1104 and the flange channel 1204 results in the deformation of the O-ring resilient member 1504a. Deformation of the O-ring resilient member 1504a provides a gas and liquid tight seal between the expandable tubular members 1100 and 1200. In an exemplary embodiment, the gas and liquid tight seal provided between the expandable tubular members 1100 and 1200 is a metal to metal seal. Thus, a method and apparatus are provided which provide a gas and liquid tight seal between two expandable tubular members 1100 and 1200 which are coupled together and radially expanded and plastically deformed.

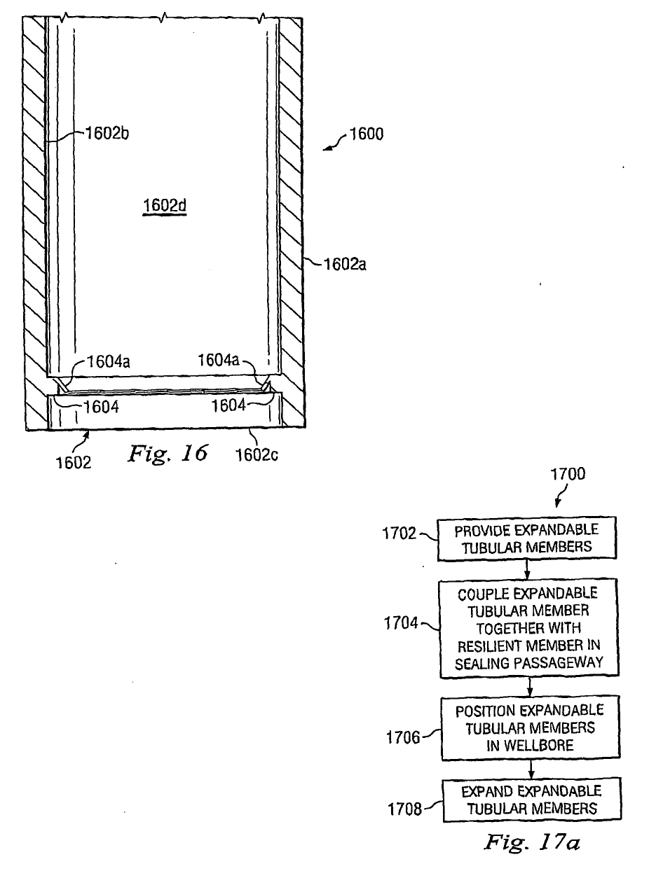

Referring now to FIG. 16, an expandable tubular member 1600 is illustrated. The expandable tubular member 1600 includes a tubular base 1602 having an outer surface 1602a, and inner surface 1602b located opposite the outer surface 1602a, a distal end 1602c, and defining a passageway 1602d extending along its length of the tubular base 1602 to the distal end 1602c. A plurality of flange members 1604 extend from the inner surface 1602b of the tubular base 1602 and into the passageway 1602d, each flange member 1604 including a resilient beam 1604a extending from a distal end of the flange member 1604 at an angle with respect to the flange member 1604 and into the passageway 1602d. In an exemplary embodiment, the expandable tubular member 1600 is fabricated from a metal material.

Referring now to FIGS. 12, 16, 17a, 17b, and 17c, a method 1700 for coupling expandable tubular members is illustrated. The method 1700 begins at step 1702 where the expandable tubular members 1200 and 1600, illustrated in FIGS. 12 and 16, are provided.

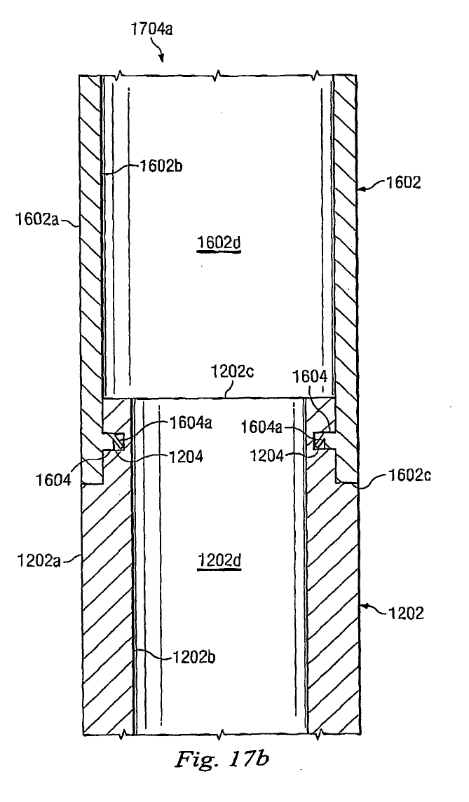

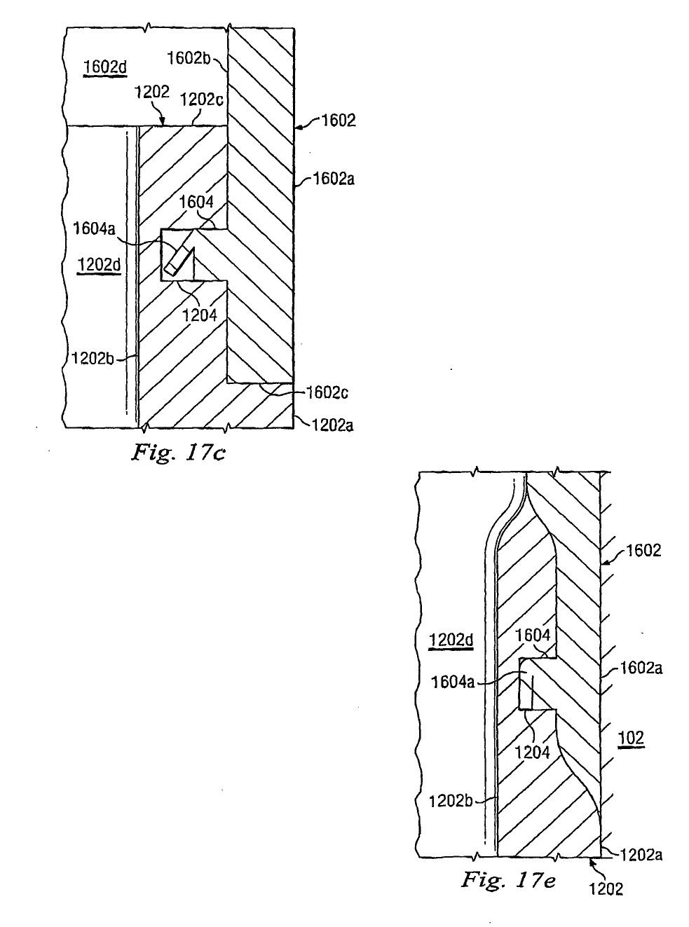

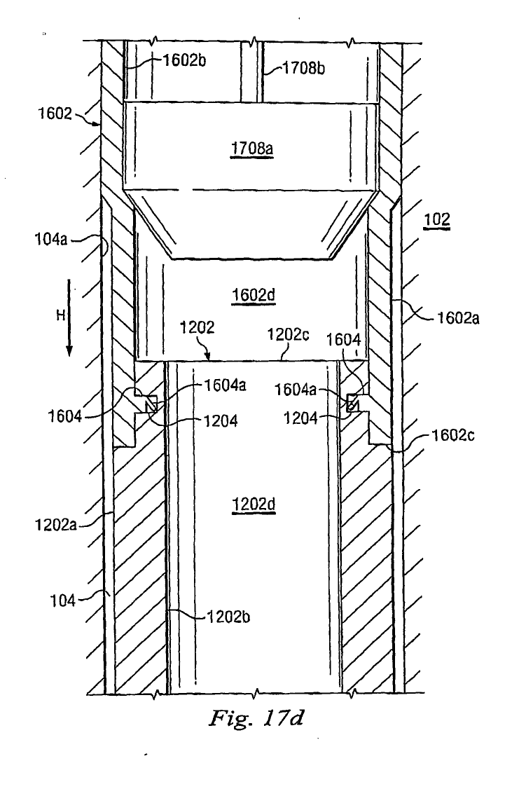

The method 1700 then proceeds to step 1704 where the expandable tubular members 1200 and 1600 are coupled together. The expandable tubular member 1600 is coupled to the expandable tubular member 1200 by positioning the flange members 1604 in the flange channels 1204. In an exemplary embodiment, the flange members 1604 are positioned in the flange channels 1204 by heating the expandable tubular member 1100, causing the expandable tubular member 1100 to expand, which increases the diameter of the passageway 1602d and allows the distal end of expandable tubular member 1200 to be positioned in the passageway 1602d of the expandable tubular member 1600. In an exemplary embodiment, the flange members 1604 are positioned in the flange channels 1204 by forcing the distal end of expandable tubular member 1200 into the passageway 1602d of the expandable tubular member 1600, causing the expandable tubular member 1600 to elastically deform to allow the distal end of expandable tubular member 1200 to be positioned in the passageway 1602d of the expandable tubular member 1100. In an exemplary embodiment, the flange members 1604 are conventional thread members known in the art and the flange channels 1204 are conventional thread channels known in the art, and the flange members 1604 are positioned in the flange channels 1204 by threading the thread members into the thread channels. In an exemplary embodiment, the flange members 1604 may be positioned in the flange channels 1204 using a variety of other conventional methods known in the art. With the expandable tubular member 1600 coupled to the expandable tubular member 1200, a sealing channel is defined between the flange member 1604 and the flange channel 1204 and the resilient beam 1604a is positioned in the sealing channel, as illustrated in FIGS. 17b and 17c. With the expandable tubular member 1600 coupled to the expandable tubular member 1200, an expandable tubular member 1704a is provided.

Referring now to FIGS. 1, 17a, 17d, and 17e, the method 1700 then proceeds to step 1706 where the expandable tubular members 1200 and 1600 are positioned in the wellbore 100. The expandable tubular member 1704a is positioned in the passageway 104 of wellbore 100 such that outer surfaces 1202a and 1602a of the expandable tubular members 1200 and 1600, respectively, are positioned adjacent the passageway surface 104a, as illustrated in FIG. 17d.

The method 1700 proceeds to step 1708 where the expandable tubular members 1200 and 1600 are radially expanded and plastically deformed. An expansion device 1708a which is coupled to a drill string 1708b is provided which has larger outside diameter than the inside diameters of the expandable tubular members 1200 and 1600. The expansion device 1708a is positioned in the expandable tubular member 1704a and moved in a direction H, as illustrated in FIG. 17d. Movement of the expansion device 1708a in direction H expands the expandable tubular members 1200 and 1600 such that the outer surfaces 1202a and 1602a, respectively, engage the passageway surface 104a of the wellbore 100. In an exemplary embodiment, the expansion device 1708a may be a fixed diameter expansion device, a rotary expansion device, a hydroforming device, combinations thereof, and/or a variety of other expansion devices known in the art. Furthermore, the expansion of the expandable tubular member 1704a adjacent the flange member 1604 and the flange channel 1204 results in the deformation of the resilient beam 1604a. Deformation of the resilient beam 1604a provides a gas and liquid tight seal between the expandable tubular members 1200 and 1600. In an exemplary embodiment, the gas and liquid tight seal provided between the expandable tubular members 1200 and 1600 is a metal to metal seal. Thus, a method and apparatus are provided which provide a gas and liquid tight seal between two expandable tubular members 1200 and 1600 which are coupled together and radially expanded and plastically deformed.

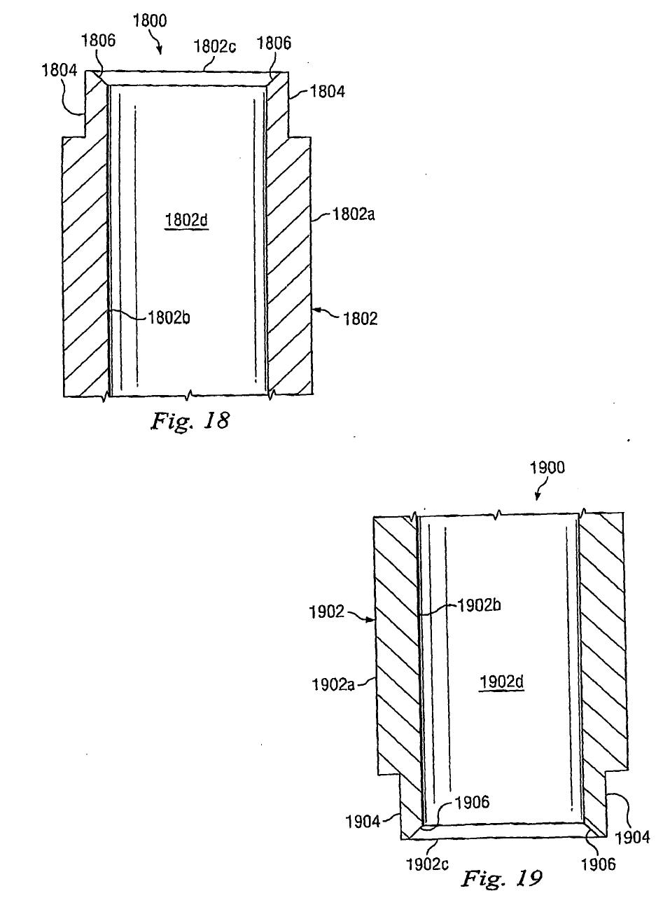

Referring now to FIG. 18, an expandable tubular member 1800 is illustrated. The expandable tubular member 1800 includes a tubular base 1802 having an outer surface 1802a, and inner surface 1802b located opposite the outer surface 1802a, a distal end 1802c, and defining a passageway 1802d extending along its length of the tubular base 1802 to the distal end 1802c. A secondary sealing surface 1804 is defined by the tubular base 1802 and is located on the outer surface 1802a and adjacent the distal end 1802c. A beveled primary sealing surface 1806 is defined by the tubular base 1802 and is located on the inner surface 1802b and adjacent the distal end 1802c. In an exemplary embodiment, the expandable tubular member 1800 is fabricated from a metal material.

Referring now to FIG. 19, an expandable tubular member 1900 is illustrated. The expandable tubular member 1900 includes a tubular base 1902 having an outer surface 1902a, and inner surface 1902b located opposite the outer surface 1902a, a distal end 1902c, and defining a passageway 1902d extending along its length of the tubular base 1902 to the distal end 1902c. A secondary sealing surface 1904 is defined by the tubular base 1902 and is located on the outer surface 1902a and adjacent the distal end 1902c. A beveled primary sealing surface 1906 is defined by the tubular base 1902 and is located on the inner surface 1902b and adjacent the distal end 1902c. In an exemplary embodiment, the expandable tubular member 1900 is fabricated from a metal material.

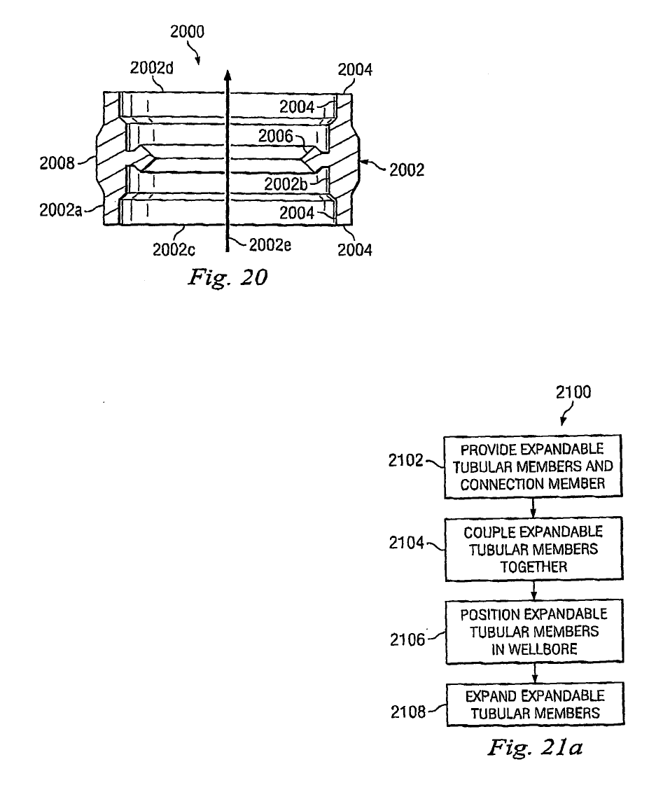

Referring now to FIG. 20, a connection member 2000 is illustrated. Connection member 2000 includes a tubular base member 2002 having an outer surface 2002a, and inner surface 2002b located opposite the outer surface 2002a, a pair of opposing distal ends 2002c and 2002d, and defining a passageway 2002e along the length of the tubular base member 2002 from distal end 2002c to distal end 2002d. The tubular base member 2002 defines a plurality of secondary sealing surfaces 2004 on the inner surface 2002b adjacent the distal ends 2002c and 200d and on the distal ends 2002c and 2002d. A primary sealing member 2006 having a substantially diamond shaped cross section extends from the inner surface 2002b, centrally located between the distal ends 2002c and 2002d of the tubular base member 2002, and into the passageway 2002e. A reinforcing member 2008 is located on the outer surface 2002a radially adjacent the primary sealing member 2006 on tubular base member 2002, and provides a circumferential section of the connection member 2000 located adjacent the primary sealing member 2006 which is thicker than the rest of the connection member 2000 in order assist in the plastic deformation for the primary sealing member 2006. In an exemplary embodiment, the connection member 2000 is fabricated from a metal material.

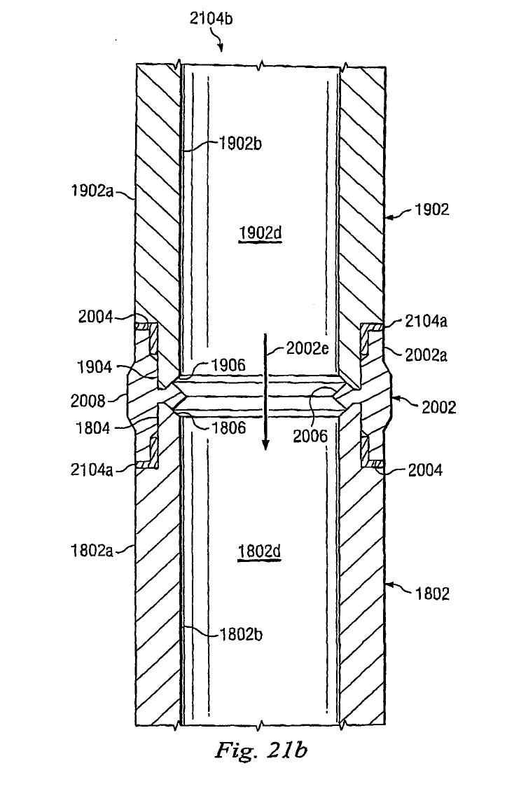

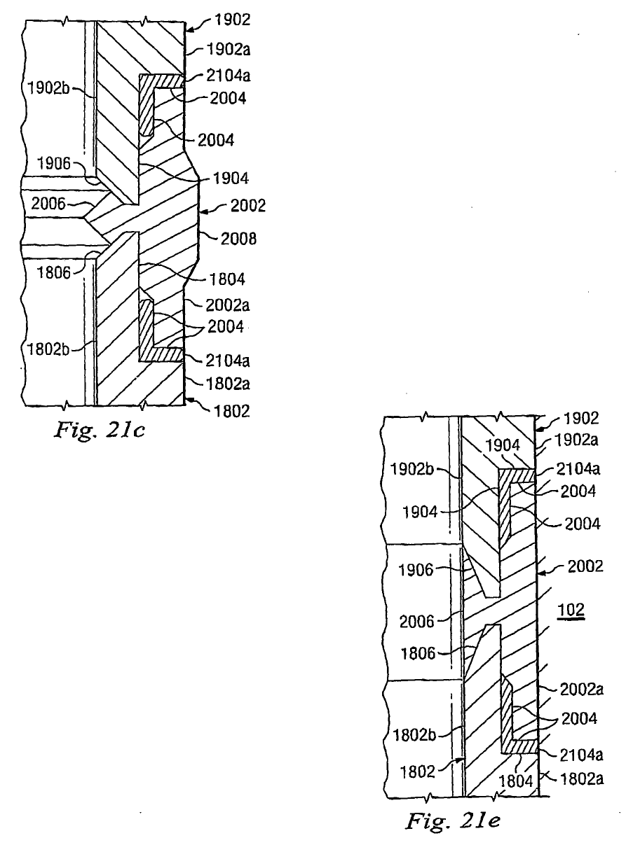

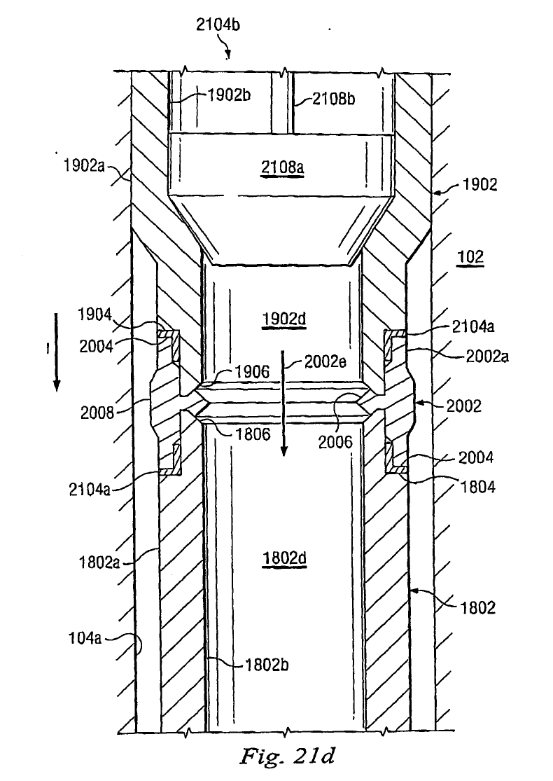

Referring now to FIGS. 18, 19, 20, 21a, 21b, and 21c, a method 2100 for coupling expandable tubular members is illustrated. The method 2100 begins at step 2102 where the expandable tubular members 1800 and 1900, illustrated in FIGS. 18 and 19, and the connection member 2000, illustrated in FIG. 20, are provided. The method 2100 then proceeds to step 2104 where the expandable tubular members 1800 and 1900 are coupled together. The connection member 2000 is positioned between the expandable tubular members 1800 and 1900 such that the distal end 2002d on connection member 2000 is adjacent the distal end 1902c on expandable tubular member 1900 and the distal end 2002c on connection member 2000 is adjacent the distal end 1802c on expandable tubular member 1900. The expandable tubular members 1800 and 1900 are then engaged with the connection member 2000 such that the beveled primary sealing surfaces 1806 and 1906, respectively, engage the primary sealing member 2006 on connection member 2000. A coupling member 2104a is them provided between the secondary sealing surfaces 1804 and 1904 on expandable tubular members 1800 and 1900, respectively, and the secondary sealing surfaces 2004 on the connection member 2000, as illustrated in FIGS. 21b and 21c. In an exemplary embodiment, the coupling member 2104a may be a variety of coupling members known in the art such as, for example, a weld.

Referring now to FIGS. 1, 21a, 21d, and 21e, the method 2100 then proceeds to step 2106 where the expandable tubular members 1800 and 1900 are positioned in the wellbore 100. The expandable tubular member 2104b is positioned in the passageway 104 of wellbore 100 such that outer surfaces 1802a and 1902a of the expandable tubular members 1800 and 1900, respectively, are positioned adjacent the passageway surface 104a, as illustrated in FIG. 21d.

The method 2100 proceeds to step 2108 where the expandable tubular members 1800 and 1900 are radially expanded and plastically deformed. An expansion device 2108a which is coupled to a drill string 2108b is provided which has larger outside diameter than the inside diameters of the expandable tubular members 1800 and 1900. The expansion device 2108a is positioned in the expandable tubular member 2104b and moved in a direction I, as illustrated in FIG. 21d. Movement of the expansion device 2108a in direction I expands the expandable tubular members 1800 and 1900 such that the outer surfaces 1802a and 1902a, respectively, engage the passageway surface 104a of the wellbore 100. In an exemplary embodiment, the expansion device 2108a may be a fixed diameter expansion device, a rotary expansion device, a hydroforming device, combinations thereof, and/or a variety of other expansion devices known in the art.

Furthermore, the expansion of the connection member 2000 deforms the coupling member 2104a against the secondary sealing surfaces 1804, 1904, and 2004, and deforms the primary sealing member 2006 again the primary sealing surfaces 1806 and 1906, as illustrated in FIG. 21e, which results in a gas and liquid tight seal between the expandable tubular members 1800 and 1900 and the connection member 2000. In an exemplary embodiment, the gas and liquid tight seal provided between the expandable tubular members 1800 and 1900 and the connection member 2000 is a metal to metal seal. Thus, a method and apparatus are provided which provide a gas and liquid tight seal between two expandable tubular members 1800 and 1900 which are coupled together and radially expanded and plastically deformed.

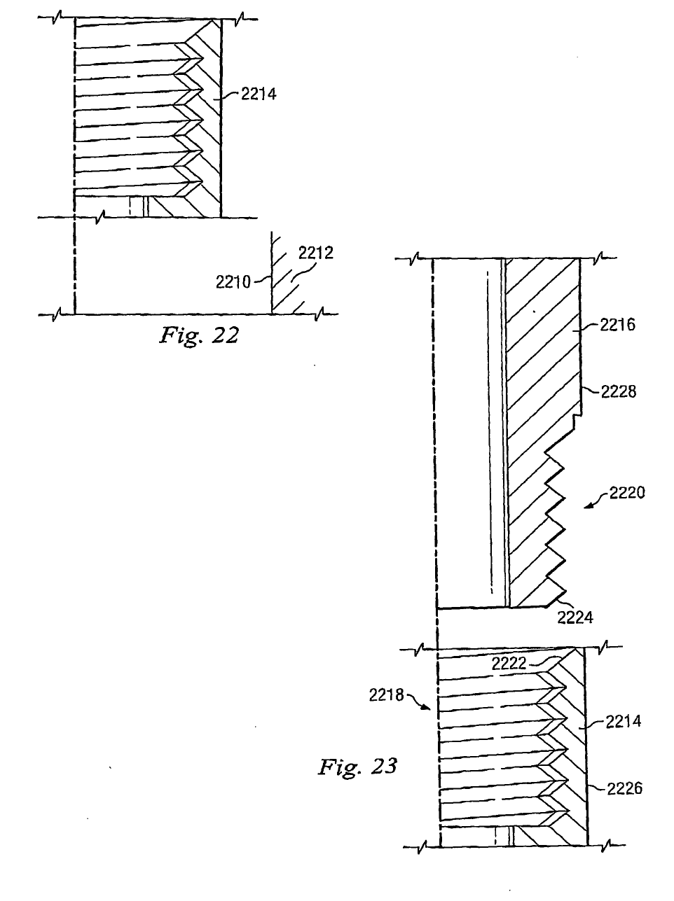

Referring to FIG. 22, a borehole 2210 that traverses a subterranean formation 2212 includes a first tubular member 2214, such as a first wellbore casing 2214 that may be positioned within the borehole. In several exemplary embodiments, tubular members in the form of wellbore casings will be described and depicted. It will be understood that although the methods are particularly advantageous for forming wellbore casings, certain advantageous features may also be applicable to other tubular members as described and claimed herein. In an illustrative embodiment; the first wellbore casing 2214 may, for example, be positioned within and coupled to the borehole 2210 using any number of conventional methods and apparatus, that may or may not include radial expansion and plastic deformation of the first wellbore casing 2214, and/or using one or more of the methods and apparatus disclosed in one or more of the following: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343.674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application serial number 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999, (122) PCT patent application serial no. PCT/US2004/06246, attorney docket no. 25791.238.02, filed on Feb. 26, 2004, (123) PCT patent application serial number PCT/US2004/08170, attorney docket number 25791.40.02, filed on Mar. 15, 2004, (124) PCT patent application serial number PCT/US2004/08171, attorney docket number 25791.236.02, filed on Mar. 15, 2004, (125) PCT patent application serial number PCT/US2004/08073, attorney docket number 25791.262.02, filed on Mar. 18, 2004, (126) PCT patent application serial number PCT/US2004/07711, attorney docket number 25791.253.02, filed on Mar. 11, 2004, (127) PCT patent application serial number PCT/US2004/029025, attorney docket number 25791.260.02, filed on Mar. 26, 2004, (128) PCT patent application serial number PCT/US2004/010317, attorney docket number 25791.270.02, filed on Apr. 2, 2004, (129) PCT patent application serial number PCT/US2004/010712, attorney docket number 25791.272.02, filed on Apr. 6, 2004, (130) PCT patent application serial number PCT/US2004/010762, attorney docket number 25791.273.02, filed on Apr. 6, 2004, (131) PCT patent application serial number PCT/US2004/011973, attorney docket number 25791.277.02, filed on Apr. 15, 2004, (132) U.S. provisional patent application Ser. No. 60/495,056, attorney docket number 25791.301, filed on Aug. 14, 2003, (133) U.S. provisional patent application Ser. No. 60/600,679, attorney docket number 25791.194, filed on Aug. 11, 2004, (134) PCT patent application serial number PCT/US2005/027318, attorney docket number 25791.329.02, filed on Jul. 29, 2005, the disclosures of which are incorporated herein by reference. (135) PCT patent application serial number PCT/US2005/028936, attorney docket number 25791.338.02, filed on Aug. 12, 2005, (136) PCT patent application serial number PCT/US2005/028669, attorney docket number 25791.194.02, filed on Aug. 11, 2005, (137) PCT patent application serial number PCT/US2005/028453, attorney docket number 25791.371, filed on Aug. 11, 2005, (138) PCT patent application serial number PCT/US2005/028641, attorney docket number 25791.372, filed on Aug. 11, 2005, (139) PCT patent application serial number PCT/US2005/028819, attorney docket number 25791.373, filed on Aug. 11, 2005, (140) PCT patent application serial number PCT/US2005/028446, attorney docket number 25791.374, filed on Aug. 11, 2005, (141) PCT patent application serial number PCT/US2005/028642, attorney docket number 25791.375, filed on Aug. 11, 2005, (142) PCT patent application serial number PCT/US2005/028451, attorney docket number 25791.376, filed on Aug. 11, 2005, and (143). PCT patent application serial number PCT/US2005/028473, attorney docket number 25791.377, filed on Jul. 29, 2005, (144) U.S. National Stage application Ser. No. 10/546,084, attorney docket no. 25791.185.05, filed on Aug. 17, 2005; (145) U.S. National Stage application Ser. No. 10/546,082, attorney docket no. 25791.378, filed on Aug. 17, 2005; (146) U.S. National Stage application Ser. No. 10/546,076, attorney docket no. 25791.379, filed on Aug. 17, 2005; (147) U.S. National Stage application Ser. No. 10/546,936, attorney docket no. 25791.380, filed on Aug. 17, 2005; (148) U.S. National Stage application Ser. No. 10/546,079, attorney docket no. 25791.381, filed on Aug. 17, 2005; (149) U.S. National Stage application Ser. No. 10/545,941, attorney docket no. 25791.382, filed on Aug. 17, 2005; (150) U.S. National Stage application Ser. No. 10/546,078, attorney docket no. 25791.383, filed on Aug. 17, 2005 the disclosures of which are incorporated herein by reference.

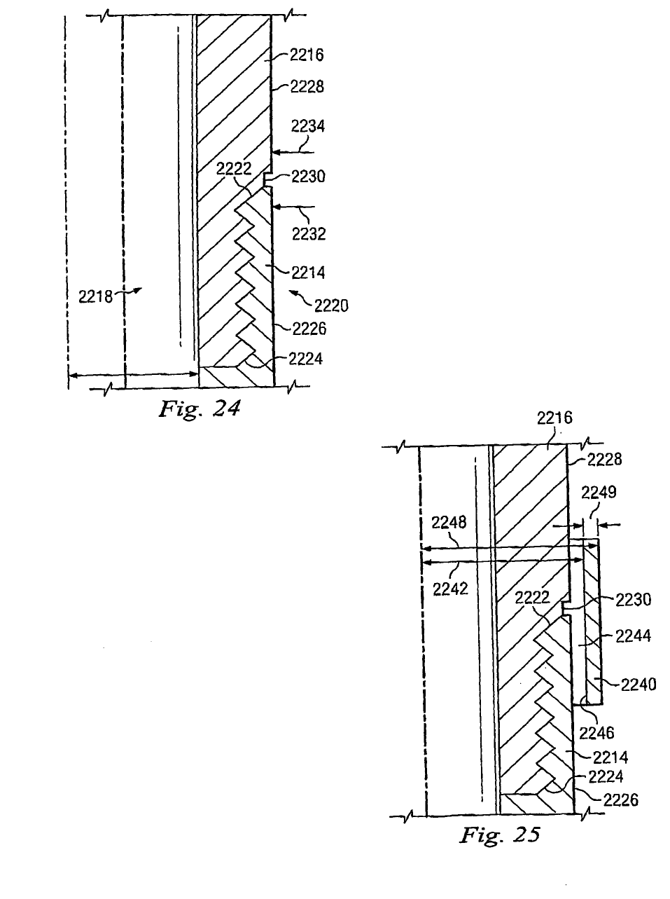

Referring to FIG. 23, the second tubular member 2216, such as second wellbore casing 2216 is then overlappingly coupled to the first wellbore casing 2214 for positioning within the borehole 2210. In several exemplary embodiments, the first wellbore casing 2214 may, for example, be coupled at a first coupling portion 2218 to a second coupling portion 2220 of the second wellbore casing 2216 using any number of conventional methods apparatus. For example as shown in FIG. 23, the coupling may comprise a male, or externally, threaded portion 2224 engaged with a female, or internally, threaded portion 2222. The method of coupling may or may not include radial expansion and plastic deformation of either of the wellbore casings 2214 or 2216 or both, and or using one of more of the methods disclosed in one of more of the following: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471 filed on Sep. 25, 2001, attorney docket no. 25791.64, which is a divisional of U.S. patent application Ser. No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 5,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application serial no, 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048; attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999, (122) PCT patent application serial no. PCT/US2004/06246, attorney docket no. 25791.238.02, filed on Feb. 26, 2004, (123) PCT patent application serial number PCT/US2004/08170, attorney docket number 25791.40.02, filed on Mar. 15, 2004, (124) PCT patent application serial number PCT/US2004/08171, attorney docket number 25791.236.02, filed on Mar. 15, 2004, (125) PCT patent application serial number PCT/US2004/08073, attorney docket number 25791.262.02, filed on Mar. 18, 2004, (126) PCT patent application serial number PCT/US2004/07711, attorney docket number 25791.253.02, filed on Mar. 11, 2004, (127) PCT patent application serial number PCT/US2004/029025, attorney docket number 25791.260.02, filed on Mar. 26, 2004, (128) PCT patent application serial number PCT/US2004/010317, attorney docket number 25791.270.02, filed on Apr. 2, 2004, (129) PCT patent application serial number PCT/US2004/010712, attorney docket number 25791.272.02, filed on Apr. 6, 2004, (130) PCT patent application serial number PCT/US2004/010762, attorney docket number 25791.273.02, filed on Apr. 6, 2004, (131) PCT patent application serial number PCT/US2004/011973, attorney docket number 25791.277.02, filed on Apr. 15, 2004, (132) U.S. provisional patent application Ser. No. 60/495,056, attorney docket number 25791.301, filed on Aug. 14, 2003, (133) U.S. provisional patent application Ser. No. 60/600,679, attorney docket number 25791.194, filed on Aug. 11, 2004, (134) PCT patent application serial number PCT/US2005/027318, attorney docket number 25791.329.02, filed on Jul. 29, 2005, the disclosures of which are incorporated herein by reference. (135) PCT patent application serial number PCT/US2005/028936, attorney docket number 25791.338.02, filed on Aug. 12, 2005, (136) PCT patent application serial number PCT/US2005/028669, attorney docket number 25791.194.02, filed on Aug. 11, 2005, (137) PCT patent application serial number PCT/US2005/028453, attorney docket number 25791.371, filed on Aug. 11, 2005, (138) PCT patent application serial number PCT/US2005/028641, attorney docket number 25791.372, filed on Aug. 11, 2005, (139) PCT patent application serial number PCT/US2005/028819, attorney docket number 25791.373, filed on Aug. 11, 2005, (140) PCT patent application serial number PCT/US2005/028446, attorney docket number 25791.374, filed on Aug. 11, 2005, (141) PCT patent application serial number PCT/US2005/028642, attorney docket number 25791.375, filed on Aug. 11, 2005, (142) PCT patent application serial number PCT/US2005/028451, attorney docket number 25791.376, filed on Aug. 11, 2005, and (143). PCT patent application serial number PCT/US2005/028473, attorney docket number 25791.377, filed on Jul. 29, 2005, (144) U.S. National Stage application Ser. No. 10/546,084, attorney docket no. 25791.185.05, filed on Aug. 17, 2005; (145) U.S. National Stage application Ser. No. 10/546,082, attorney docket no. 25791.378, filed on Aug. 17, 2005; (146) U.S. National Stage application Ser. No. 10/546,076, attorney docket no. 25791.379, filed on Aug. 17, 2005; (147) U.S. National Stage application Ser. No. 10/546,936, attorney docket no. 25791.380, filed on Aug. 17, 2005; (148) U.S. National Stage application Ser. No. 10/546,079, attorney docket no. 25791.381, filed on Aug. 17, 2005; (149) U.S. National Stage application Ser. No. 10/545,941, attorney docket no. 25791.382, filed on Aug. 17, 2005; (150) U.S. National Stage application Ser. No. 10/546,078, attorney docket no. 25791.383, filed on Aug. 17, 2005 the disclosures of which are incorporated herein by reference. Upon coupling the first and second tubular members, such as upon coupling the first and second wellbore casings 2214 and 2216, as depicted in FIG. 23, a first surface portion 2226 and a second surface portion 2228 are adjacently positionally in the axial direction and may or may not have the same or nearly the same outside diameters 2232 and 2234. It would understood that according to the foregoing methods and apparatus for expanding the wellbore casing, the depiction in FIG. 23 and FIG. 24 may or may not demonstrate an overlapping portion that has been previously expanded. In either instance, it is desirable for the present invention that the exterior first outside diameter 2232 and the outside diameter 2234 have the same or nearly the same dimensions. Further it will be seen that a joint 2230 is formed between the first and second surfaces that may include a small gap such as a bevel or partial channel on either member as is conventional for accommodating nicks or dents so that they will not interfere with complete coupling between the first and second wellbore casings.

Referring to FIG. 25, it will again be understood that the first wellbore casing 2214 and the second wellbore casing 2216 may or may not have been radially expanded in the embodiment depicted. A tubular sleeve 2240 is positioned overlapping the first surface portion 2226 of the first wellbore casings 2214 and also overlapping the second surface portion 2228 of the second wellbore casing 2216, thereby overlapping the joint 2230 and axially extending in either direction there from at least partially over the overlapping coupling as well as at least partially over a portion of casing 2216 that does not overlap first wellbore casing 2214.

The tubular sleeve 2240 is preferably composed of electrically conductive material that are suitably malleable or flowable to be shaped mechanically, as for example copper, aluminum, light metal, and metal alloys. Steel alloys and other metal alloys with suitable electrically conductivity and with suitable malleability or suitable flow behavior may also be used. The inside diameter 2242, of the tubular sleeve 2240 is only slightly larger than the outside diameter of the first and second tubular members 2214 and 2216 at the joint 2230. This means a cylindrical gap 2244 between the inside surface 2246 of sleeve 2240 and the first and second outside surfaces 2226 and 2228 of wellbore casings 2214 and 2216, respectively. The outside diameter 2248 of tubular sleeve 2240 is slightly larger than the inside diameter 2242 defining a thickness 2249 that is relatively thin compared the thickness of the wellbore casings 2214 and 2216.

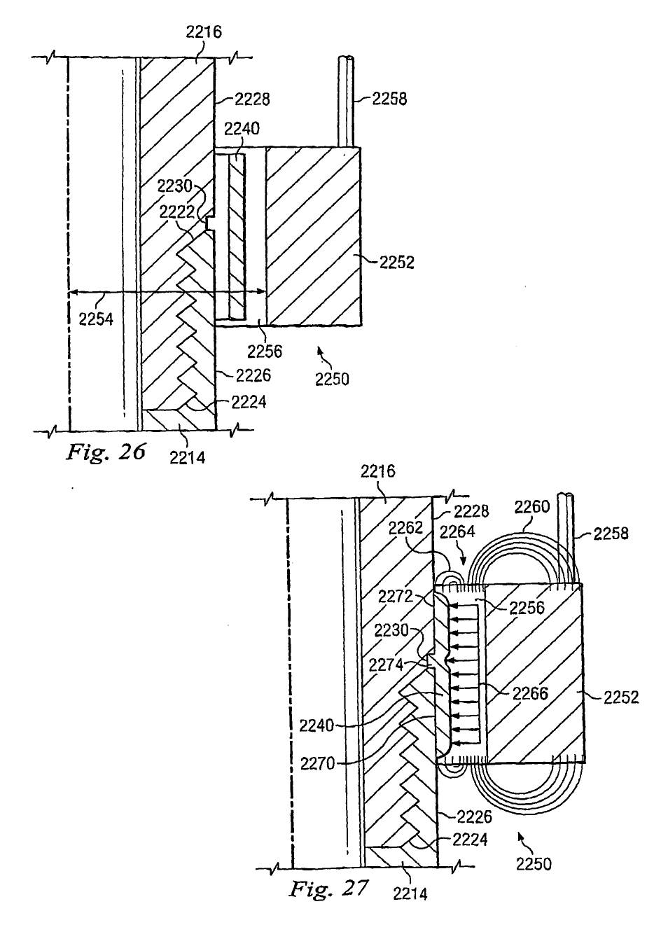

FIG. 26 is a schematic illustration of the overlapping wellbore casings 2214 and 2216 and the overlapping tubular sleeve 2240, as in FIG. 25, and further schematically depicts a magnetic impulse energy applicator 2250. The impulse energy applicator 2250, according to one aspect of the present invention, is aligned with the tubular sleeve 2240 at a position overlapping the joint 2230 and extending a distance over the surfaces 2226 and 2228 on either side of the joint 2230. The magnetic impulse apparatus 2250 may comprise an impulse conductor ring 2252 having an inside diameter 2254 slightly larger than the outside diameter of the ring 2240, thereby leaving a small cylindrical gap 2256 therebetween. Conductor ring 2252 is interrupted with a radially extending gap (not shown) and is operatively connected to an impulse generator 2258 such that the magnetic impulse power flows circumferentially around conductor ring 2252 when applied from the impulse generator 2258. This method applied to joints of wellbore casing has not heretofore been known, although there are conventional devices and it is a conventional concept for providing a magnetic impulse for shaping of cylindrical metal parts. Thus, the adaptation of one or more of the methods and apparatus according to one or more of the following may be used in connection with this aspect of the present invention: (1) U.S. Pat. No. 5,444,963 issued to Steingroever, et al., Aug. 29, 1995; (2) U.S. Pat. No. 5,586,460 issued to Steingroever Dec. 24, 1996; (3). U.S. Pat. No. 5,953,805 issued to Steingroever Sep. 21, 1999, as well as the techniques and apparatus described on the web page of Magnetic-Physics, Inc. with reference to the shaping technique under the trademark Magnetopuls, (http://www.magnet-physics.com/st_magnetopuls.html), a copy of which is attached hereto as Exhibit A, and the disclosures of which are incorporated by reference.

With reference to FIG. 27, the method of applying the tubular sleeve to the joint of wellbore casing 2214 and 2216 may be more fully understood. The magnetic impulse generator 2258 provides a magnetic in pulse to the conductor ring 2252. The magnetic impulse causes a powerful magnetic field 2260 to be produced and simultaneously causes a counter current magnetic pulse 2262 to be produced within tubular sleeve 2240. An extremely high concentration of magnetic flux at 2264 results in the gap 2256 between tubular sleeve 2240 and conductor ring 2252. This high flux concentration due to the magnetic impulse generates a large force 2266 inward from the ring 2252 thereby collapsing tubular sleeve 2240 onto the surfaces 2226 and 2228 at the joint. This effectively forms a first sealing interface 2270 between the first surface 2226 and the inside surface 2244 of the tubular sleeve, and also forms a second sealing interface 2272 between the inside surface 2244 of the tubular sleeve and the surface 2228 of the second wellbore casing. With sufficiently high force, the malleable or flowable material from which tubular sleeve 2240 is made, flows at 2274 into the joint gap 2230. This method produces a surface to surface air tight metallic seal entirely over the coupling between the first wellbore casing 2214 and the second wellbore casing 2216. The strength of the tubular sleeve 2240 also holds the joint together during the process of mechanical expansion of the wellbore casing at the joint.

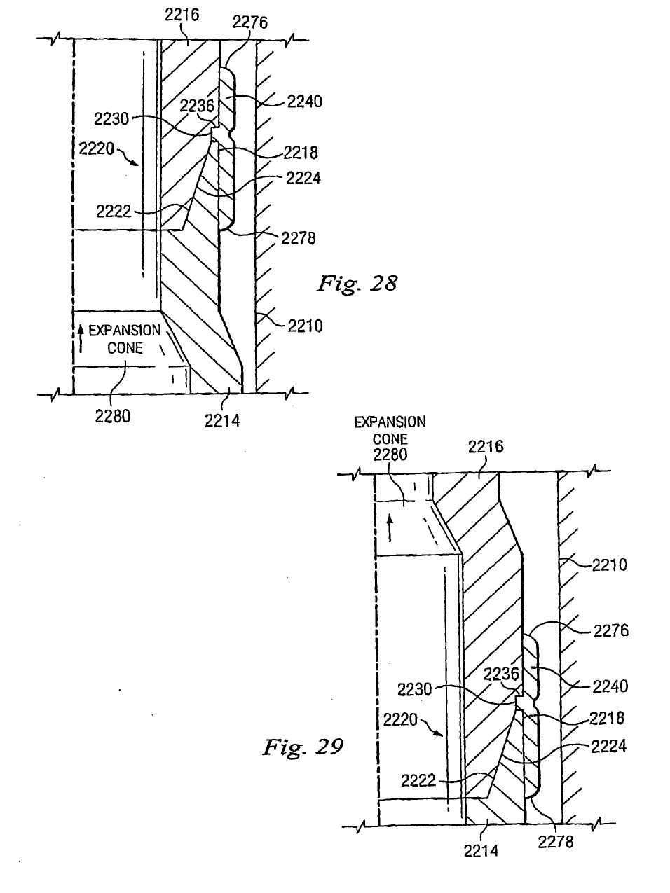

In an exemplary embodiment, as illustrated in FIGS. 28 and 29, the first and second tubular members, 2214 and 2216, and the tubular sleeve 2240 may then be positioned within another structure 2210 such as, for example, a wellbore 2210, and radially expanded and plastically deformed, for example, by moving an expansion cone 2280 through the interiors of the first and second tubular members 2214 and 2216. The tapered portions, 2276 and 2278, of the tubular sleeve 2240 as may result from material flow due to large magnetic force of the type of material of sleeve 2240 and facilitate the insertion and movement of the first and second tubular members 2214 and 2216 within and through the structure 2210, and the movement of the expansion cone 2280 through the interiors of the first and second tubular members, 2214 and 2216, may be from top to bottom or from bottom to top.

In an exemplary embodiment, during the radial expansion and plastic deformation of the first and second tubular members, 2214 and 2216, the tubular sleeve 2240 is also radially expanded and plastically deformed. In an exemplary embodiment, as a result, the tubular sleeve 2240 may be maintained in circumferential tension and the overlapping end coupling portions, 2218 and 2220, of the first and second tubular members, 2214 and 2216, may be maintained in circumferential compression.

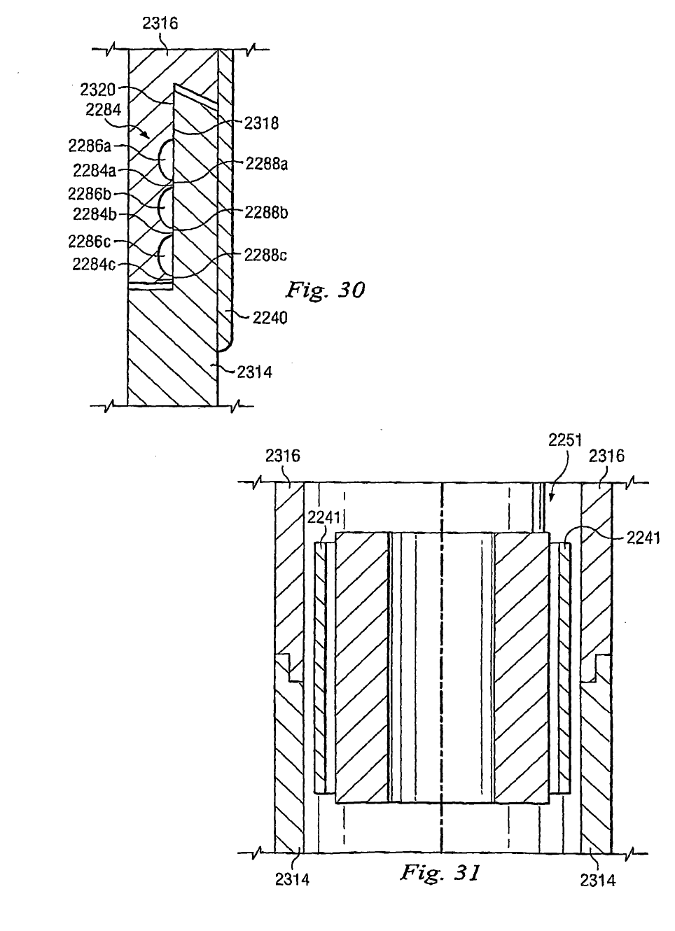

In FIG. 30, a fragmentary cross-sectional schematic illustration shows an exemplary embodiment of method and apparatus in which first and second tubular members 2314 and 2316 are overlapping coupled together, as with a first coupling portion 2318 and a second coupling portion 2320 pressed together in surface-to-surface engagement, and with an overlapping tubular sleeve 2240 applied to the exterior thereof and providing a substantially continuous tubular assembly that may be expanded and plastically deformed. The first coupling portion 2318 and the second coupling portion 2320 may be overlappingly coupled together, as with a first female coupling portion and a second male coupling portion pushed, slid or pressed together in surface-to-surface engagement. An overlapping tubular sleeve 2240 is applied to the coupling to provide sealing and to stress the tubular coupling portions toward each other. In an exemplary embodiment, one or more raised ridge rings 2284(a-c) and corresponding trough rings 2286(a-c) are formed interposed between the first and second couplings to increase the surface to surface contact stress for maintaining sealing contact upon expanding and plastically deforming the coupling and tubular sleeve at the overlapping portions of the first and second tubular members. In this method and apparatus the peaks 2288(a-c) of the ridges 2284(a-c) have a small area of surface contact with the opposed coupling portion, compared to the entire overlapping coupling area, such that the stress or force per area of contact is significantly increased thereby facilitating the surface to surface seal at the coupling joint. Although the ridge rings 2284 are shown formed in the second male coupling portion with the peaks toward the first female male coupling portion, it will be understood based upon this disclosure that the ridge rings 2284 might alternatively be formed on the female coupling portion 2318 with the peaks toward the female coupling portion 2320. Also, although a specific number of ridge rings are depicted having particular shapes, a greater or lesser number of ridges having different or modified shapes may be provided consistent with this aspect of the present invention. The tubular sleeve 2240 as applied to the exterior of the overlapping tubular members increases the sealing stress. In a further exemplary embodiment, the tubular sleeve 2240 acting together with the raised ridge rings 2284 work together to maintain the seal when the tubular members 2314 and 2316 are expanded and plastically deformed as disclosed herein.

FIG. 31 depicts another exemplary embodiment of the invention in which an interior tubular sleeve 2241 is aligned with coupling joint between tubular members 2314 and 2316. Before or after expanding the tubular members the interior tubular sleeve 2241 is forced outward by magnetic impulse device 2251 in a conventional manner or by the adaptation of one of more of the methods and apparatus according to one or more of the following may be used in connection with this aspect of the present invention: (1) U.S. Pat. No. 5,444,963 issued to Steingroever, et al., Aug. 29, 1995; (2) U.S. Pat. No. 5,586,460 issued to Steingroever Dec. 24, 1996; (3). U.S. Pat. No. 5,953,805 issued to Steingroever Sep. 21, 1999, as well as the techniques an apparatus is described on the web page of Magnetic-Physics, Inc., with reference to the shaping technique under the trademark Magnetopuls, (http://www.magnet-physics.com/st_magnetopuls.html), a copy of which is attached hereto as Exhibit A, and the disclosures of which are incorporated by reference. The interior sleeve 2241 is applied to the interior surfaces of the tubular members overlapping the coupling joint and thereby facilitates sealing and connection between the tubular members.

In several exemplary embodiments, the first and second tubular members, 2214 and 2216, are radially expanded and plastically deformed using the expansion cone 2280 in a conventional manner and/or using one or more of the methods and apparatus disclosed in one or more of the following: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application serial No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application serial no. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application serial no. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999, (122) PCT patent application serial no. PCT/US2004/06246, attorney docket no. 25791.238.02, filed on Feb. 26, 2004, (123) PCT patent application serial number PCT/US2004/08170, attorney docket number 25791.40.02, filed on Mar. 15, 2004, (124) PCT patent application serial number PCT/US2004/08171, attorney docket number 25791.236.02, filed on Mar. 15, 2004, (125) PCT patent application serial number PCT/US2004/08073, attorney docket number 25791.262.02, filed on Mar. 18, 2004, (126) PCT patent application serial number PCT/US2004/07711, attorney docket number 25791.253.02, filed on Mar. 11, 2004, (127) PCT patent application serial number PCT/US2004/029025, attorney docket number 25791.260.02, filed on Mar. 26, 2004, (128) PCT patent application serial number PCT/US2004/010317, attorney docket number 25791.270.02, filed on Apr. 2, 2004, (129) PCT patent application serial number PCT/US2004/010712, attorney docket number 25791.272.02, filed on Apr. 6, 2004, (130) PCT patent application serial number PCT/US2004/010762, attorney docket number 25791.273.02, filed on Apr. 6, 2004, (131) PCT patent application serial number PCT/US2004/011973, attorney docket number 25791.277.02, filed on Apr. 15, 2004, (132) U.S. provisional patent application Ser. No. 60/495,056, attorney docket number 25791.301, filed on Aug. 14, 2003, (133) U.S. provisional patent application Ser. No. 60/600,679, attorney docket number 25791.194, filed on Aug. 11, 2004, (134) PCT patent application serial number PCT/US2005/027318, attorney docket number 25791.329.02, filed on Jul. 29, 2005, the disclosures of which are incorporated herein by reference. (135) PCT patent application serial number PCT/US2005/028936, attorney docket number 25791.338.02, filed on Aug. 12, 2005, (136) PCT patent application serial number PCT/US2005/028669, attorney docket number 25791.194.02, filed on Aug. 11, 2005, (137) PCT patent application serial number PCT/US2005/028453, attorney docket number 25791.371, filed on Aug. 11, 2005, (138) PCT patent application serial number PCT/US2005/028641, attorney docket number 25791.372, filed on Aug. 11, 2005, (139) PCT patent application serial number PCT/US2005/028819, attorney docket number 25791.373, filed on Aug. 11, 2005, (140) PCT patent application serial number PCT/US2005/028446, attorney docket number 25791.374, filed on Aug. 11, 2005, (141) PCT patent application serial number PCT/US2005/028642, attorney docket number 25791.375, filed on Aug. 11, 2005, (142) PCT patent application serial number PCT/US2005/028451, attorney docket number 25791.376, filed on Aug. 11, 2005, and (143). PCT patent application serial number PCT/US2005/028473, attorney docket number 25791.377, filed on Jul. 29, 2005, (144) U.S. National Stage application Ser. No. 10/546,084, attorney docket no. 25791.185.05, filed on Aug. 17, 2005; (145) U.S. National Stage application Ser. No. 10/546,082, attorney docket no. 25791.378, filed on Aug. 17, 2005; (146) U.S. National Stage application Ser. No. 10/546,076, attorney docket no. 25791.379, filed on Aug. 17, 2005; (147) U.S. National Stage application Ser. No. 10/546,936, attorney docket no. 25791.380, filed on Aug. 17, 2005; (148) U.S. National Stage application Ser. No. 10/546,079, attorney docket no. 25791.381, filed on Aug. 17, 2005; (149) U.S. National Stage application Ser. No. 10/545,941, attorney docket no. 25791.382, filed on Aug. 17, 2005; (150) U.S. National Stage application Ser. No. 10/546,078, attorney docket no. 25791.383, filed on Aug. 17, 2005 the disclosures of which are incorporated herein by reference.

In several alternative embodiments, the first and second tubular members, 2214 and 2216, are radially expanded and plastically deformed using other conventional methods for radially expanding and plastically deforming tubular members such as, for example, internal pressurization and/or roller expansion devices such as, for example, that disclosed in U.S. patent application publication no. US 2001/0045284 A1, the disclosure of which is incorporated herein by reference.

The use of the tubular sleeve during (a) the coupling of the first tubular member to the second tubular member, (b) the placement of the first and second tubular members in the structure, (c) the radial expansion and plastic deformation of the first and second tubular members, and (d) magnetic impulse applying tubular sleeve to the overlapping coupling ends between the first and second tubular members provides a number of significant benefits. For example, the tubular sleeve 2240 protects the exterior surfaces of the end portions, 2218 and 2220, of the first and second tubular members, 2214 and 2216, during handling and insertion of the tubular members within the structure 2210. In this manner, damage to the exterior surfaces of the end portions, 2218 and 2220, of the first and second tubular member, 2214 and 2216, are prevented that could result in stress concentrations that could result in a catastrophic failure during subsequent radial expansion operations. In this manner, misalignment that could result in damage to the threaded connections, 2222 and 2224, of the first and second tubular members, 2214 and 2216, may be avoided. In addition, the relative rotation of the second tubular member with respect to the first tubular member, after the threaded coupling of the first and second tubular members is resisted by the tubular sleeve 2240. Tubular sleeve 2240 may also provide an indication of to what degree the first and second tubular members are threadably coupled. For example, if the tubular sleeve 2240 can be easily rotated, that would indicate that the first and second tubular members, 2214 and 2216, are not fully threadably coupled and in intimate contact with the internal flange 2236 of the tubular sleeve. Furthermore, the tubular sleeve 2216 may prevent crack propagation during the radial expansion and plastic deformation of the first and second tubular members, 2214 and 2216. In this manner, failure modes such as, for example, longitudinal cracks in the end portions, 2218 and 2220, of the first and second tubular members may be limited in severity or eliminated all together. In addition, after completing the radial expansion and plastic deformation of the first and second tubular members, 2214 and 2216, the tubular sleeve 2240 may provide a fluid tight metal-to-metal seal between interior surface of the tubular sleeve and the exterior surfaces of the end portions, 2218 and 2220, of the first and second tubular members. In this manner, fluidic materials are prevented from passing through the threaded connections, 2222 and 2224, of the first and second tubular members, 2214 and 2216, into the annulus between the first and second tubular members and the structure 2210. Furthermore, because, following the radial expansion and plastic deformation of the first and second tubular members, 2214 and 2216, the tubular sleeve 2240 may be maintained in circumferential tension and the end portions, 2218 and 2220, of the first and second tubular members, 2214 and 2216, may be maintained in circumferential compression, axial loads and/or torque loads may be transmitted through the tubular sleeve. In addition, the tubular sleeve 2240 may also increase the collapse strength of the end portions, 2218 and 2220, of the first and second tubular members, 2214 and 2216.

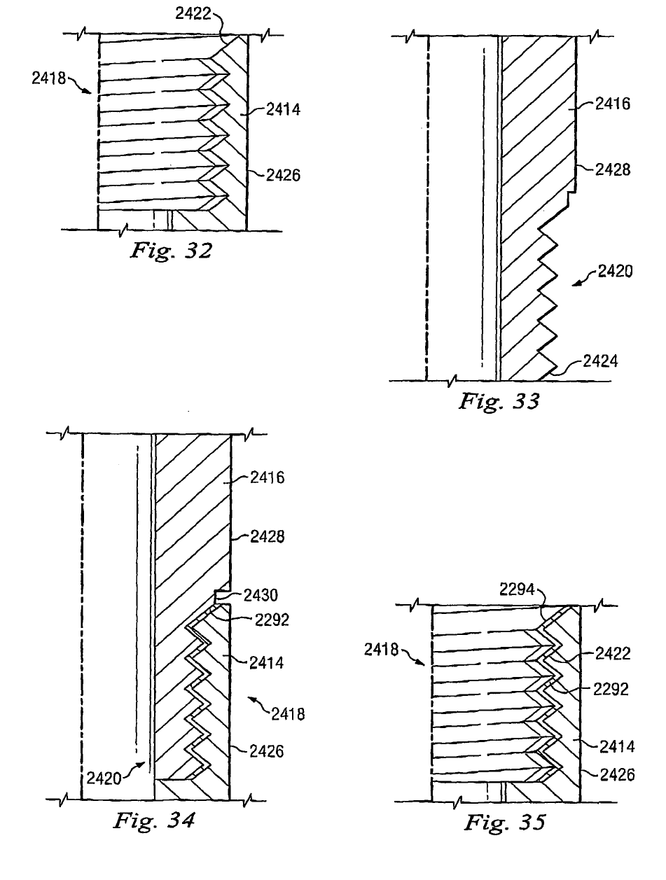

FIG. 32 depicts a fragmentary schematic illustration of a wellbore casing 2414 having a first coupling portion 2418 that may, for example, comprise threads 2422.

FIG. 33 depicts a fragmentary schematic view of a second wellbore casing 2416 being a coupling portion 2420 formed thereon such as threaded mail coupling 2424. Adjacent to the coupling portion will be cylindrical surface portion 2428.

With reference to FIG. 34 which is a schematic depiction of wellbore casing 2414 coupled to wellbore casing 2416 at a joint 2430, the wellbore casing 2414 and 2416 are formed with their coupling portions 2418 and 2420 appropriately sized to leave a gap 2291 there between. The gap 2291 is, according to one exemplary embodiment, depicted in FIG. 34 filled with an interposed material layer 2292. The interposed layer 2292 is preferably a material that is softer than the wellbore casing 2414 and 2410 at there coupling portions 2418 and 2420. In an exemplary embodiment, the interposed layer 2292 may be composed of plastic or metal. It may be implied in the coils or springs and it may be an exothermic material defined as one having a low temperature during joining, a much higher temperature after influence of deformation and or temperature. Examples of the interpose material might include plastic or metals such as copper, zinc, cagmium, tin and alloy. In an exemplary embodiment, the depose layer may comprise an exothermic alloy material being one having a low melting temperature during joining and a much higher temperature after solidification of the solid joint as a result of plastic deformation stress and or temperature. The combination of the responding sizes of the coupling portion 2418 and 2420 such as threads 2422 and 2424 are calculated to determine the soft coding volume or the thickness of the interpose layer 2292 in order to fill the gap before and after radial expansion and plastic deformation of the tubular members at the joint.

FIG. 35 shows a fragmentary cross sectional view of the male coupling 2418 and in particular threads 2422 in which the posed layer 2292 is formed by reposition or insert onto the threads 2422 that 2294.

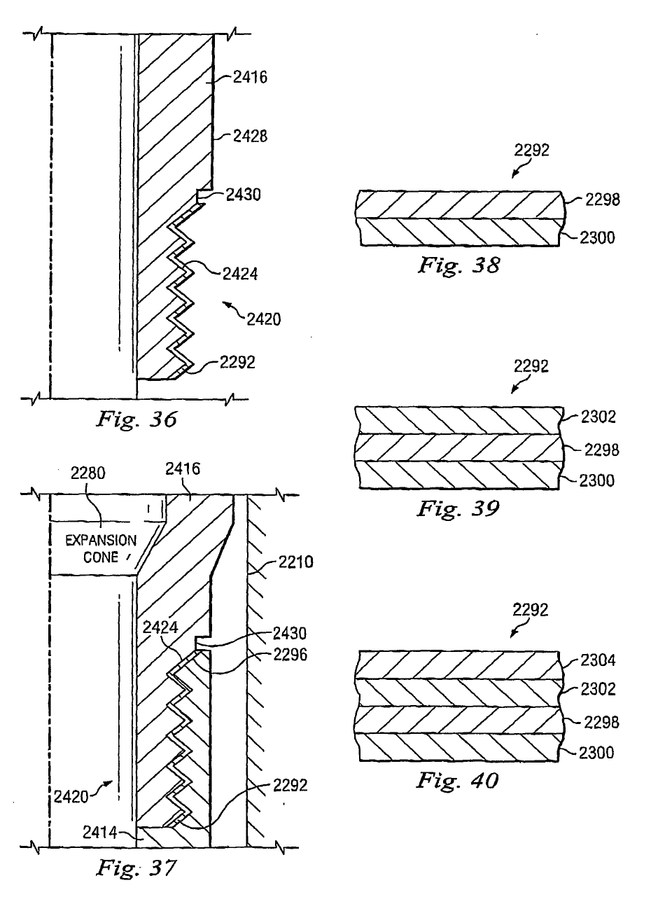

FIG. 36 is a fragmentary cross sectional illustration of wellbore casing 2416 with the coupling portion 2420 formed at male threads 2424 and the interpose layer 2292 deposited or attached to the threads 2424 as at 2296.

FIG. 37 schematically depicts a fragmentary illustration first casing 2414 coupled to second casing 2416 with the interposed layer 2292 there between. Further depicted is a expansion cone 2280 moving along the axis of the coupled casings thereby radially expand and plastically deform. The tubular casings and as discussed previously the overlapping coupling joint.

With reference to FIGS. 38, 39, and 40, it will be more fully understood that the interposed layer 2292 in an illustrative example may comprise multiple layers, which has layers 2298 and 2300 in FIG. 38, layers 2298, 2300, 2302 in FIG. 39 and layers 2298, 2300, 2302, and 2304 in FIG. 40. The layers are preferably each with a different modulus of elasticity such as for example in FIG. 38 layer 2298 comprising a relatively harder material and layer 2300 comprising a softer material, as for example copper layer 2298 and a cagmium layer 2300 in such an embodiment the copper may plastically deform to provide a sealing layer sealing along the entire joint surface and layer 2300 cagnuim may provide a micro-sealing layer.

In FIG. 39 the triple layer comprising layer 2298, 2300, and 2302 comprise of the sealing layer 2298 and the micro-sealing layer 2300 in FIG. 38. Layer 2302 might advantageously be another micro sealing layer more to layer 2300 alternatively might be there are having an even greater modulus of elasticity than layer 2298 provide additional rigidity for maintaining contact with the coupling services while the micro layer 2300 and the interpose layer 2298 act too effectively micro seal from the surface of the coupling in contact with layer 2300 through the lay 2298 and layer 2302.

In FIG. 40 depicting four layers 2298, 2300, 2302, and 2304 to form the interposed lay 2292 it will be understood that the combination of hard and soft layers and or exothermic materials in any relative combination might be accomplished or advantageous sealing of the coupling joint. Again, for example layer 2302 might be a solid material and layer 2304 might be flux for promoting sealing engagement with the coupling surface. In an illustrative example, layer 2302 might be an alloy of copper, other materials that provide for a low initial melting point during a deformation and or heating and after deformation stress and or heating having a hire melting point. In this matter upon coupling and then radial expansion, layer 2302 may be caused to melt with flux 2304 acting in a traditional manner to allow a bonding between layer 2302 and the surface of the coupling such that upon cooling and resolidifation a strong soldered joint is formed and remains sealed and that has a high melting temperature to prevent later separation.

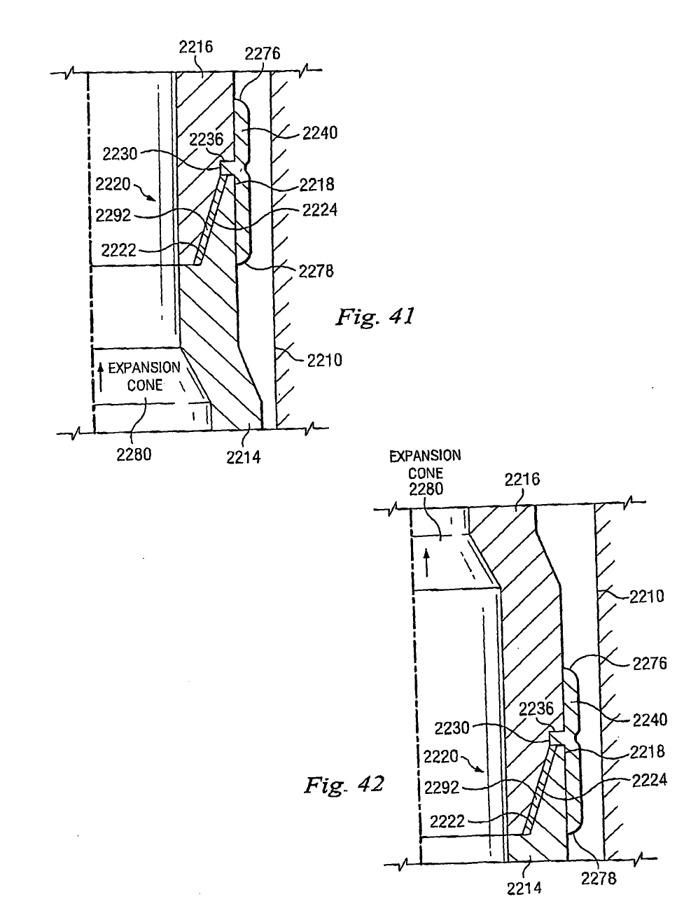

FIG. 41 depicts a coupling joint having a layer 2292 interposed there between and further having a tubular sleeve 2240 applied overlapping the coupling. Prior to expansion as with an expansion cone 2280.

FIG. 42 further depicts the method of coupling with a layer 2292 interposed there between the coupling joint with the tubular sleeve 2240 all having been expanded by the expansion cone 2280 for retaining a tight sealing engagement between the coupling surfaces for both strength and sealing rigidity.

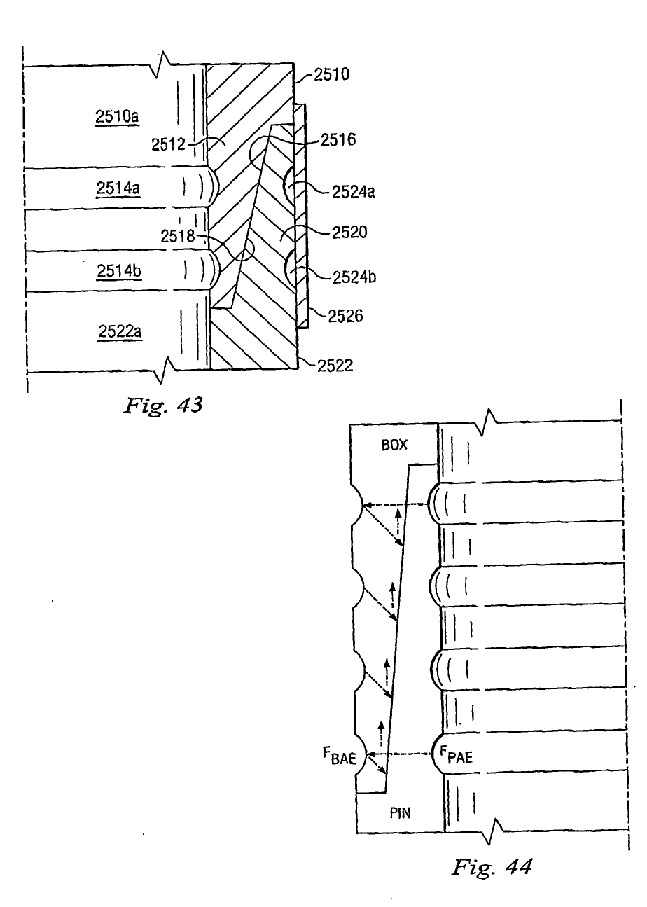

FIG. 43 illustrates a first tubular member 2510 that defines a passage 2510a that includes a pin member 2512 that includes stress concentration grooves, 2514a and 2514b, formed in the internal surface of the pin member, and external threads 2516 that engage internal threads 2518 of a box member 2520 of a second tubular member 2522 that defines a passage 2522a. Stress concentration grooves, 2524a and 2524b, are formed in the external surface of the box member 2520 of the second tubular member, and an external sleeve 2526 is coupled to and overlaps with the ends of the first and second tubular members, 2510 and 2522. The first tubular member 2510, the second tubular member 2522, and the external sleeve 2526 may be radially expanded and plastically deformed using any number of conventional methods and apparatus and/or as disclosed in one or more of the following: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/, filed on Dec. 18, 2002, attorney docket no. 25791.46.07, which claims priority from provisional patent application Ser. No. 60/221,645, attorney docket no. 25791.46, filed on Jul. 28, 2000, (26) patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999, (122) PCT patent application serial no. PCT/US2004/06246, attorney docket no. 25791.238.02, filed on Feb. 26, 2004, (123) PCT patent application serial number PCT/US2004/08170, attorney docket number 25791.40.02, filed on Mar. 15, 2004, (124) PCT patent application serial number PCT/US2004/08171, attorney docket number 25791.236.02, filed on Mar. 15, 2004, (125) PCT patent application serial number PCT/US2004/08073, attorney docket number 25791.262.02, filed on Mar. 18, 2004, (126) PCT patent application serial number PCT/US2004/07711, attorney docket number 25791.253.02, filed on Mar. 11, 2004, (127) PCT patent application serial number PCT/US2004/029025, attorney docket number 25791.260.02, filed on Mar. 26, 2004, (128) PCT patent application serial number PCT/US2004/010317, attorney docket number 25791.270.02, filed on Apr. 2, 2004, (129) PCT patent application serial number PCT/US2004/010712, attorney docket number 25791.272.02, filed on Apr. 6, 2004, (130) PCT patent application serial number PCT/US2004/010762, attorney docket number 25791.273.02, filed on Apr. 6, 2004, (131) PCT patent application serial number PCT/US2004/011973, attorney docket number 25791.277.02, filed on Apr. 15, 2004, (132) U.S. provisional patent application Ser. No. 60/495,056, attorney docket number 25791.301, filed on Aug. 14, 2003, (133) U.S. provisional patent application Ser. No. 60/600,679, attorney docket number 25791.194, filed on Aug. 11, 2004, (134) PCT patent application serial number PCT/US2005/027318, attorney docket number 25791.329.02, filed on Jul. 29, 2005, the disclosures of which are incorporated herein by reference. (135) PCT patent application serial number PCT/US2005/028936, attorney docket number 25791.338.02, filed on Aug. 12, 2005, (136) PCT patent application serial number PCT/US2005/028669, attorney docket number 25791.194.02, filed on Aug. 11, 2005, (137) PCT patent application serial number PCT/US2005/028453, attorney docket number 25791.371, filed on Aug. 11, 2005, (138) PCT patent application serial number PCT/US2005/028641, attorney docket number 25791.372, filed on Aug. 11, 2005, (139) PCT patent application serial number PCT/US2005/028819, attorney docket number 25791.373, filed on Aug. 11, 2005, (140) PCT patent application serial number PCT/US2005/028446, attorney docket number 25791.374, filed on Aug. 11, 2005, (141) PCT patent application serial number PCT/US2005/028642, attorney docket number 25791.375, filed on Aug. 11, 2005, (142) PCT patent application serial number PCT/US2005/028451, attorney docket number 25791.376, filed on Aug. 11, 2005, and (143). PCT patent application serial number PCT/US2005/028473, attorney docket number 25791.377, filed on Jul. 29, 2005, (144) U.S. National Stage application Ser. No. 10/546,084, attorney docket no. 25791.185.05, filed on Aug. 17, 2005; (145) U.S. National Stage application Ser. No. 10/546,082, attorney docket no. 25791.378, filed on Aug. 17, 2005; (146) U.S. National Stage application Ser. No. 10/546,076, attorney docket no. 25791.379, filed on Aug. 17, 2005; (147) U.S. National Stage application Ser. No. 10/546,936, attorney docket no. 25791.380, filed on Aug. 17, 2005; (148) U.S. National Stage application Ser. No. 10/546,079, attorney docket no. 25791.381, filed on Aug. 17, 2005; (149) U.S. National Stage application Ser. No. 10/545,941, attorney docket no. 25791.382, filed on Aug. 17, 2005; (150) U.S. National Stage application Ser. No. 10/546,078, attorney docket no. 25791.383, filed on Aug. 17, 2005 the disclosures of which are incorporated herein by reference.

In an exemplary embodiment, during the radial expansion and plastic deformation of the first tubular member 2510, the second tubular member 2522, and the external sleeve 2526, the stress concentration grooves, 2514a, 2514b, 2524a, and 2524b, concentrate compressive stresses onto the threads, 2516 and 2518, of the pin and box members, 2512 and 2520, of the first and second tubular members to drive the threads together to thereby provide a fluid tight seal between the threads of the pin and box members of the first and second tubular members upon the completion of the radial expansion and plastic deformation.

FIG. 44 is an illustration of another illustrative embodiment.

It is understood that variations may be made in the foregoing without departing from the scope of the invention. For example, the teachings of the present illustrative embodiments may be used to provide an insulated wellbore casing, a pipeline, or a structural support. Furthermore, the elements and teachings of the various illustrative embodiments may be combined in whole or in part in some or all of the illustrative embodiments. In addition, the external sleeve 2526 may be omitted. Furthermore, one or more of the stress concentration grooves, 2514a, 2514b, 2524a, and/or 2524b, may be omitted. In addition, the stress concentration grooves, 2514a, 2514b, 2524a, and/or 2524b may be provided in any geometric shape capable of concentrating stresses. Furthermore, the stress concentration grooves, 2514a and 2514b, may or may not be positioned in opposing relation to the stress concentration grooves, 2524a and 2524b. In addition, the first and second tubular members, 2510 and 2522, may or may not be threadably coupled to one another, and the threads, 2516 and 2518, of the first and second tubular members may be any type of threads.

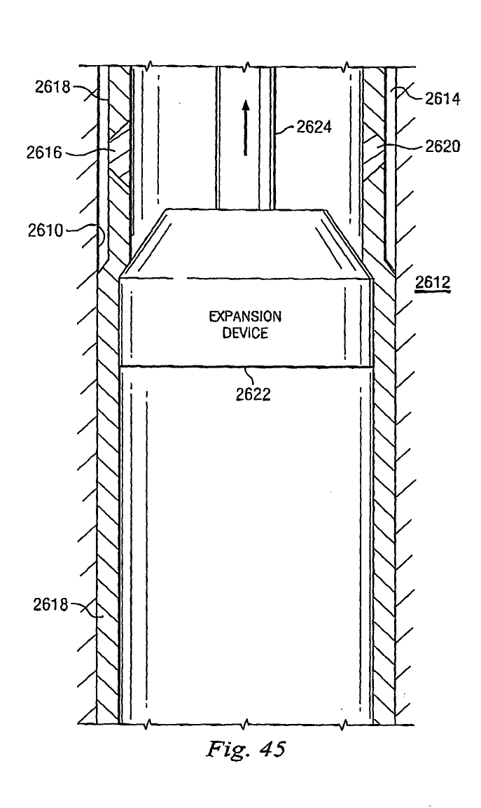

Referring to FIG. 45, a wellbore 2610 that traverses a subterranean formation 2612 includes a tubular assembly 2614 positioned therein. The tubular assembly 2614 includes a first tubular 2616 threadably coupled to a second tubular 2618 by a conventional threaded connection 2620. In order to radially expand and plastically deform the tubular assembly 2614, a conventional expansion device 2622 coupled to a conventional support member 2624 is displaced relative to the tubular assembly in a longitudinal direction. As will be recognized by persons having ordinary skill in the art, the threaded connection 2620 includes external threads formed on an exterior surface of the first tubular 2616 and mating external threads formed on an internal surface of the second tubular 2618.

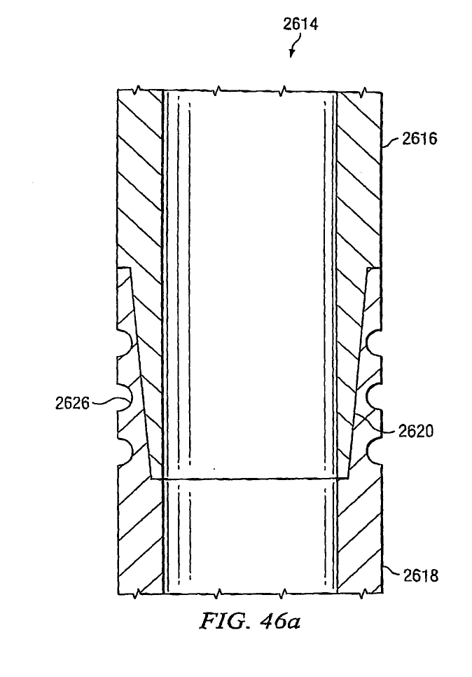

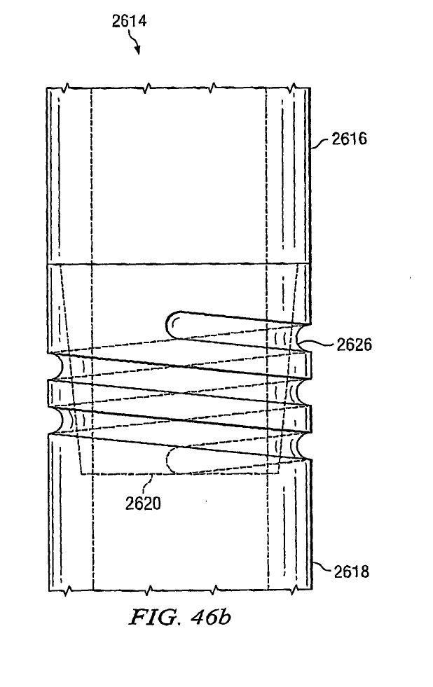

As illustrated in FIGS. 46a and 46b, in an exemplary embodiment, a spiral groove 2626 is defined in the exterior surface of the second tubular 2618 proximate and in opposing relation to at least a portion of the threaded connection 2620. In this manner, the spiral groove 2626 provides a stress concentration element that, during the radial expansion and plastic deformation of the tubular assembly 2614 by the expansion device 2622, enhances and concentrates the forces applied to the mating threads of the threaded connection 2620. As a result, a fluid tight connection is provided within the threaded connection 2620 following the radial expansion and plastic deformation of the threaded connection.

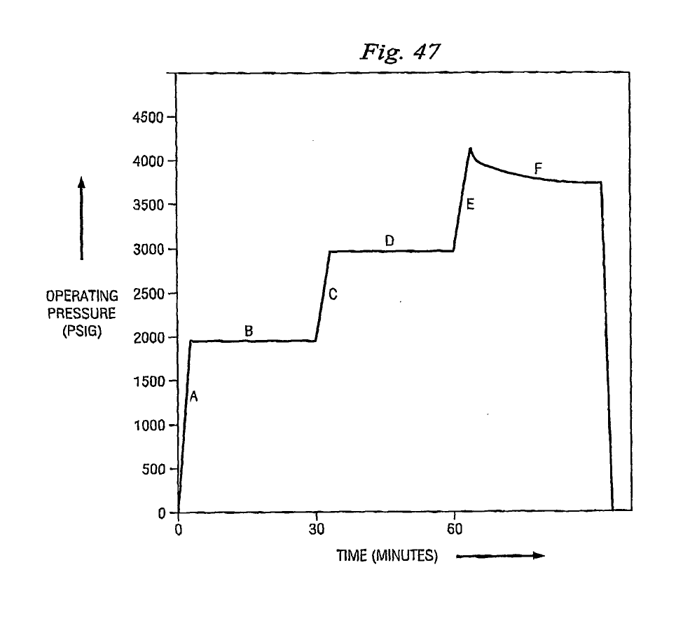

Referring now to FIG. 47, during an exemplary experimental test of the tubular assembly 2614, the first and second tubulars, 2616 and 2618, were threadably coupled, and then radially expanded and plastically deformed using the expansion device 2622. Throughout the experimental test, the interior of the tubular assembly 2614 was pressurized using a fluidic materials and the corresponding operating pressure (PSIG) within the tubular assembly 2614 was monitored.

In particular, following the threaded coupling of the first and second tubulars, 2616 and 2618, the tubular assembly 2614 was pressurized using a fluidic material as indicated by the portion A of FIG. 47 and was able to contain a fluid pressure of about 2000 psi for at least about 30 minutes as indicated by the portion B of FIG. 47 Thus, before radial expansion and plastic deformation, the threaded connection 2620 was capable of withstanding approximately 2000 psi as illustrated by the portion B of FIG. 47.

The radial expansion of the threaded connection 2620 was then begun using the expansion device 2622 which initially caused an elastic expansion of the threaded connection. As the stress in the threaded connection 2620 increased, the sealing capacity of the threaded connection increased to about 3000 psi as illustrated by the portion C of FIG. 47. The additional stress allowed the stress concentration elements to create zones of increased stress which increased the sealing capability of the threaded connection 2620.

During continued operation of the expansion device 2622, the stress in the threaded connection 2620 remained relatively constant as further expansion caused the stress in the threaded connection 2620 to move from the elastic to the plastic range as illustrated by the portion D of FIG. 47 during which the sealing capacity of the threaded connection remained at about 3000 psi.

Further operation of the expansion device 2622 caused the stress in the threaded connection 2620 to increase as the stress approached the yield stress. This additional increase in stress, caused an additional increase in the sealing capacity of the threaded connection as illustrated by the portion E of FIG. 47. Further operation of the expansion device caused a failure of the connection and a drop in the operating pressure as indicated by the portion F of FIG. 47.

As illustrated in FIG. 47, during the exemplary experimental test of the tubular assembly 2614, the sealing capacity of the threaded connection 2620 increased after being radially expanded. This was an unexpected result.

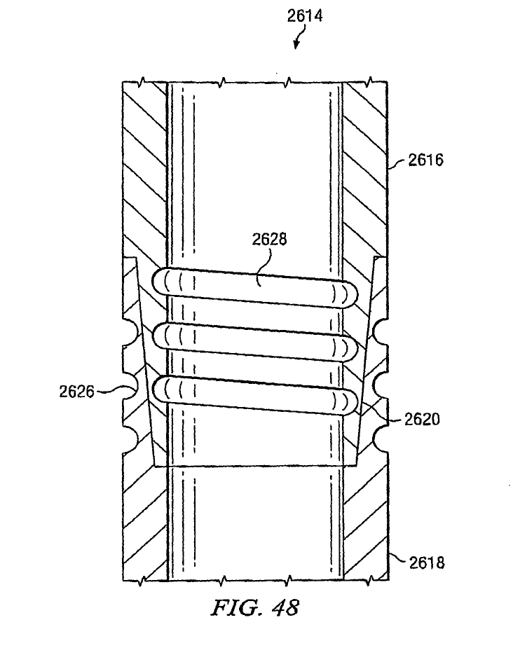

Referring now to FIG. 48, in an alternative embodiment, a spiral groove 2628 is defined in the interior surface of the first tubular 2616 proximate and in opposing relation to at least a portion of the threaded connection 2620. In this manner, the spiral grooves 2626 and 2628 provides stress concentration elements that, during the radial expansion and plastic deformation of the tubular assembly 2614 by the expansion device 2622, enhance and concentrates the forces applied to the mating threads of the threaded connection 2620. As a result, a fluid tight connection is provided within the threaded connection 2620 following the radial expansion and plastic deformation of the threaded connection.

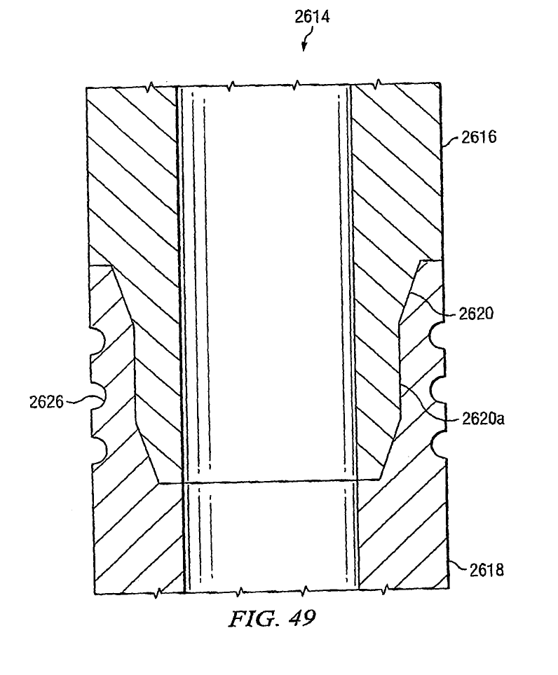

Referring now to FIG. 49, in an alternative embodiment, the threaded connection 2620 includes at least one portion 2620a that is not threaded. In this manner, the spiral grooves 2626 and 2628 provides stress concentration elements that, during the radial expansion and plastic deformation of the tubular assembly 2614 by the expansion device 2622, enhance and concentrates the forces applied to the mating threads of the threaded portions of the threaded connection 2620. Furthermore, the addition of the non threaded portion 2620a to the threaded connection 2620 further enhances the stress concentration effect of the spiral grooves 2626 and 2628. As a result, a fluid tight connection is provided within the threaded connection 2620 following the radial expansion and plastic deformation of the threaded connection.

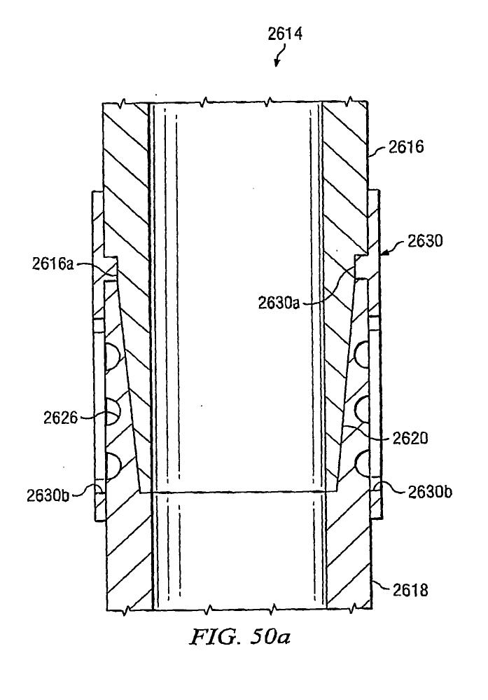

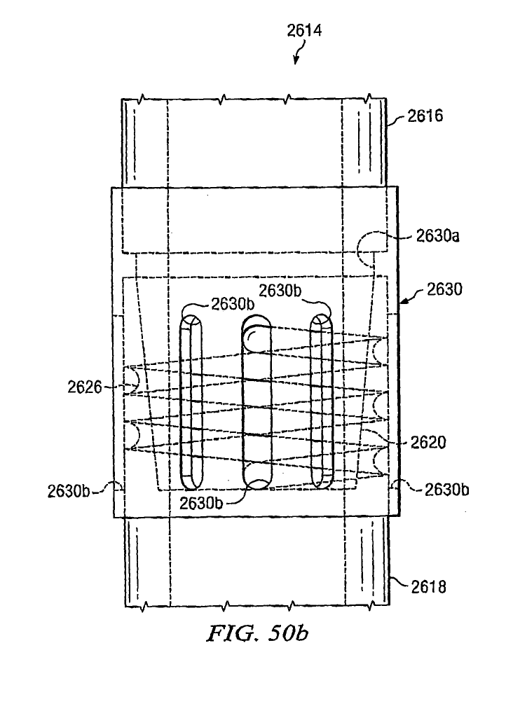

Referring now to FIGS. 50a and 50b, in an alternative embodiment, the threaded connection 2620 includes a connector sleeve 2630 that receives and mates with the ends of the first and second tubulars, 2616 and 2618, and includes an internal flange 2630a that is received within and mates with an annulus defined within the exterior surface of the first tubular 2616 proximate an end face of the second tubular 2618. The connector sleeve 2630 further defines a plurality of circumferentially spaced apart longitudinal slots 2630b that intersect the spiral grooves 2626. In this manner, the spiral grooves 2626 and the slots 2630b provide stress concentration elements that, during the radial expansion and plastic deformation of the tubular assembly 2614 by the expansion device 2622, enhance and concentrates the forces applied to the mating threads of the threaded portions of the threaded connection 2620. As a result, a fluid tight connection is provided within the threaded connection 2620 following the radial expansion and plastic deformation of the threaded connection.

In one embodiment, system 2610 may be used to radially expand and plastically deform the tubular members, 2616 and 2618, by displacing the expansion device 2622 in longitudinal direction in a conventional manner and/or by rotating the expansion device relative to tubular members in a conventional manner and/or by expanding the size of the expansion device in a conventional manner within the tubular members.

The operation and design of the embodiments described with reference to FIGS. 45, 46a, 46b, 47, 48, 49, 50a, and 50b above may also be implemented using one or more of the apparatus and methods as disclosed in one or more of the following: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25.791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application. Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of, U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999, (122) PCT patent application serial no. PCT/US2004/06246, attorney docket no. 25791.238.02, filed on Feb. 26, 2004, (123) PCT patent application serial number PCT/US2004/08170, attorney docket number 25791.40.02, filed on Mar. 15, 2004, (124) PCT patent application serial number PCT/US2004/08171, attorney docket number 25791.236.02, filed on Mar. 15, 2004, (125) PCT patent application serial number PCT/US2004/08073, attorney docket number 25791.262.02, filed on Mar. 18, 2004, (126) PCT patent application serial number PCT/US2004/07711, attorney docket number 25791.253.02, filed on Mar. 11, 2004, (127) PCT patent application serial number PCT/US2004/029025, attorney docket number 25791.260.02, filed on Mar. 26, 2004, (128) PCT patent application serial number PCT/US2004/010317, attorney docket number 25791.270.02, filed on Apr. 2, 2004, (129) PCT patent application serial number PCT/US2004/010712, attorney docket number 25791.272.02, filed on Apr. 6, 2004, (130) PCT patent application serial number PCT/US2004/010762, attorney docket number 25791.273.02, filed on Apr. 6, 2004, (131) PCT patent application serial number PCT/US2004/011973, attorney docket number 25791.277.02, filed on Apr. 15, 2004, (132) U.S. provisional patent application Ser. No. 60/495,056, attorney docket number 25791.301, filed on Aug. 14, 2003, (133) U.S. provisional patent application Ser. No. 60/600,679, attorney docket number 25791.194, filed on Aug. 11, 2004, (134) PCT patent application serial number PCT/US2005/027318, attorney docket number 25791.329.02, filed on Jul. 29, 2005, the disclosures of which are incorporated herein by reference. (135) PCT patent application serial number PCT/US2005/028936, attorney docket number 25791.338.02, filed on Aug. 12, 2005, (136) PCT patent application serial number PCT/US2005/028669, attorney docket number 25791.194.02, filed on Aug. 11, 2005, (137) PCT patent application serial number PCT/US2005/028453, attorney docket number 25791.371, filed on Aug. 11, 2005, (138) PCT patent application serial number PCT/US2005/028641, attorney docket number 25791.372, filed on Aug. 11, 2005, (139) PCT patent application serial number PCT/US2005/028819, attorney docket number 25791.373, filed on Aug. 11, 2005, (140) PCT patent application serial number PCT/US2005/028446, attorney docket number 25791.374, filed on Aug. 11, 2005, (141) PCT patent application serial number PCT/US2005/028642, attorney docket number 25791.375, filed on Aug. 11, 2005, (142) PCT patent application serial number PCT/US2005/028451, attorney docket number 25791.376, filed on Aug. 11, 2005, and (143). PCT patent application serial number PCT/US2005/028473, attorney docket number 25791.377, filed on Jul. 29, 2005, (144) U.S. National Stage application Ser. No. 10/546,084, attorney docket no. 25791.185.05, filed on Aug. 17, 2005; (145) U.S. National Stage application Ser. No. 10/546,082, attorney docket no. 25791.378, filed on Aug. 17, 2005; (146) U.S. National Stage application Ser. No. 10/546,076, attorney docket no. 25791.379, filed on Aug. 17, 2005; (147) U.S. National Stage application Ser. No. 10/546,936, attorney docket no. 25791.380, filed on Aug. 17, 2005; (148) U.S. National Stage application Ser. No. 10/546,079, attorney docket no. 25791.381, filed on Aug. 17, 2005; (149) U.S. National Stage application Ser. No. 10/545,941, attorney docket no. 25791.382, filed on Aug. 17, 2005; (150) U.S. National Stage application Ser. No. 10/546,078, attorney docket no. 25791.383, filed on Aug. 17, 2005 the disclosures of which are incorporated herein by reference.

In several alternative embodiments, the threaded connection 2620 is a pin and box connection.

In several alternative embodiments, the cross sectional shape of the spiral grooves, 2626 and 2628, may, for example, be semi-circular, square, triangular, elliptical, or other shapes capable of providing a stress concentration element.

In several alternative embodiments, one or both of the spiral grooves, 2626 and 2628, are aligned with the first full point of full form internal threads of the threaded connection 2620.

In several alternative embodiments, one or both of the spiral grooves, 2626 and 2628, form a helical spiral that may be left-handed or right-handed.

In several alternative embodiments, one or both of the spiral grooves, 2626 and 2628, correspond to the interior thread roots of the internal connecting threads of the threaded connection 2620.

In several alternative embodiments, one or both of spiral grooves, 2626 and 2628, are axially aligned with and are radially offset from the internal connecting threads of the threaded connection 2620.

In several alternative embodiments, a stress concentration element, for example, in the form of a plurality of grooves defined in the exterior surface of the second tubular 2618 proximate to the threaded connection 2620 may be substituted for, or used in addition to, the spiral grooves 2626.

In several alternative embodiments, a stress concentration element, for example, in the form of a plurality of circular or radial grooves defined in the exterior surface of the second tubular 2618 proximate the threaded connection 2620 may be substituted for, or used in addition to, the spiral grooves 2626.

In several alternative embodiments, a stress concentration element, for example, in the form of longitudinal or axial grooves defined in the exterior surface of the second tubular 2618 proximate the threaded connection 2620 may be substituted for, or used in addition to, the spiral grooves 2626.

In several alternative embodiments, a stress concentration element, for example, in the form of a plurality of parallel grooves defined in the exterior surface of the second tubular 2618 proximate the threaded connection 2620, intersecting an angle with a longitudinal axis of the second tubular between about 15 and about 75 degrees or between about 30 and 60 degrees may be substituted for, or used in addition to, the spiral grooves 2626.

In several alternative embodiments, a stress concentration element, for example, in the form of a plurality of grooves defined in the interior surface of the first tubular 2616 proximate to the threaded connection 2620 may be substituted for, or used in addition to, the spiral grooves 2628.

In several alternative embodiments, a stress concentration element, for example, in the form of a plurality of circular or radial grooves defined in the interior surface of the first tubular 2616 proximate the threaded connection 2620 may be substituted for, or used in addition to, the spiral grooves 2628.

In several alternative embodiments, a stress concentration element, for example, in the form of longitudinal or axial grooves defined in the interior surface of the first tubular 2616 proximate the threaded connection 2620 may be substituted for, or used in addition to, the spiral grooves 2628.

In several alternative embodiments, a stress concentration element, for example, in the form of a plurality of parallel grooves defined in the interior surface of the first tubular 2616 proximate the threaded connection 2620, intersecting an angle with a longitudinal axis of the first tubular between about 15 and about 75 degrees or between about 30 and 60 degrees may be substituted for, or used in addition to, the spiral grooves 2628.

In an exemplary embodiment, the internal threads of the threaded connection 2620 have a left handed orientation, a thread taper of 0.750 inches per foot, thread roots and thread crests that are parallel to the thread taper, and a thread pitch of 5 threads per inch, and the external threads of the threaded connection have a left handed orientation, a thread taper of 0.750 inches per foot, thread roots and thread crests that are parallel to the thread taper, and a thread pitch of 5 threads per inch. In an exemplary embodiment, the internal and/or external threads of the threaded connection align with an axis of the threaded connection to within plus or minus about 0.5 degrees.

In several alternative embodiments, one or more of the spiral grooves, 2626 and 2628, are axially aligned with and radially offset from the thread root of the internal and or external threads of the threaded connection.

In several alternative embodiments, one or more of the spiral grooves, 2626 and 2628, are positioned in opposition to the thread roots of the internal and/or external threads of the threaded connection 2620.

In several exemplary embodiments, the non-threaded portion 2620a of the threaded connection 2620 includes a plurality of stepped cylindrical portions defined to create a plurality of stepped concentric cylindrical surfaces in the non-threaded portion of the threaded connection.

In several exemplary embodiments, the non-threaded portion 2620a of the threaded connection 2620 includes a spiraled portion.

In several alternative embodiments, a stress concentration element such as, for example, grooves defined with the internal and/or external surface of the connector sleeve 2630 may be substituted for, or used in addition to, the slots 2630b.

In several alternative embodiments, the slots 2630b of the connector sleeve 2630 are aligned with the longitudinal axis of the tubular assembly 2614.

In several alternative embodiments, the internal diameter of the connector sleeve 2630 is at least approximately 0.020″ greater than the exterior diameter of the second tubular 2618. In this manner, during the threaded coupling of the first and second tubulars, 2616 and 2618, fluidic materials within the first and second tubulars may be vented from the members.

In several alternative embodiments, following the radial expansion and plastic deformation of the first and second tubulars, 2616 and 2618, and the connector sleeve 2630, using the expansion device 2622, the connector sleeve 2630 is maintained in circumferential tension and the threadably coupled end portions of the first and second tubulars are maintained in circumferential compression.

In several alternative embodiments, the use of the connector sleeve 2630 during (a) the coupling of the first tubular 2616 to the second tubular 2618, (b) the placement of the first and second tubulars within the wellbore 2610, and (c) the radial expansion and plastic deformation of the tubular assembly 2614 may provide a number of significant benefits. For example, connector sleeve 2630 may protect the exterior surfaces of end portions of the first and second tubulars, 2616 and 2618, during handling and insertion of the tubular members within the structure. In this manner, damage to the exterior surfaces of the end portions of the first and second tubulars, 2616 and 2618, is prevented that could result in stress concentrations that could result in a catastrophic failure during subsequent radial expansion operations. In addition, during the relative rotation of first and second tubulars, 2616 and 2618, required during the threaded coupling of the first and second tubulars, the connector sleeve 2630 provides an indication as to what degree the first and second tubulars are threadably coupled. For example, if the connector sleeve 2630 can be easily rotated, that would indicate that the first and second tubulars, 2616 and 2618, are not fully threadably coupled and in intimate contact with internal flange 2630a of the connector sleeve 2630. Furthermore, the connector sleeve 2630 may prevent crack propagation during the radial expansion and plastic deformation of the tubular assembly 2614. In this manner, failure modes such as, for example, longitudinal cracks in the end portions of the first and second tubulars, 2616 and 2618, be limited in severity or eliminated all together.

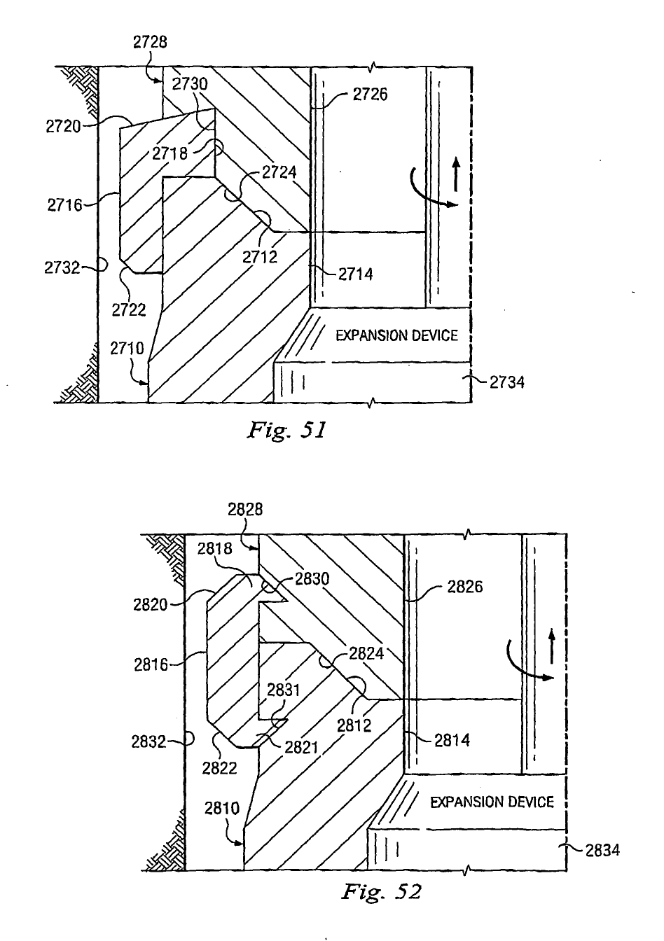

Referring to FIG. 51 in an exemplary embodiment, a first tubular member 2710 includes an internally threaded connection 2712 at an end portion 2714. A first end of a tubular sleeve 2716 that includes an internal flange 2718 having a tapered portion 2720, and a second end that includes a tapered portion 2722, is then mounted upon and receives the end portion 2714 of the first tubular member 110. In an exemplary embodiment, the end portion 114 of the first tubular member 2710 abuts one side of the internal flange 2718 of the tubular sleeve 2716, and the internal diameter of the internal flange 2718 of the tubular sleeve 2716 is substantially equal to or greater than the maximum internal diameter of the internally threaded connection 2712 of the end portion 2714 of the first tubular member 2710. An externally threaded connection 2724 of an end portion 2726 of a second tubular member 2728 having an annular recess 2730 is then positioned within the tubular sleeve 2716 and threadably coupled to the internally threaded connection 2712 of the end portion 2714 of the first tubular member 2710. In an exemplary embodiment, the internal flange 2718 of the tubular sleeve 2716 mates with and is received within the annular recess 2730 of the end portion 2726 of the second tubular member 2728. Thus, the tubular sleeve 2716 is coupled to and surrounds the external surfaces of the first and second tubular members, 2710 and 2728.

The internally threaded connection 2712 of the end portion 2714 of the first tubular member 2710 is a box connection, and the externally threaded connection 2724 of the end portion 2726 of the second tubular member 2728 is a pin connection. In an exemplary embodiment, the internal diameter of the tubular sleeve 2716 is at least approximately 0.020″ greater than the outside diameters of the first and second tubular members, 2710 and 2728. In this manner, during the threaded coupling of the first and second tubular members, 2710 and 2728, fluidic materials within the first and second tubular members may be vented from the tubular members.

As illustrated in FIG. 51, the first and second tubular members, 2710 and 2728, and the tubular sleeve 2716 may be positioned within another structure 2732 such as, for example, a cased or uncased wellbore, and radially expanded and plastically deformed, for example, by displacing and/or rotating a conventional expansion device 2734 within and/or through the interiors of the first and second tubular members. The tapered portions, 2720 and 2722, of the tubular sleeve 2716 facilitate the insertion and movement of the first and second tubular members within and through the structure 2732, and the movement of the expansion device 2734 through the interiors of the first and second tubular members, 2710 and 2728, may be from top to bottom or from bottom to top.

During the radial expansion and plastic deformation of the first and second tubular members, 2710 and 2728, the tubular sleeve 2716 is also radially expanded and plastically deformed. As a result, the tubular sleeve 2716 may be maintained in circumferential tension and the end portions, 2714 and 2726, of the first and second tubular members, 2710 and 2728, may be maintained in circumferential compression.

Sleeve 2716 increases the axial compression loading of the connection between tubular members 2710 and 2728 before and after expansion by the expansion device 2734. Sleeve 2716 may be secured to tubular members 2710 and 2728 by a heat shrink fit.

In several alternative embodiments, the first and second tubular members, 2710 and 2728, are radially expanded and plastically deformed using other conventional methods for radially expanding and plastically deforming tubular members such as, for example, internal pressurization, hydroforming, and/or roller expansion devices and/or any one or combination of the conventional commercially available expansion products and services available from Baker Hughes, Weatherford International, and/or Enventure Global Technology L.L.C.

The use of the tubular sleeve 2716 during (a) the coupling of the first tubular member 2710 to the second tubular member 2728, (b) the placement of the first and second tubular members in the structure 2732, and (c) the radial expansion and plastic deformation of the first and second tubular members provides a number of significant benefits. For example, the tubular sleeve 2716 protects the exterior surfaces of the end portions, 2714 and 2726, of the first and second tubular members, 2710 and 2728, during handling and insertion of the tubular members within the structure 2732. In this manner, damage to the exterior surfaces of the end portions, 2714 and 2726, of the first and second tubular members, 2710 and 2728, is avoided that could otherwise result in stress concentrations that could cause a catastrophic failure during subsequent radial expansion operations. Furthermore, the tubular sleeve 2716 provides an alignment guide that facilitates the insertion and threaded coupling of the second tubular Member 2728 to the first tubular member 2710. In this manner, misalignment that could result in damage to the threaded connections, 2712 and 2724, of the first and second tubular members, 2710 and 2728, may be avoided. In addition, during the relative rotation of the second tubular member with respect to the first tubular member, required during the threaded coupling of the first and second tubular members, the tubular sleeve 2716 provides an indication of to what degree the first and second tubular members are threadably coupled. For example, if the tubular sleeve 2716 can be easily rotated, that would indicate that the first and second tubular members, 2710 and 2728, are not fully threadably coupled and in intimate contact with the internal flange 2718 of the tubular sleeve. Furthermore, the tubular sleeve 2716 may prevent crack propagation during the radial expansion and plastic deformation of the first and second tubular members, 2710 and 2728. In this manner, failure modes such as, for example, longitudinal cracks in the end portions, 2714 and 2726, of the first and second tubular members may be limited in severity or eliminated all together. In addition, after completing the radial expansion and plastic deformation of the first and second tubular members, 2710 and 2728, the tubular sleeve 2716 may provide a fluid tight metal-to-metal seal between interior surface of the tubular sleeve 2716 and the exterior surfaces of the end portions, 2714 and 2726, of the first and second tubular members. In this manner, fluidic materials are prevented from passing through the threaded connections, 2712 and 2724, of the first and second tubular members, 2710 and 2728, into the annulus between the first and second tubular members and the structure 2732. Furthermore, because, following the radial expansion and plastic deformation of the first and second tubular members, 2710 and 2728, the tubular sleeve 2716 may be maintained in circumferential tension and the end portions, 2714 and 2726, of the first and second tubular members, 2710 and 2728, may be maintained in circumferential compression, axial loads and/or torque loads may be transmitted through the tubular sleeve.

Referring to FIG. 52, in an exemplary embodiment, a first tubular member 2810 includes an internally threaded connection 2812 at an end portion 2814. A first end of a tubular sleeve 2816 includes an internal flange 2818 and a tapered portion 2820. A second end of the sleeve 2816 includes an internal flange 2821 and a tapered portion 2822. An externally threaded connection 2824 of an end portion 2826 of a second tubular member 2828 having an annular recess 2830, is then positioned within the tubular sleeve 2816 and threadably coupled to the internally threaded connection 2812 of the end portion 2814 of the first tubular member 2810. The internal flange 2818 of the sleeve 2816 mates with and is received within the annular recess 2830.

The first tubular member 2810 includes a recess 2831. The internal flange 2821 mates with and is received within the annular recess 2831. Thus, the sleeve 2816 is coupled to and surrounds the external surfaces of the first and second tubular members 2810 and 2828.

The internally threaded connection 2812 of the end portion 2814 of the first tubular member 2810 is a box connection, and the externally threaded connection 2824 of the end portion 2826 of the second tubular member 2828 is a pin connection. In an exemplary embodiment, the internal diameter of the tubular sleeve 2816 is at least approximately 0.020″ greater than the outside diameters of the first and second tubular members 2810 and 2828. In this manner, during the threaded coupling of the first and second tubular members 2810 and 2828, fluidic materials within the first and second tubular members may be vented from the tubular members.

As illustrated in FIG. 52, the first and second tubular members 2810 and 2828, and the tubular sleeve 2816 may then be positioned within another structure 2832 such as, for example, a wellbore, and radially expanded and plastically deformed, for example, by displacing and/or rotating an expansion device 2834 through and/or within the interiors of the first and second tubular members. The tapered portions 2820 and 2822, of the tubular sleeve 2816 facilitates the insertion and movement of the first and second tubular members within and through the structure 2832, and the displacement of the expansion device 2834 through the interiors of the first and second tubular members 2810 and 2828, may be from top to bottom or from bottom to top.

During the radial expansion and plastic deformation of the first and second tubular members 2810 and 2828, the tubular sleeve 2816 is also radially expanded and plastically deformed. In an exemplary embodiment, as a result, the tubular sleeve 2816 may be maintained in circumferential tension and the end portions 2814 and 2826, of the first and second tubular members 2810 and 2828, may be maintained in circumferential compression.

Sleeve 2816 increases the axial tension loading of the connection between tubular members 2810 and 2828 before and after expansion by the expansion device 2834. Sleeve 2816 may be secured to tubular members 2810 and 2828 by a heat shrink fit.

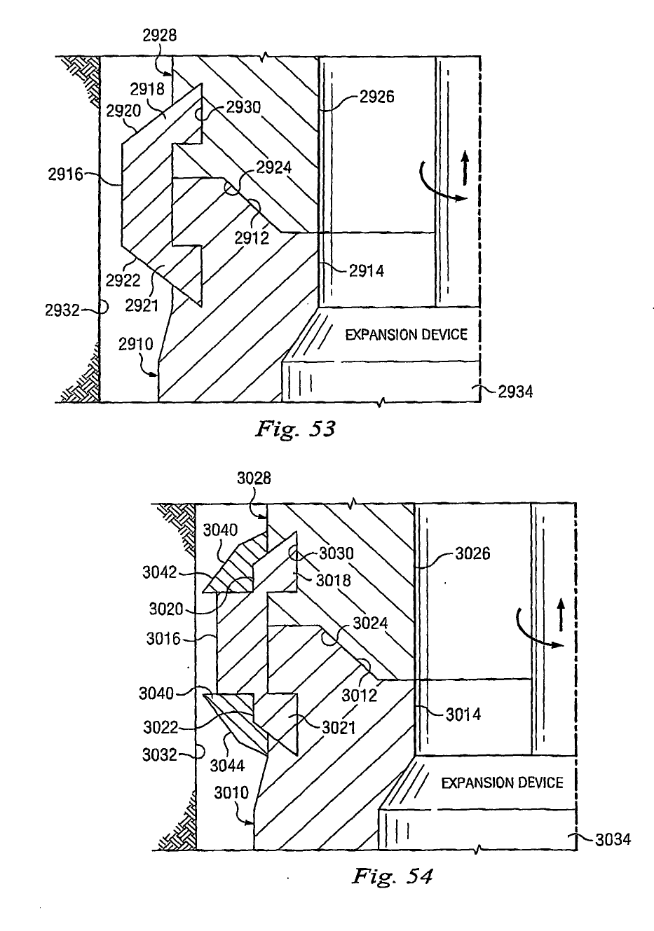

Referring to FIG. 53, in an exemplary embodiment, a first tubular member 2910 includes an internally threaded connection 2912 at an end portion 2914. A first end of a tubular sleeve 2916 includes an internal flange 2918 and a tapered portion 2920. A second end of the sleeve 2916 includes an internal flange 2921 and a tapered portion 2922. An externally threaded connection 2924 of an end portion 2926 of a second tubular member 2928 having an annular recess 2930, is then positioned within the tubular sleeve 2916 and threadably coupled to the internally threaded connection 2912 of the end portion 2914 of the first tubular member 2910. The internal flange 2918 of the sleeve 2916 mates with and is received within the annular recess 2930. The first tubular member 2910 includes a recess 2931. The internal flange 2921 mates with and is received within the annular recess 2931. Thus, the sleeve 2916 is coupled to and surrounds the external surfaces of the first and second tubular members 2910 and 2928.

The internally threaded connection 2912 of the end portion 2914 of the first tubular member 2910 is a box connection, and the externally threaded connection 2924 of the end portion 2926 of the second tubular member 2928 is a pin connection. In an exemplary embodiment, the internal diameter of the tubular sleeve 2916 is at least approximately 0.020″ greater than the outside diameters of the first and second tubular members 2910 and 2928. In this manner, during the threaded coupling of the first and second tubular members 2910 and 2928, fluidic materials within the first and second tubular members may be vented from the tubular members.

As illustrated in FIG. 53, the first and second tubular members 2910 and 2928, and the tubular sleeve 2916 may then be positioned within another structure 2932 such as, for example, a wellbore, and radially expanded and plastically deformed, for example, by displacing and/or rotating an expansion device 2934 through and/or within the interiors of the first and second tubular members. The tapered portions 2920 and 2922, of the tubular sleeve 2916 facilitate the insertion and movement of the first and second tubular members within and through the structure 2932, and the displacement of the expansion device 2934 through the interiors of the first and second tubular members, 2910 and 2928, may be from top to bottom or from bottom to top.

During the radial expansion and plastic deformation of the first and second tubular members, 2910 and 2928, the tubular sleeve 2916 is also radially expanded and plastically deformed. In an exemplary embodiment, as a result, the tubular sleeve 2916 may be maintained in circumferential tension and the end portions, 2914 and 2926, of the first and second tubular members, 2910 and 2928, may be maintained in circumferential compression.

The sleeve 2916 increases the axial compression and tension loading of the connection between tubular members 2910 and 2928 before and after expansion by expansion device 2924. Sleeve 2916 may be secured to tubular members 2910 and 2928 by a heat shrink fit.

Referring to FIG. 54, in an exemplary embodiment, a first tubular member 3010 includes an internally threaded connection 3012 at an end portion 3014. A first end of a tubular sleeve 3016 includes an internal flange 3018 and a relief 3020. A second end of the sleeve 3016 includes an internal flange 3021 and a relief 3022. An externally threaded connection 3024 of an end portion 3026 of a second tubular member 3028 having an annular recess 3030, is then positioned within the tubular sleeve 3016 and threadably coupled to the internally threaded connection 3012 of the end portion 3014 of the first tubular member 3010. The internal flange 3018 of the sleeve 3016 mates with and is received within the annular recess 3030. The first tubular member 3010 includes a recess 3031. The internal flange 3021 mates with and is received within the annular recess 3031. Thus, the sleeve 3016 is coupled to and surrounds the external surfaces of the first and second tubular members 3010 and 3028.

The internally threaded connection 3012 of the end portion 3014 of the first tubular member 3010 is a box connection, and the externally threaded connection 3024 of the end portion 3026 of the second tubular member 3028 is a pin connection. In an exemplary embodiment, the internal diameter of the tubular sleeve 3016 is at least approximately 0.020″ greater than the outside diameters of the first and second tubular members 3010 and 3028. In this manner, during the threaded coupling of the first and second tubular members 3010 and 3028, fluidic materials within the first and second tubular members may be vented from the tubular members.

As illustrated in FIG. 54, the first and second tubular members 3010 and 3028, and the tubular sleeve 3016 may then be positioned within another structure 3032 such as, for example, a wellbore, and radially expanded and plastically deformed, for example, by displacing and/or rotating an expansion device 3034 through and/or within the interiors of the first and second tubular members. The reliefs 3020 and 3022 are each filled with a sacrificial material 3040 including a tapered surface 3042 and 3044, respectively. The material 3040 may be a metal or a synthetic, and is provided to facilitate the insertion and movement of the first and second tubular members 3010 and 3028, through the structure 3032. The displacement of the expansion device 3034 through the interiors of the first and second tubular members 3010 and 3028, may be from top to bottom or from bottom to top.

During the radial expansion and plastic deformation of the first and second tubular members 3010 and 3028, the tubular sleeve 3016 is also radially expanded and plastically deformed. In an exemplary embodiment, as a result, the tubular sleeve 3016 may be maintained in circumferential tension and the end portions 3014 and 3026, of the first and second tubular members, 3010 and 3028, may be maintained in circumferential compression.

The addition of the sacrificial material 3040, provided on sleeve 3016, avoids stress risers on the sleeve 3016 and the tubular member 3010. The tapered surfaces 3042 and 3044 are intended to wear or even become damaged, thus incurring such wear or damage which would otherwise be borne by sleeve 3016. Sleeve 3016 may be secured to tubular members 3010 and 3028 by a heat shrink fit.

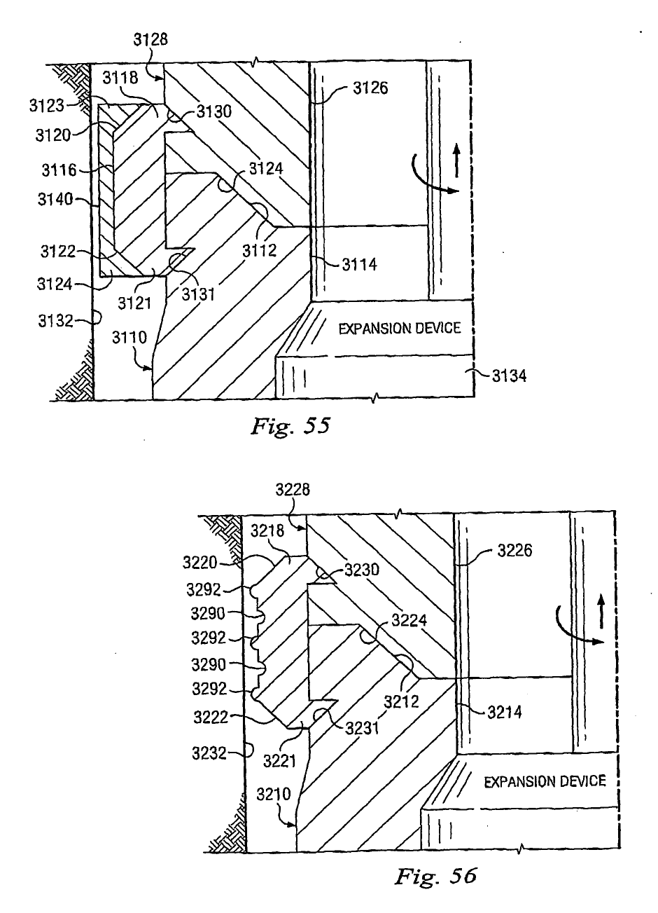

Referring to FIG. 55, in an exemplary embodiment, a first tubular member 3110 includes an internally threaded connection 3112 at an end portion 3114. A first end of a tubular sleeve 3116 includes an internal flange 3118 and a tapered portion 3120. A second end of the sleeve 3116 includes an internal flange 3121 and a tapered portion 3122. An externally threaded connection 3124 of an end portion 3126 of a second tubular member 3128 having an annular recess 3130, is then positioned within the tubular sleeve 3116 and threadably coupled to the internally threaded connection 3112 of the end portion 3114 of the first tubular member 3110. The internal flange 3118 of the sleeve 3116 mates with and is received within the annular recess 3130.

The first tubular member 3110 includes a recess 3131. The internal flange 3121 mates with and is received within the annular recess 3131. Thus, the sleeve 3116 is coupled to and surrounds the external surfaces of the first and second tubular members 3110 and 3128.

The internally threaded connection 3112 of the end portion 3114 of the first tubular member 3110 is a box connection, and the externally threaded connection 3124 of the end portion 3126 of the second tubular member 3128 is a pin connection. In an exemplary embodiment, the internal diameter of the tubular sleeve 3116 is at least approximately 0.020″ greater than the outside diameters of the first and second tubular members 3110 and 3128. In this manner, during the threaded coupling of the first and second tubular members 3110 and 3128, fluidic materials within the first and second tubular members may be vented from the tubular members.

As illustrated in FIG. 55, the first and second tubular members 3110 and 3128, and the tubular sleeve 3116 may then be positioned within another structure 3132 such as, for example, a wellbore, and radially expanded and plastically deformed, for example, by displacing and/or rotating an expansion device 3134 through and/or within the interiors of the first and second tubular members. The tapered portions 3120 and 3122, of the tubular sleeve 3116 facilitates the insertion and movement of the first and second tubular members within and through the structure 3132, and the displacement of the expansion device 3134 through the interiors of the first and second tubular members 3110 and 3128, may be from top to bottom or from bottom to top.

During the radial expansion and plastic deformation of the first and second tubular members 3110 and 3128, the tubular sleeve 3116 is also radially expanded and plastically deformed. In an exemplary embodiment, as a result, the tubular sleeve 3116 may be maintained in circumferential tension and the end portions 3114 and 3126, of the first and second tubular members 3110 and 3128, may be maintained in circumferential compression.

Sleeve 3116 is covered by a thin walled cylinder of sacrificial material 3140. Spaces 3123 and 3124, adjacent tapered portions 3120 and 3122, respectively, are also filled with an excess of the sacrificial material 3140. The material may be a metal or a synthetic, and is provided to facilitate the insertion and movement of the first and second tubular members 3110 and 3128, through the structure 3132.

The addition of the sacrificial material 3140, provided on sleeve 3116, avoids stress risers on the sleeve 3116 and the tubular member 3110. The excess of the sacrificial material 3140 adjacent tapered portions 3120 and 3122 are intended to wear or even become damaged, thus incurring such wear or damage which would otherwise be borne by sleeve 3116. Sleeve 3116 may be secured to tubular members 3110 and 3128 by a heat shrink fit.

Referring to FIG. 56, in an exemplary embodiment, a first tubular member 3210 includes an internally threaded connection 3212 at an end portion 3214. A first end of a tubular sleeve 3216 includes an internal flange 3218 and a tapered portion 3220. A second end of the sleeve 3216 includes an internal flange 3221 and a tapered portion 3222. An externally threaded connection 3224 of an end portion 3226 of a second tubular member 3228 having an annular recess 3230, is then positioned within the tubular sleeve 3216 and threadably coupled to the internally threaded connection 3212 of the end portion 3214 of the first tubular member 3210. The internal flange 3218 of the sleeve 3216 mates with and is received within the annular recess 3230.

The first tubular member 3210 includes a recess 3231. The internal flange 3221 mates with and is received within the annular recess 3231. Thus, the sleeve 3216 is coupled to and surrounds the external surfaces of the first and second tubular members 3210 and 3228.

The internally threaded connection 3212 of the end portion 3214 of the first tubular member 3210 is a box connection, and the externally threaded connection 3224 of the end portion 3226 of the second tubular member 3228 is a pin connection. In an exemplary embodiment, the internal diameter of the tubular sleeve 3216 is at least approximately 0.020″ greater than the outside diameters of the first and second tubular members 3210 and 3228. In this manner, during the threaded coupling of the first and second tubular members 3210 and 3228, fluidic materials within the first and second tubular members may be vented from the tubular members.

As illustrated in FIG. 56, the first and second tubular members 3210 and 3228, and the tubular sleeve 3216 may then be positioned within another structure 3232 such as, for example, a wellbore, and radially expanded and plastically deformed, for example, by displacing and/or rotating an expansion device 3234 through and/or within the interiors of the first and second tubular members. The tapered portions 3220 and 3222, of the tubular sleeve 3216 facilitates the insertion and movement of the first and second tubular members within and through the structure 3232, and the displacement of the expansion device 3234 through the interiors of the first and second tubular members 3210 and 3228, may be from top to bottom or from bottom to top.

During the radial expansion and plastic deformation of the first and second tubular members 3210 and 3228, the tubular sleeve 3216 is also radially expanded and plastically deformed. In an exemplary embodiment, as a result, the tubular sleeve 3216 may be maintained in circumferential tension and the end portions 3214 and 3226, of the first and second tubular members 3210 and 3228, may be maintained in circumferential compression.

Sleeve 3216 has a variable thickness due to one or more reduced thickness portions 3290 and/or increased thickness portions 3292.

Varying the thickness of sleeve 3216 provides the ability to control or induce stresses at selected positions along the length of sleeve 3216 and the end portions 3224 and 3226. Sleeve 3216 may be secured to tubular members 3210 and 3228 by a heat shrink fit.

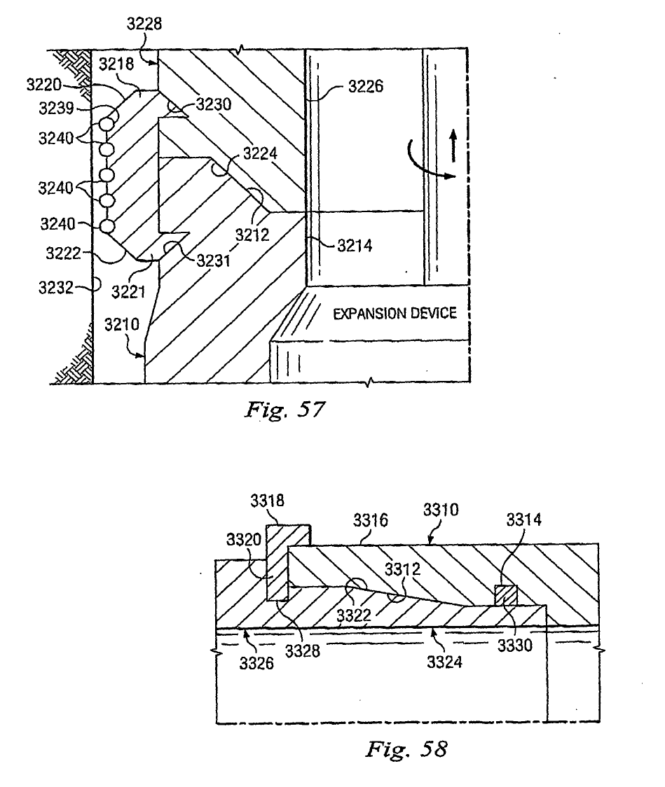

Referring to FIG. 57, in an alternative embodiment, instead of varying the thickness of sleeve 3216, the same result described above with reference to FIG. 56, may be achieved by adding a member 3240 which may be coiled onto the grooves 3239 formed in sleeve 3216, thus varying the thickness along the length of sleeve 3216.

Referring to FIG. 58, in an exemplary embodiment, a first tubular member 3310 includes an internally threaded connection 3312 and an internal annular recess 3314 at an end portion 3316. A first end of a tubular sleeve 3318 includes an internal flange 3320, and a second end of the sleeve 3316 mates with and receives the end portion 3316 of the first tubular member 3310. An externally threaded connection 3322 of an end portion 3324 of a second tubular member 3326 having an annular recess 3328, is then positioned within the tubular sleeve 3318 and threadably coupled to the internally threaded connection 3312 of the end portion 3316 of the first tubular member 3310. The internal flange 3320 of the sleeve 3318 mates with and is received within the annular recess 3328. A sealing element 3330 is received within the internal annular recess 3314 of the end portion 3316 of the first tubular member 3310.

The internally threaded connection 3312 of the end portion 3316 of the first tubular member 3310 is a box connection, and the externally threaded connection 3322 of the end portion 3324 of the second tubular member 3326 is a pin connection. In an exemplary embodiment, the internal diameter of the tubular sleeve 3318 is at least approximately 0.020″ greater than the outside diameters of the first tubular member 3310. In this manner, during the threaded coupling of the first and second tubular members 3310 and 3326, fluidic materials within the first and second tubular members may be vented from the tubular members.

The first and second tubular members 3310 and 3326, and the tubular sleeve 3318 may be positioned within another structure such as, for example, a wellbore, and radially expanded and plastically deformed, for example, by displacing and/or rotating an expansion device through and/or within the interiors of the first and second tubular members.

During the radial expansion and plastic deformation of the first and second tubular members 3310 and 3326, the tubular sleeve 3318 is also radially expanded and plastically deformed. In an exemplary embodiment, as a result, the tubular sleeve 3318 may be maintained in circumferential tension and the end portions 3316 and 3324, of the first and second tubular members 3310 and 3326, respectively, may be maintained in circumferential compression.

In an exemplary embodiment, before, during, and after the radial expansion and plastic deformation of the first and second tubular members 3310 and 3326, and the tubular sleeve 3318, the sealing element 3330 seals the interface between the first and second tubular members. In an exemplary embodiment, during and after the radial expansion and plastic deformation of the first and second tubular members 3310 and 3326, and the tubular sleeve 3318, a metal to metal seal is formed between at least one of: the first and second tubular members 3310 and 3326, the first tubular member and the tubular sleeve 3318, and/or the second tubular member and the tubular sleeve. In an exemplary embodiment, the metal to metal seal is both fluid tight and gas tight.

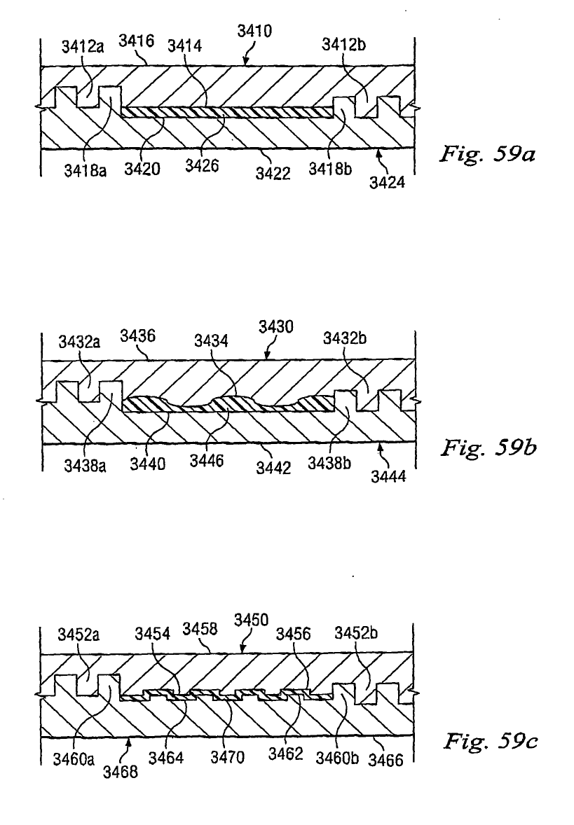

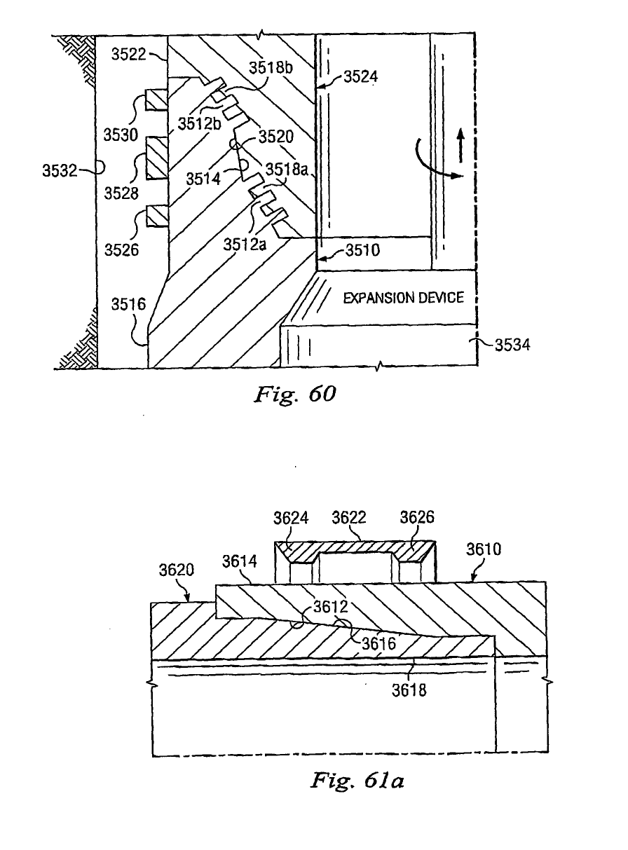

Referring to FIG. 59a, in an exemplary embodiment, a first tubular member 3410 includes internally threaded connections 3412a and 3412b, spaced apart by a cylindrical internal surface 3414, at an end portion 3416. Externally threaded connections 3418a and 3418b, spaced apart by a cylindrical external surface 3420, of an end portion 3422 of a second tubular member 3424 are threadably coupled to the internally threaded connections, 3412a and 3412b, respectively, of the end portion 3416 of the first tubular member 3410. A sealing element 3426 is received within an annulus defined between the internal cylindrical surface 3414 of the first tubular member 3410 and the external cylindrical surface 3420 of the second tubular member 3424.

The internally threaded connections, 3412a and 3412b, of the end portion 3416 of the first tubular member 3410 are box connections, and the externally threaded connections, 3418a and 3418b, of the end portion 3422 of the second tubular member 3424 are pin connections. In an exemplary embodiment, the sealing element 3426 is an elastomeric and/or metallic sealing element.

The first and second tubular members 3410 and 3424 may be positioned within another structure such as, for example, a wellbore, and radially expanded and plastically deformed, for example, by displacing and/or rotating an expansion device through and/or within the interiors of the first and second tubular members.

In an exemplary embodiment, before, during, and after the radial expansion and plastic deformation of the first and second tubular members 3410 and 3424, the sealing element 3426 seals the interface between the first and second tubular members. In an exemplary embodiment, before, during and/or after the radial expansion and plastic deformation of the first and second tubular members 3410 and 3424, a metal to metal seal is formed between at least one of: the first and second tubular members 3410 and 3424, the first tubular member and the sealing element 3426, and/or the second tubular member and the sealing element. In an exemplary embodiment, the metal to metal seal is both fluid tight and gas tight.

In an alternative embodiment, the sealing element 3426 is omitted, and during and/or after the radial expansion and plastic deformation of the first and, second tubular members 3410 and 3424, a metal to metal seal is formed between the first and second tubular members.

Referring to FIG. 59b, in an exemplary embodiment, a first tubular member 3430 includes internally threaded connections 3432a and 3432b, spaced apart by an undulating approximately cylindrical internal surface 3434, at an end portion 3436. Externally threaded connections 3438a and 3438b, spaced apart by a cylindrical external surface 3440, of an end portion 3442 of a second tubular member 3444 are threadably coupled to the internally threaded connections, 3432a and 3432b, respectively, of the end portion 3436 of the first tubular member 3430. A sealing element 3446 is received within an annulus defined between the undulating approximately cylindrical internal surface 3434 of the first tubular member 3430 and the external cylindrical surface 3440 of the second tubular member 3444.

The internally threaded connections, 3432a and 3432b, of the end portion 3436 of the first tubular member 3430 are box connections, and the externally threaded connections, 3438a and 3438b, of the end portion 3442 of the second tubular member 3444 are pin connections. In an exemplary embodiment, the sealing element 3446 is an elastomeric and/or metallic sealing element.

The first and second tubular members 3430 and 3444 may be positioned within another structure such as, for example, a wellbore, and radially expanded and plastically deformed, for example, by displacing and/or rotating an expansion device through and/or within the interiors of the first and second tubular members.

In an exemplary embodiment, before, during, and after the radial expansion and plastic deformation of the first and second tubular members 3430 and 3444, the sealing element 3446 seals the interface between the first and second tubular members. In an exemplary embodiment, before, during and/or after the radial expansion and plastic deformation of the first and second tubular members 3430 and 3444, a metal to metal seal is formed between at least one of: the first and second tubular members 3430 and 3444, the first tubular member and the sealing element 3446, and/or the second tubular member and the sealing element. In an exemplary embodiment, the metal to metal seal is both fluid tight and gas tight.

In an alternative embodiment, the sealing element 3446 is omitted, and during and/or after the radial expansion and plastic deformation of the first and second tubular members 3430 and 3444, a metal to metal seal is formed between the first and second tubular members.

Referring to FIG. 59c, in an exemplary embodiment, a first tubular member 3450 includes internally threaded connections 3452a and 3452b, spaced apart by a cylindrical internal surface 3454 including one or more square grooves 3456, at an end portion 3458. Externally threaded connections 3460a and 3460b, spaced apart by a cylindrical external surface 3462 including one or more square grooves 3464, of an end portion 3466 of a second tubular member 3468 are threadably coupled to the internally threaded connections, 3452a and 3452b, respectively, of the end portion 3458 of the first tubular member 3450. A sealing element 3470 is received within an annulus defined between the cylindrical internal surface 3454 of the first tubular member 3450 and the external cylindrical surface 3462 of the second tubular member 3468.

The internally threaded connections, 3452a and 3452b, of the end portion 3458 of the first tubular member 3450 are box connections, and the externally threaded connections, 3460a and 3460b, of the end portion 3466 of the second tubular member 3468 are pin connections. In an exemplary embodiment, the sealing element 3470 is an elastomeric and/or metallic sealing element.

The first and second tubular members 3450 and 3468 may be positioned within another structure such as, for example, a wellbore, and radially expanded and plastically deformed, for example, by displacing and/or rotating an expansion device through and/or within the interiors of the first and second tubular members.

In an exemplary embodiment, before, during, and after the radial expansion and plastic deformation of the first and second tubular members 3450 and 3468, the sealing element 3470 seals the interface between the first and second tubular members. In an exemplary embodiment, before, during and/or after the radial expansion and plastic deformation of the first and second tubular members, 3450 and 3468, a metal to metal seal is formed between at least one of: the first and second tubular members, the first tubular member and the sealing element 3470, and/or the second tubular member and the sealing element. In an exemplary embodiment, the metal to metal seal is both fluid tight and gas tight.

In an alternative embodiment, the sealing element 3470 is omitted, and during and/or after the radial expansion and plastic deformation of the first and second tubular members 3450 and 3468, a metal to metal seal is formed between the first and second tubular members.

Referring to FIG. 60, in an exemplary embodiment, a first tubular member 3510 includes internally threaded connections, 3512a and 3512b, spaced apart by a non-threaded internal surface 3514, at an end portion 3516. Externally threaded connections, 3518a and 3518b, spaced apart by a non-threaded external surface 3520, of an end portion 3522 of a second tubular member 3524 are threadably coupled to the internally threaded connections, 3512a and 3512b, respectively, of the end portion 3522 of the first tubular member 3524.

First, second, and/or third tubular sleeves, 3526, 3528, and 3530, are coupled the external surface of the first tubular member 3510 in opposing relation to the threaded connection formed by the internal and external threads, 3512a and 3518a, the interface between the non-threaded surfaces, 3514 and 3520, and the threaded connection formed by the internal and external threads, 3512b and 3518b, respectively.

The internally threaded connections, 3512a and 3512b, of the end portion 3516 of the first tubular member 3510 are box connections, and the externally threaded connections, 3518a and 3518b, of the end portion 3522 of the second tubular member 3524 are pin connections.

The first and second tubular members 3510 and 3524, and the tubular sleeves 3526, 3528, and/or 3530, may then be positioned within another structure 3532 such as, for example, a wellbore, and radially expanded and plastically deformed, for example, by displacing and/or rotating an expansion device 3534 through and/or within the interiors of the first and second tubular members.

During the radial expansion and plastic deformation of the first and second tubular members 3510 and 3524, the tubular sleeves 3526, 3528 and/or 3530 are also radially expanded and plastically deformed. In an exemplary embodiment, as a result, the tubular sleeves 3526, 3528, and/or 3530 are maintained in circumferential tension and the end portions 3516 and 3522, of the first and second tubular members 3510 and 3524, may be maintained in circumferential compression.

The sleeve 3526, 3528, and/or 3530 may, for example, be secured to the first tubular member 3510 by a heat shrink fit.

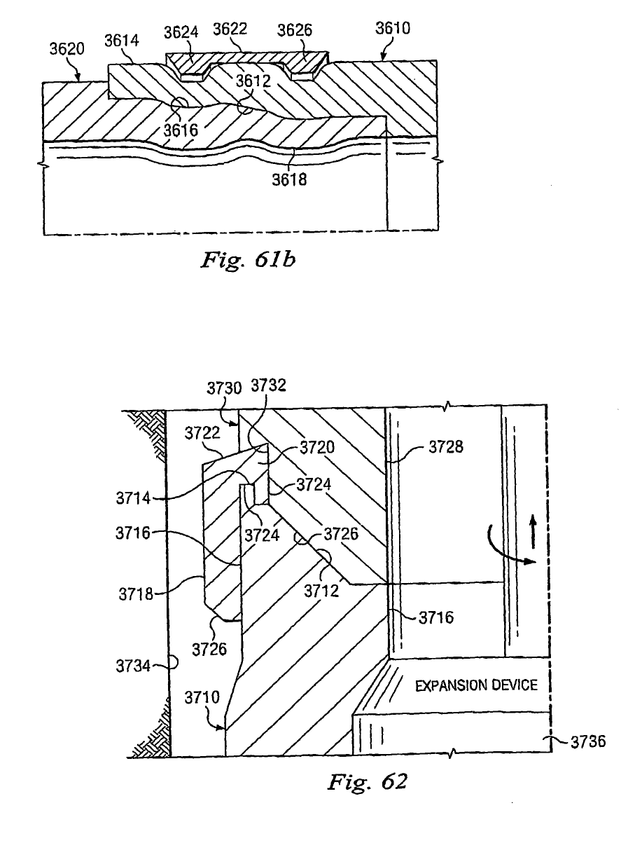

Referring to FIG. 61a, in an exemplary embodiment, a first tubular member 3610 includes an internally threaded connection 3612 at an end portion 3614. An externally threaded connection 3616 of an end portion 3618 of a second tubular member 3620 are threadably coupled to the internally threaded connection 3612 of the end portion 3614 of the first tubular member 3610.

The internally threaded connection 3612 of the end portion 3614 of the first tubular member 3610 is a box connection, and the externally threaded connection 3616 of the end portion 3618 of the second tubular member 3620 is a pin connection.

A tubular sleeve 3622 including internal flanges 3624 and 3626 is positioned proximate and surrounding the end portion 3614 of the first tubular member 3610. As illustrated in FIG. 61b, the tubular sleeve 3622 is then forced into engagement with the external surface of the end portion 3614 of the first tubular member 3610 in a conventional manner. As a result, the end portions, 3614 and 3618, of the first and second tubular members, 3610 and 3620, are upset in an undulating fashion.

The first and second tubular members 3610 and 3620, and the tubular sleeve 3622, may then be positioned within another structure such as, for example, a wellbore, and radially expanded and plastically deformed, for example, by displacing and/or rotating an expansion device through and/or within the interiors of the first and second tubular members.

During the radial expansion and plastic deformation of the first and second tubular members 3610 and 3620, the tubular sleeve 3622 is also radially expanded and plastically deformed. In an exemplary embodiment, as a result, the tubular sleeve 3622 is maintained in circumferential tension and the end portions 3614 and 3618, of the first and second tubular members 3610 and 3620, may be maintained in circumferential compression.

Referring to FIG. 62, in an exemplary embodiment, a first tubular member 3710 includes an internally threaded connection 3712 and an annular projection 3714 at an end portion 3716.

A first end of a tubular sleeve 3718 that includes an internal flange 3720 having a tapered portion 3722 and an annular recess 3724 for receiving the annular projection 3714 of the first tubular member 3710, and a second end that includes a tapered portion 3726, is then mounted upon and receives the end portion 3716 of the first tubular member 3710.

In an exemplary embodiment, the end portion 3716 of the first tubular member 3710 abuts one side of the internal flange 3720 of the tubular sleeve 3718 and the annular projection 3714 of the end portion of the first tubular member mates with and is received within the annular recess 3724 of the internal flange of the tubular sleeve, and the internal diameter of the internal flange 3720 of the tubular sleeve 3718 is substantially equal to or greater than the maximum internal diameter of the internally threaded connection 3712 of the end portion 3716 of the first tubular member 3710. An externally threaded connection 3726 of an end portion 3728 of a second tubular member 3730 having an annular recess 3732 is then positioned within the tubular sleeve 3718 and threadably coupled to the internally threaded connection 3712 of the end portion 3716 of the first tubular member 3710. In an exemplary embodiment, the internal flange 3732 of the tubular sleeve 3718 mates with and is received within the annular recess 3732 of the end portion 3728 of the second tubular member 3730. Thus, the tubular sleeve 3718 is coupled to and surrounds the external surfaces of the first and second tubular members, 3710 and 3728.

The internally threaded connection 3712 of the end portion 3716 of the first tubular member 3710 is a box connection, and the externally threaded connection 3726 of the end portion 3728 of the second tubular member 3730 is a pin connection. In an exemplary embodiment, the internal diameter of the tubular sleeve 3718 is at least approximately 0.020″ greater than the outside diameters of the first and second tubular members, 3710 and 3730. In this manner, during the threaded coupling of the first and second tubular members, 3710 and 3730, fluidic materials within the first and second tubular members may be vented from the tubular members.

As illustrated in FIG. 62, the first and second tubular members, 3710 and 3728, and the tubular sleeve 3716 may be positioned within another structure 3732 such as, for example, a cased or uncased wellbore, and radially expanded and plastically deformed, for example, by displacing and/or rotating a conventional expansion device 3736 within and/or through the interiors of the first and second tubular members. The tapered portions, 3722 and 3726, of the tubular sleeve 3718 facilitate the insertion and movement of the first and second tubular members within and through the structure 3734, and the movement of the expansion device 3736 through the interiors of the first and second tubular members, 3710 and 3730, may be from top to bottom or from bottom to top.

During the radial expansion and plastic deformation of the first and second tubular members, 3710 and 3730, the tubular sleeve 3718 is also radially expanded and plastically deformed. As a result, the tubular sleeve 3718 may be maintained in circumferential tension and the end portions, 3716 and 3728, of the first and second tubular members, 3710 and 3730, may be maintained in circumferential compression.

Sleeve 3716 increases the axial compression loading of the connection between tubular members 3710 and 3730 before and after expansion by the expansion device 3736. Sleeve 3716 may be secured to tubular members 3710 and 3730, for example, by a heat shrink fit.

In, several alternative embodiments, the first and second tubular members, 3710 and 3730, are radially expanded and plastically deformed using other conventional methods for radially expanding and plastically deforming tubular members such as, for example, internal pressurization, hydroforming, and/or roller expansion devices and/or any one or combination of the conventional commercially available expansion products and services available from Baker Hughes, Weatherford International, and/or Enventure Global Technology L.L.C.

The use of the tubular sleeve 3716 during (a) the coupling of the first tubular member 3710 to the second tubular member 3730, (b) the placement of the first and second tubular members in the structure 3734, and (c) the radial expansion and plastic deformation of the first and second tubular members provides a number of significant benefits. For example, the tubular sleeve 3716 protects the exterior surfaces of the end portions, 3716 and 3728, of the first and second tubular members, 3710 and 3730, during handling and insertion of the tubular members within the structure 3734. In this manner, damage to the exterior surfaces of the end portions, 3716 and 3728, of the first and second tubular members, 3710 and 3730, is avoided that could otherwise result in stress concentrations that could cause a catastrophic failure during subsequent radial expansion operations. Furthermore, the tubular sleeve 3716 provides an alignment guide that facilitates the insertion and threaded coupling of the second tubular member 3730 to the first tubular member 3710. In this manner, misalignment that could result in damage to the threaded connections, 3712 and 3728, of the first and second tubular members, 3710 and 3730, may be avoided. In addition, during the relative rotation of the second tubular member with respect to the first tubular member, required during the threaded coupling of the first and second tubular members, the tubular sleeve 3716 provides an indication of to what degree the first and second tubular members are threadably coupled. For example, if the tubular sleeve 3716 can be easily rotated, that would indicate that the first and second tubular members, 3710 and 3730, are not fully threadably coupled and in intimate contact with the internal flange 3720 of the tubular sleeve. Furthermore, the tubular sleeve 3716 may prevent crack propagation during the radial expansion and plastic deformation of the first and second tubular members, 3710 and 3730. In this manner, failure modes such as, for example, longitudinal cracks in the end portions, 3716 and 3728, of the first and second tubular members may be limited in severity or eliminated all together. In addition, after completing the radial expansion and plastic deformation of the first and second tubular members, 3710 and 3730, the tubular sleeve 3716 may provide a fluid tight metal-to-metal seal between interior surface of the tubular sleeve 3716 and the exterior surfaces of the end portions, 3716 and 3728, of the first and second tubular members. In this manner, fluidic materials are prevented from passing through the threaded connections, 3712 and 3726, of the first and second tubular members, 3710 and 3730, into the annulus between the first and second tubular members and the structure 3734. Furthermore, because, following the radial expansion and plastic deformation of the first and second tubular members, 3710 and 3730, the tubular sleeve 3716 may be maintained in circumferential tension and the end portions, 3716 and 3728, of the first and second tubular members, 3710 and 3730, may be maintained in circumferential compression, axial loads and/or torque loads may be transmitted through the tubular sleeve.

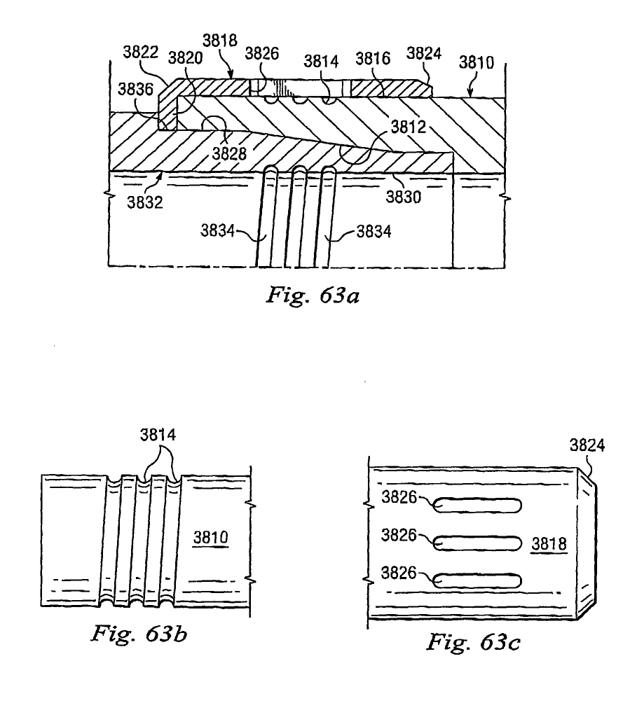

Referring to FIGS. 63a, 63b, and 63c, in an exemplary embodiment, a first tubular member 3810 includes an internally threaded connection 3812 and one or more external grooves 3814 at an end portion 3816.

A first end of a tubular sleeve 3818 that includes an internal flange 3820 and a tapered portion 3822, a second end that includes a tapered portion 3824, and an intermediate portion that includes one or more longitudinally aligned openings 3826, is then mounted upon and receives the end portion 3816 of the first tubular member 3810.

In an exemplary embodiment, the end portion 3816 of the first tubular member 3810 abuts one side of the internal flange 3820 of the tubular sleeve 3818, and the internal diameter of the internal flange 3820 of the tubular sleeve 3816 is substantially equal to or greater than the maximum internal diameter of the internally threaded connection 3812 of the end portion 3816 of the first tubular member 3810. An externally threaded connection 3828 of an end portion 3830 of a second tubular member 3832 that includes one or more internal grooves 3834 is then positioned within the tubular sleeve 3818 and threadably coupled to the internally threaded connection 3812 of the end portion 3816 of the first tubular member 3810. In an exemplary embodiment, the internal flange 3820 of the tubular sleeve 3818 mates with and is received within an annular recess 3836 defined in the end portion 3830 of the second tubular member 3832. Thus, the tubular sleeve 3818 is coupled to and surrounds the external surfaces of the first and second tubular members, 3810 and 3832.

The first and second tubular members, 3810 and 3832, and the tubular sleeve 3818 may be positioned within another structure such as, for example, a cased or uncased wellbore, and radially expanded and plastically deformed, for example, by displacing and/or rotating a conventional expansion device within and/or through the interiors of the first and second tubular members. The tapered portions, 3822 and 3824, of the tubular sleeve 3818 facilitate the insertion and movement of the first and second tubular members within and through the structure, and the movement of the expansion device through the interiors of the first and second tubular members, 3810 and 3832, may be from top to bottom or from bottom to top.

During the radial expansion and plastic deformation of the first and second tubular members, 3810 and 3832, the tubular sleeve 3818 is also radially expanded and plastically deformed. As a result, the tubular sleeve 3818 may be maintained in circumferential tension and the end portions, 3816 and 3830, of the first and second tubular members, 3810 and 3832, may be maintained in circumferential compression.

Sleeve 3816 increases the axial compression loading of the connection between tubular members 3810 and 3832 before and after expansion by the expansion device. The sleeve 3818 may be secured to tubular members 3810 and 3832, for example, by a heat shrink fit.

During the radial expansion and plastic deformation of the first and second tubular members, 3810 and 3832, the grooves 3814 and/or 3834 and/or the openings 3826 provide stress concentrations that in turn apply added stress forces to the mating threads of the threaded connections, 3812 and 3828. As a result, during and after the radial expansion and plastic deformation of the first and second tubular members, 3810 and 3832, the mating threads of the threaded connections, 3812 and 3828, are maintained in metal to metal contact thereby providing a fluid and gas tight connection. In an exemplary embodiment, the orientations of the grooves 3814 and/or 3834 and the openings 3826 are orthogonal to one another. In an exemplary embodiment, the grooves 3814 and/or 3834 are helical grooves.

In several alternative embodiments, the first and second tubular members, 3810 and 3832, are radially expanded and plastically deformed using other conventional methods for radially expanding and plastically deforming tubular members such as, for example, internal pressurization, hydroforming, and/or roller expansion devices and/or any one or combination of the conventional commercially available expansion products and services available from Baker Hughes, Weatherford International, and/or Enventure Global Technology L.L.C.

The use of the tubular sleeve 3818 during (a) the coupling of the first tubular member 3810 to the second tubular member 3832, (b) the placement of the first and second tubular members in the structure, and (c) the radial expansion and plastic deformation of the first and second tubular members provides a number of significant benefits. For example, the tubular sleeve 3818 protects the exterior surfaces of the end portions, 3816 and 3830, of the first and second tubular members, 3810 and 3832, during handling and insertion of the tubular members within the structure. In this manner, damage to the exterior surfaces of the end portions, 3816 and 3830, of the first and second tubular members, 3810 and 3832, is avoided that could otherwise result in stress concentrations that could cause a catastrophic failure during subsequent radial expansion operations. Furthermore, the tubular sleeve 3818 provides an alignment guide that facilitates the insertion and threaded coupling of the second tubular member 3832 to the first tubular member 3810. In this manner, misalignment that could result in damage to the threaded connections, 3812 and 3828, of the first and second tubular members, 3810 and 3832, may be avoided. In addition, during the relative rotation of the second tubular member with respect to the first tubular member, required during the threaded coupling of the first and second tubular members, the tubular sleeve 3816 provides an indication of to what degree the first and second tubular members are threadably coupled. For example, if the tubular sleeve 3818 can be easily rotated, that would indicate that the first and second tubular members, 3810 and 3832, are not fully threadably coupled and in intimate contact with the internal flange 3820 of the tubular sleeve. Furthermore, the tubular sleeve 3818 may prevent crack propagation during the radial expansion and plastic deformation of the first and second tubular members, 3810 and 3832. In this manner, failure modes such as, for example, longitudinal cracks in the end portions, 3816 and 3830, of the first and second tubular members may be limited in severity or eliminated all together. In addition, after completing the radial expansion and plastic deformation of the first and second tubular members, 3810 and 3832, the tubular sleeve 3818 may provide a fluid and gas tight metal-to-metal seal between interior surface of the tubular sleeve 3818 and the exterior surfaces of the end portions, 3816 and 3830, of the first and second tubular members. In this manner, fluidic materials are prevented from passing through the threaded connections, 3812 and 3830, of the first and second tubular members, 3810 and 3832, into the annulus between the first and second tubular members and the structure. Furthermore, because, following the radial expansion and plastic deformation of the first and second tubular members, 3810 and 3832, the tubular sleeve 3818 may be maintained in circumferential tension and the end portions, 3816 and 3830, of the first and second tubular members, 3810 and 3832, may be maintained in circumferential compression, axial loads and/or torque loads may be transmitted through the tubular sleeve.

In several exemplary embodiments, the first and second tubular members are radially expanded and plastically deformed using the expansion device in a conventional manner and/or using one or more of the methods and apparatus disclosed in one or more of the following: This application is related to the following co-pending applications: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.61.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.110.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no: 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942, attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999, (122) PCT patent application serial no. PCT/US2004/06246, attorney docket no. 25791.238.02, filed on Feb. 26, 2004, (123) PCT patent application serial number PCT/US2004/08170, attorney docket number 25791.40.02, filed on Mar. 15, 2004, (124) PCT patent application serial number PCT/US2004/08171, attorney docket number 25791.236.02, filed on Mar. 15, 2004, (125) PCT patent application serial number PCT/US2004/08073, attorney docket number 25791.262.02, filed on Mar. 18, 2004, (126) PCT patent application serial number PCT/US2004/07711, attorney docket number 25791.253.02, filed on Mar. 11, 2004, (127) PCT patent application serial number PCT/US2004/029025, attorney docket number 25791.260.02, filed on Mar. 26, 2004, (128) PCT patent application serial number PCT/US2004/010317, attorney docket number 25791.270.02, filed on Apr. 2, 2004, (129) PCT patent application serial number PCT/US2004/010712, attorney docket number 25791.272.02, filed on Apr. 6, 2004, (130) PCT patent application serial number PCT/US2004/010762, attorney docket number 25791.273.02, filed on Apr. 6, 2004, (131) PCT patent application serial number PCT/US2004/011973, attorney docket number 25791.277.02, filed on Apr. 15, 2004, (132) U.S. provisional patent application Ser. No. 60/495,056, attorney docket number 25791.301, filed on Aug. 14, 2003, (133) U.S. provisional patent application Ser. No. 60/600,679, attorney docket number 25791.194, filed on Aug. 11, 2004, (134) PCT patent application serial number PCT US2005/027318, attorney docket number 25791.329.02, filed on Jul. 29, 2005, the disclosures of which are incorporated herein by reference. (135) PCT patent application serial number PCT/US2005/028936, attorney docket number 25791.338.02, filed on Aug. 12, 2005, (136) PCT patent application serial number PCT/US2005/028669, attorney docket number 25791.194.02, filed on Aug. 11, 2005, (137) PCT patent application serial number PCT/US2005/028453, attorney docket number 25791.371, filed on Aug. 11, 2005, (138) PCT patent application serial number PCT/US2005/028641, attorney docket number 25791.372, filed on Aug. 11, 2005, (139) PCT patent application serial number PCT/US2005/028819, attorney docket number 25791.373, filed on Aug. 11, 2005, (140) PCT patent application serial number PCT/US2005/028446, attorney docket number 25791.374, filed on Aug. 11, 2005, (141) PCT patent application serial number PCT/US2005/028642, attorney docket number 25791.375, filed on Aug. 11, 2005, (142) PCT patent application serial number PCT/US2005/028451, attorney docket number 25791.376, filed on Aug. 11, 2005, and (143). PCT patent application serial number PCT/US2005/028473, attorney docket number 25791.377, filed on Jul. 29, 2005, (144) U.S. National Stage application Ser. No. 10/546,084, attorney docket no. 25791.185.05, filed on Aug. 17, 2005; (145) U.S. National Stage application Ser. No. 10/546,082, attorney docket no. 25791.378, filed on Aug. 17, 2005; (146) U.S. National Stage application Ser. No. 10/546,076, attorney docket no. 25791.379, filed on Aug. 17, 2005; (147) U.S. National Stage application Ser. No. 10/546,936, attorney docket no. 25791.380, filed on Aug. 17, 2005; (148) U.S. National Stage application Ser. No. 10/546,079, attorney docket no. 25791.381, filed on Aug. 17, 2005; (149) U.S. National Stage application Ser. No. 10/545,941, attorney docket no. 25791.382, filed on Aug. 17, 2005; (150) U.S. National Stage application Ser. No. 10/546,078, attorney docket no. 25791.383, filed on Aug. 17, 2005 the disclosures of which are incorporated herein by reference.

In several exemplary embodiments, the teachings of the present disclosure are combined with one or more of the teachings disclosed in FR 2 841 626, filed on Jun. 28, 2002, and published on Jan. 2, 2004, the disclosure of which is incorporated herein by reference.

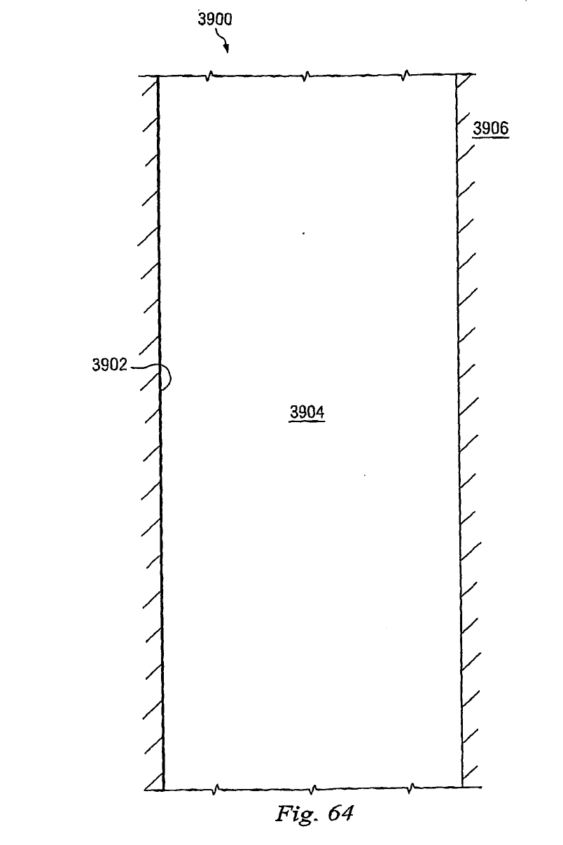

Referring now to FIG. 64, in one embodiment, a preexisting structure 3900 is illustrated. The preexisting structure 3900 includes an inner wall 3902 which defines a passageway 3904. In an exemplary embodiment, a volume of earth 3906 includes the inner wall 3902 and defines the passageway 3904 such as, for example, when the preexisting structure 3900 is a wellbore. However, the preexisting structure 3900 may also include, for example, a wellbore casing, an expandable tubular member, a pipeline, a structural support, combinations thereof, and/or a variety of other preexisting structures known in the art.

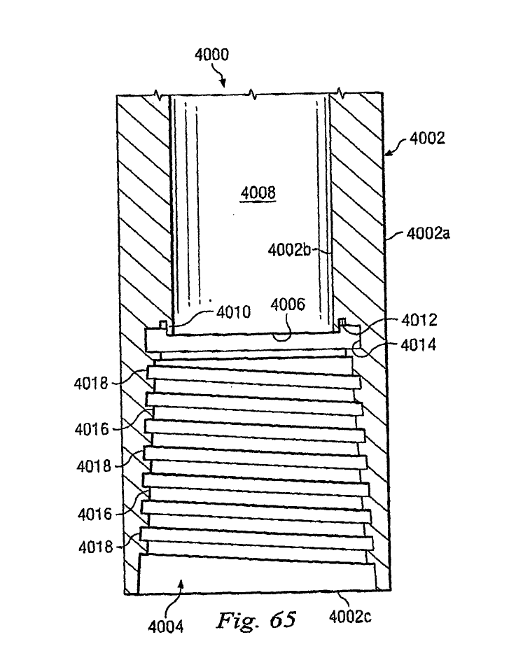

Referring now to FIG. 65, a first tubular member 4000 is illustrated. The first tubular member 4000 includes a tubular base 4002 having an outer surface 4002a, an inner surface 4002b located opposite the outer surface 4002a, and a distal end 4002c. A second tubular member coupling passageway 4004 is defined by the inner surface 4002b between the distal end 4002c of the tubular base 4002 and a coupling passageway end 4006, the second tubular member coupling passageway 4004 decreasing in inner diameter from the distal end 4002c to the coupling passageway end 4006. The inner surface 4002b also defines a first tubular member passageway 4008 immediately adjacent the coupling passageway end 4006. An annular distal end securing member 4010 extends from the tubular base 4002, is located adjacent the coupling passageway end 4006, and includes a portion of the inner surface 4002b which defines the first tubular member passageway 4008. An annular distal end securing channel 4012 is defined by the tubular base 4002 and is located between the distal end securing member 4010 and the outer surface 4002a of the tubular base 4002. An annular sealing member channel 4014 is defined by the tubular base 4002 and is located adjacent the distal end securing channel 4012 on the opposite side of the distal end securing channel 4012 as the distal end securing member 4010. A plurality of first tubular member threads 4016 extend from the inner surface 4002b of the tubular base 4002 which defines the second tubular member coupling passageway 4004. The plurality of first tubular member threads 4016 define a plurality of first tubular member thread channels 4018 located between the plurality of first tubular member threads 4016. In an exemplary embodiment, the inner surface 4002b may be coated with a lubricating material known in the art. In an exemplary embodiment, the first tubular member 4000 is a box-thread tubular member for use in a pin and box tubular member connection.

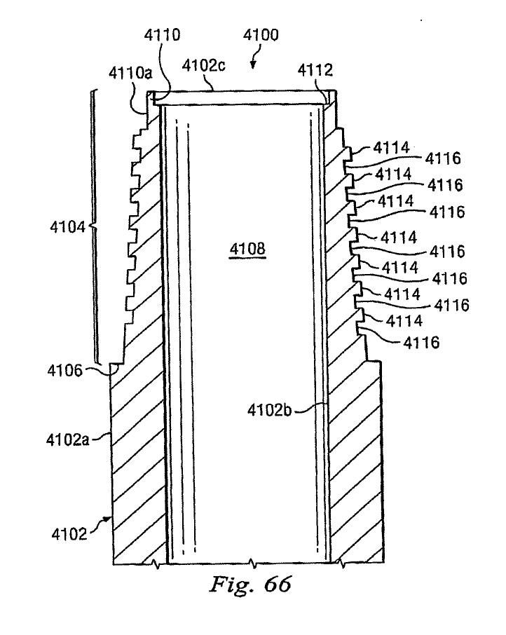

Referring now to FIG. 66, a second tubular member 4100 is illustrated. The second tubular member 4100 includes a tubular base 4102 having an outer surface 4102a, an inner surface 4102b located opposite the outer surface 4102a, and a distal end 4102c. A first tubular member coupling portion 4104 is located on the tubular base 4102 between the distal end 4102c of the tubular base 4102 and a coupling portion end 4106, the first tubular member coupling portion 4104 increasing in outside diameter from the distal end 4102c to the coupling portion end 4106. The inner surface 4102b defines a second tubular member passageway 4108 along the length of the tubular base 4102. An annular distal end securing member 4110 extends from the distal end 4102c of the tubular base 4102 and includes a sealing member engagement surface 4110a adjacent the outer surface 4102a on the first tubular member coupling portion 4104 of the tubular base 4102. An annular distal end securing channel 4112 is defined by the tubular base 4102 and is located between the distal end securing member 4110 and the second tubular member passageway 4108. A plurality of second tubular member threads 4114 extend from the outer surface 4102a of the tubular base 4102 on the first tubular member coupling portion 4104 of the tubular base 4102. The plurality of second tubular member threads 4114 define a plurality of second tubular member thread channels 4116 located between the plurality of second tubular member threads 4114. In an exemplary embodiment, the inner surface 4102b may be coated with a lubricating material known in the art. In an exemplary embodiment, the second tubular member 4100 is a pin-thread tubular member for use in a pin and box tubular member connection.

Referring now to FIGS. 65, 66, 67a, and 67b, a method 4200 for coupling expandable tubular members is illustrated. The method 4200 begins at step 4202 where the first tubular member 4000, described above with reference to FIG. 65, and the second tubular member 4100, described above with reference to FIG. 66, are provided. The method 4200 then proceeds to step 4204 where the first tubular member 4000 is coupled to the second tubular member 4100. In an exemplary embodiment, a primary sealing member 4204a is positioned in the sealing member channel 4014. A secondary sealing member 4204b is positioned in the sealing member channel 4014 adjacent the primary sealing member 4204a. In an exemplary embodiment, the primary sealing member 4204a is an O-ring. The second tubular member 4100 is then positioned adjacent the first tubular member 4000 such that the distal end 4102c on the second tubular member 4100 is adjacent the distal end 4002c on the first tubular member 4000. The first tubular member coupling portion 4104 on the second tubular member 4100 is then positioned in the second tubular member coupling passageway 4004 such that the plurality of threads 4114 on the second tubular member 4100 engage the plurality of threads 4016 on the first tubular member 4000. With the plurality of threads 4114 engaging the plurality of threads 4016, the threads 4114 enter the thread channels 4018 on the first tubular member 4000 and the threads 4016 enter the thread channels 4116 on the second tubular member 4100. The second tubular member 4100 is then rotated relative to the first tubular member 4000, which couples the first tubular member 4000 to the second tubular member 4100 and moves the distal end 4102c of the second tubular member 4100 towards the coupling passageway end 4006 on the first tubular member 4000. The first tubular member 4000 and the second tubular member 4100 are coupled to each other when the distal end 4102c of the second tubular member 4100 is positioned immediately adjacent the coupling passageway end 4006. With the first tubular member 4000 coupled to the second tubular member 4100, the distal end securing member 4010 on the first tubular member 4000 is positioned in the distal end securing channel 4112 on the second tubular member 4100, the distal end securing member 4110 on the second tubular member 4100 is positioned in the distal end securing channel 4012 on the first tubular member 4000, the distal end securing member 4010 on the first tubular member 4000 engages the distal end securing member 4110 on the second tubular member 4100, and the sealing member engagement surface 4110a engages the primary sealing member 4204a and the secondary sealing member 4204b. With the first tubular member 4000 coupled to the second tubular member 4100, an expandable tubular member 4204c is provided. In an exemplary embodiment, methods known in the art may be used to provide a cold weld between the distal end securing member 4110 on the second tubular member 4100 and the distal end securing channel 4012 on the first tubular member 4000. In an exemplary embodiment, the distal end securing member 4110 on the second tubular member 4100 is fabricated from a material having a different hardness than the distal end securing channel 4012 on the first tubular member 4000, allowing the deformation of the distal end securing member 4110 in the distal end securing channel 4012 to couple the first tubular member 4000 to the second tubular member 4100.

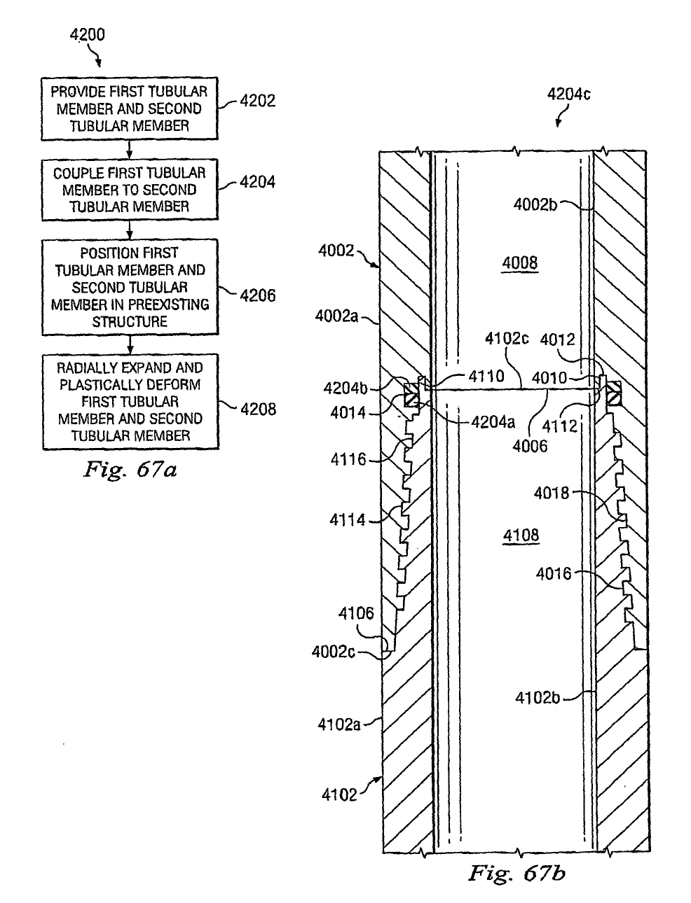

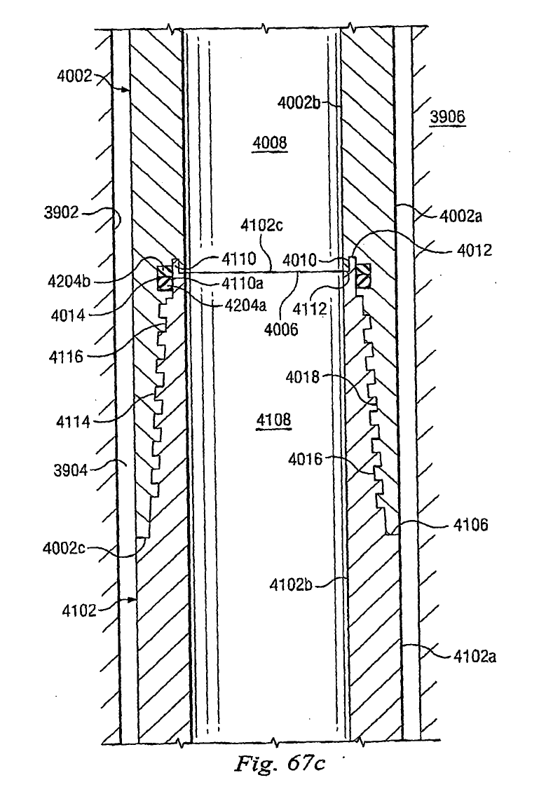

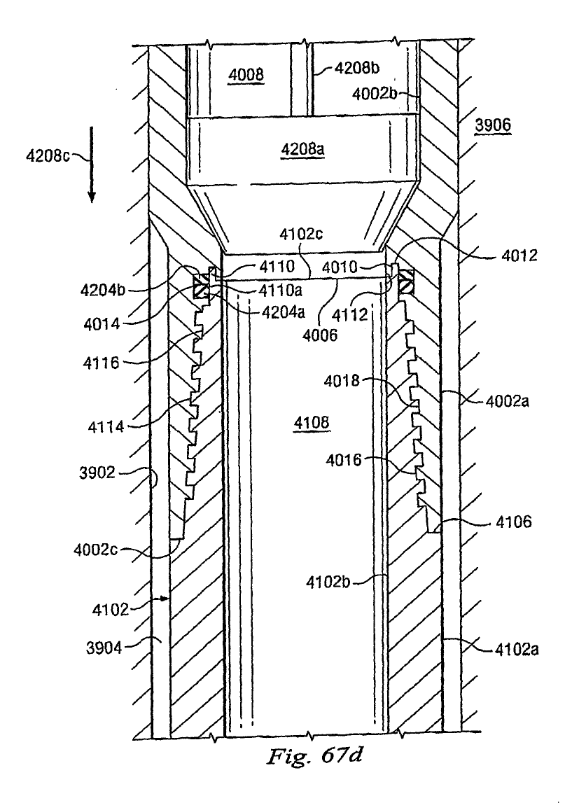

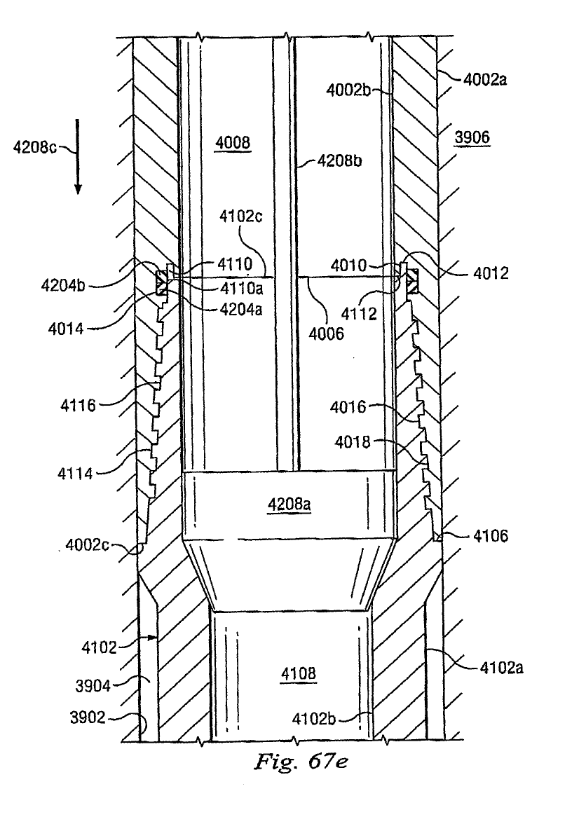

Referring now to FIGS. 67a and 67c, the method 4200 proceeds to step 4206 where the expandable tubular member 4204c is positioned in the preexisting structure 3900, described above with reference to FIG. 64. The expandable tubular member 4204c is positioned in the passageway 3904 defined by the preexisting structure 3900 such that the outer surfaces 4002a and 4002a on the first tubular member 4000 and the second tubular member 4100, respectively, are adjacent the inner surface 3902 on the preexisting structure 3900.

Referring now to FIGS. 64, 65, 66, 67a, 67b, 67c, 67d, and 67e, the method 4200 proceeds to step 4208 where the expandable tubular member 4204c, including the first tubular member 4000 and the second tubular member 4100, is radially expanded and plastically deformed. An expansion device 4208a is provided which is coupled to a drill string 4208b. In an exemplary embodiment, the expansion device 4208a may be a cone expansion device, a rotary expansion device, a hydroforming expansion device, a variety of conventional expansion devices known in the art, and/or one or more of the expansion devices described in: (1) U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (2) U.S. patent application Ser. No. 09/510,913, attorney docket no. 25791.7.02, filed on Feb. 23, 2000, which claims priority from provisional application 60/121,702, filed on Feb. 25, 1999, (3) U.S. patent application Ser. No. 09/502,350, attorney docket no. 25791.8.02, filed on Feb. 10, 2000, which claims priority from provisional application 60/119,611, filed on Feb. 11, 1999, (4) U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (5) U.S. patent application Ser. No. 10/169,434, attorney docket no. 25791.10.04, filed on Jul. 1, 2002, which claims priority from provisional application 60/183,546, filed on Feb. 18, 2000, (6) U.S. patent application Ser. No. 09/523,468, attorney docket no. 25791.11.02, filed on Mar. 10, 2000, which claims priority from provisional application 60/124,042, filed on Mar. 11, 1999, (7) U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (8) U.S. Pat. No. 6,575,240, which was filed as patent application Ser. No. 09/511,941, attorney docket no. 25791.16.02, filed on Feb. 24, 2000, which claims priority from provisional application 60/121,907, filed on Feb. 26, 1999, (9) U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (10) U.S. patent application Ser. No. 09/981,916, attorney docket no. 25791.18, filed on Oct. 18, 2001 as a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (11) U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (12) U.S. patent application Ser. No. 10/030,593, attorney docket no. 25791.25.08, filed on Jan. 8, 2002, which claims priority from provisional application 60/146,203, filed on Jul. 29, 1999, (13) U.S. provisional patent application Ser. No. 60/143,039, attorney docket no. 25791.26, filed on Jul. 9, 1999, (14) U.S. patent application Ser. No. 10/111,982, attorney docket no. 25791.27.08, filed on Apr. 30, 2002, which claims priority from provisional patent application Ser. No. 60/162,671, attorney docket no. 25791.27, filed on Nov. 1, 1999, (15) U.S. provisional patent application Ser. No. 60/154,047, attorney docket no. 25791.29, filed on Sep. 16, 1999, (16) U.S. provisional patent application Ser. No. 60/438,828, attorney docket no. 25791.31, filed on Jan. 9, 2003, (17) U.S. Pat. No. 6,564,875, which was filed as application Ser. No. 09/679,907, attorney docket no. 25791.34.02, on Oct. 5, 2000, which claims priority from provisional patent application Ser. No. 60/159,082, attorney docket no. 25791.34, filed on Oct. 12, 1999, (18) U.S. patent application Ser. No. 10/089,419, filed on Mar. 27, 2002, attorney docket no. 25791.36.03, which claims priority from provisional patent application Ser. No. 60/159,039, attorney docket no. 25791.36, filed on Oct. 12, 1999, (19) U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (20) U.S. patent application Ser. No. 10/303,992, filed on Nov. 22, 2002, attorney docket no. 25791.38.07, which claims priority from provisional patent application Ser. No. 60/212,359, attorney docket no. 25791.38, filed on Jun. 19, 2000, (21) U.S. provisional patent application Ser. No. 60/165,228, attorney docket no. 25791.39, filed on Nov. 12, 1999, (22) U.S. provisional patent application Ser. No. 60/455,051, attorney docket no. 25791.40, filed on Mar. 14, 2003, (23) PCT application US02/2477, filed on Jun. 26, 2002, attorney docket no. 25791.44.02, which claims priority from U.S. provisional patent application Ser. No. 60/303,711, attorney docket no. 25791.44, filed on Jul. 6, 2001, (24) U.S. patent application Ser. No. 10/311,412, filed on Dec. 12, 2002, attorney docket no. 25791.45.07, which claims priority from provisional patent application Ser. No. 60/221,443, attorney docket no. 25791.45, filed on Jul. 28, 2000, (25) U.S. patent application Ser. No. 10/, filed on Dec. 18, 2002, attorney docket no. 25791.46.07, which claims priority from provisional patent application Ser. No. 60/221,645, attorney docket no. 25791.46, filed on Jul. 28, 2000, (26) U.S. patent application Ser. No. 10/322,947, filed on Jan. 22, 2003, attorney docket no. 25791.47.03, which claims priority from provisional patent application Ser. No. 60/233,638, attorney docket no. 25791.47, filed on Sep. 18, 2000, (27) U.S. patent application Ser. No. 10/406,648, filed on Mar. 31, 2003, attorney docket no. 25791.48.06, which claims priority from provisional patent application Ser. No. 60/237,334, attorney docket no. 25791.48, filed on Oct. 2, 2000, (28) PCT application US02/04353, filed on Feb. 14, 2002, attorney docket no. 25791.50.02, which claims priority from U.S. provisional patent application Ser. No. 60/270,007, attorney docket no. 25791.50, filed on Feb. 20, 2001, (29) U.S. patent application Ser. No. 10/465,835, filed on Jun. 13, 2003, attorney docket no. 25791.51.06, which claims priority from provisional patent application Ser. No. 60/262,434, attorney docket no. 25791.51, filed on Jan. 17, 2001, (30) U.S. patent application Ser. No. 10/465,831, filed on Jun. 13, 2003, attorney docket no. 25791.52.06, which claims priority from U.S. provisional patent application Ser. No. 60/259,486, attorney docket no. 25791.52, filed on Jan. 3, 2001, (31) U.S. provisional patent application Ser. No. 60/452,303, filed on Mar. 5, 2003, attorney docket no. 25791.53, (32) U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (33) U.S. Pat. No. 6,561,227, which was filed as patent application Ser. No. 09/852,026, filed on May 9, 2001, attorney docket no. 25791.56, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (34) U.S. patent application Ser. No. 09/852,027, filed on May 9, 2001, attorney docket no. 25791.57, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (35) PCT Application US02/25608, attorney docket no. 25791.58.02, filed on Aug. 13, 2002, which claims priority from provisional application 60/318,021, filed on Sep. 7, 2001, attorney docket no. 25791.58, (36) PCT Application US02/24399, attorney docket no. 25791.59.02, filed on Aug. 1, 2002, which claims priority from U.S. provisional patent application Ser. No. 60/313,453, attorney docket no. 25791.59, filed on Aug. 20, 2001, (37) PCT Application US02/29856, attorney docket no. 25791.60.02, filed on Sep. 19, 2002, which claims priority from U.S. provisional patent application Ser. No. 60/326,886, attorney docket no. 25791.60, filed on Oct. 3, 2001, (38) PCT Application US02/20256, attorney docket no. 25791.610.02, filed on Jun. 26, 2002, which claims priority from U.S. provisional patent application Ser. No. 60/303,740, attorney docket no. 25791.61, filed on Jul. 6, 2001, (39) U.S. patent application Ser. No. 09/962,469, filed on Sep. 25, 2001, attorney docket no. 25791.62, which is a divisional of U.S. patent application Ser. No. 09/523,468, attorney docket no. 25791.11.02, filed on Mar. 10, 2000, which claims priority from provisional application 60/124,042, filed on Mar. 11, 1999, (40) U.S. patent application Ser. No. 09/962,470, filed on Sep. 25, 2001, attorney docket no. 25791.63, which is a divisional of U.S. patent application Ser. No. 09/523,468, attorney docket no. 25791.11.02, filed on Mar. 10, 2000, which claims priority from provisional application 60/124,042, filed on Mar. 11, 1999, (41) U.S. patent application Ser. No. 09/962,471, filed on Sep. 25, 2001, attorney docket no. 25791.64, which is a divisional of U.S. patent application Ser. No. 09/523,468, attorney docket no. 25791.11.02, filed on Mar. 10, 2000, which claims priority from provisional application 60/124,042, filed on Mar. 11, 1999, (42) U.S. patent application Ser. No. 09/962,467, filed on Sep. 25, 2001, attorney docket no. 25791.65, which is a divisional of U.S. patent application Ser. No. 09/523,468, attorney docket no. 25791.11.02, filed on Mar. 10, 2000, which claims priority from provisional application 60/124,042, filed on Mar. 11, 1999, (43) U.S. patent application Ser. No. 09/962,468, filed on Sep. 25, 2001, attorney docket no. 25791.66, which is a divisional of U.S. patent application Ser. No. 09/523,468, attorney docket no. 25791.11.02, filed on Mar. 10, 2000, which claims priority from provisional application 60/124,042, filed on Mar. 11, 1999, (44) PCT application US 02/25727, filed on Aug. 14, 2002, attorney docket no. 25791.67.03, which claims priority from U.S. provisional patent application Ser. No. 60/317,985, attorney docket no. 25791.67, filed on Sep. 6, 2001, and U.S. provisional patent application Ser. No. 60/318,386, attorney docket no. 25791.67.02, filed on Sep. 10, 2001, (45) PCT application US 02/39425, filed on Dec. 10, 2002, attorney docket no. 25791.68.02, which claims priority from U.S. provisional patent application Ser. No. 60/343,674, attorney docket no. 25791.68, filed on Dec. 27, 2001, (46) U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (47) U.S. utility patent application Ser. No. 10/516,467, attorney docket no. 25791.70, filed on Dec. 10, 2001, which is a continuation application of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (48) PCT application US 03/00609, filed on Jan. 9, 2003, attorney docket no. 25791.71.02, which claims priority from U.S. provisional patent application Ser. No. 60/357,372, attorney docket no. 25791.71, filed on Feb. 15, 2002, (49) U.S. patent application Ser. No. 10/074,703, attorney docket no. 25791.74, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (50) U.S. patent application Ser. No. 10/074,244, attorney docket no. 25791.75, filed on Feb. 12, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (51) U.S. patent application Ser. No. 10/076,660, attorney docket no. 25791.76, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (52) U.S. patent application Ser. No. 10/076,661, attorney docket no. 25791.77, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (53) U.S. patent application Ser. No. 10/076,659, attorney docket no. 25791.78, filed on Feb. 15, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (54) U.S. patent application Ser. No. 10/078,928, attorney docket no. 25791.79, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (55) U.S. patent application Ser. No. 10/078,922, attorney docket no. 25791.80, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (56) U.S. patent application Ser. No. 10/078,921, attorney docket no. 25791.81, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (57) U.S. patent application Ser. No. 10/261,928, attorney docket no. 25791.82, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (58) U.S. patent application Ser. No. 10/079,276, attorney docket no. 25791.83, filed on Feb. 20, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (59) U.S. patent application Ser. No. 10/262,009, attorney docket no. 25791.84, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (60) U.S. patent application Ser. No. 10/092,481, attorney docket no. 25791.85, filed on Mar. 7, 2002, which is a divisional of U.S. Pat. No. 6,568,471, which was filed as patent application Ser. No. 09/512,895, attorney docket no. 25791.12.02, filed on Feb. 24, 2000, which claims priority from provisional application 60/121,841, filed on Feb. 26, 1999, (61) U.S. patent application Ser. No. 10/261,926, attorney docket no. 25791.86, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (62) PCT application US 02/36157, filed on Nov. 12, 2002, attorney docket no. 25791.87.02, which claims priority from U.S. provisional patent application Ser. No. 60/338,996, attorney docket no. 25791.87, filed on Nov. 12, 2001, (63) PCT application US 02/36267, filed on Nov. 12, 2002, attorney docket no. 25791.88.02, which claims priority from U.S. provisional patent application Ser. No. 60/339,013, attorney docket no. 25791.88, filed on Nov. 12, 2001, (64) PCT application US 03/11765, filed on Apr. 16, 2003, attorney docket no. 25791.89.02, which claims priority from U.S. provisional patent application Ser. No. 60/383,917, attorney docket no. 25791.89, filed on May 29, 2002, (65) PCT application US 03/15020, filed on May 12, 2003, attorney docket no. 25791.90.02, which claims priority from U.S. provisional patent application Ser. No. 60/391,703, attorney docket no. 25791.90, filed on Jun. 26, 2002, (66) PCT application US 02/39418, filed on Dec. 10, 2002, attorney docket no. 25791.92.02, which claims priority from U.S. provisional patent application Ser. No. 60/346,309, attorney docket no. 25791.92, filed on Jan. 7, 2002, (67) PCT application US 03/06544, filed on Mar. 4, 2003, attorney docket no. 25791.93.02, which claims priority from U.S. provisional patent application Ser. No. 60/372,048, attorney docket no. 25791.93, filed on Apr. 12, 2002, (68) U.S. patent application Ser. No. 10/331,718, attorney docket no. 25791.94, filed on Dec. 30, 2002, which is a divisional U.S. patent application Ser. No. 09/679,906, filed on Oct. 5, 2000, attorney docket no. 25791.37.02, which claims priority from provisional patent application Ser. No. 60/159,033, attorney docket no. 25791.37, filed on Oct. 12, 1999, (69) PCT application US 03/04837, filed on Feb. 29, 2003, attorney docket no. 25791.95.02, which claims priority from U.S. provisional patent application Ser. No. 60/363,829, attorney docket no. 25791.95, filed on Mar. 13, 2002, (70) U.S. patent application Ser. No. 10/261,927, attorney docket no. 25791.97, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (71) U.S. patent application Ser. No. 10/262,008, attorney docket no. 25791.98, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (72) U.S. patent application Ser. No. 10/261,925, attorney docket no. 25791.99, filed on Oct. 1, 2002, which is a divisional of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (73) U.S. patent application Ser. No. 10/199,524, attorney docket no. 25791.100, filed on Jul. 19, 2002, which is a continuation of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (74) PCT application US 03/10144, filed on Mar. 28, 2003, attorney docket no. 25791.101.02, which claims priority from U.S. provisional patent application Ser. No. 60/372,632, attorney docket no. 25791.101, filed on Apr. 15, 2002, (75) U.S. provisional patent application Ser. No. 60/412,542, attorney docket no. 25791.102, filed on Sep. 20, 2002, (76) PCT application US 03/14153, filed on May 6, 2003, attorney docket no. 25791.104.02, which claims priority from U.S. provisional patent application Ser. No. 60/380,147, attorney docket no. 25791.104, filed on May 6, 2002, (77) PCT application US 03/19993, filed on Jun. 24, 2003, attorney docket no. 25791.106.02, which claims priority from U.S. provisional patent application Ser. No. 60/397,284, attorney docket no. 25791.106, filed on Jul. 19, 2002, (78) PCT application US 03/13787, filed on May 5, 2003, attorney docket no. 25791.107.02, which claims priority from U.S. provisional patent application Ser. No. 60/387,486, attorney docket no. 25791.107, filed on Jun. 10, 2002, (79) PCT application US 03/18530, filed on Jun. 11, 2003, attorney docket no. 25791.108.02, which claims priority from U.S. provisional patent application Ser. No. 60/387,961, attorney docket no. 25791.108, filed on Jun. 12, 2002, (80) PCT application US 03/20694, filed on Jul. 1, 2003, attorney docket no. 25791.1.10.02, which claims priority from U.S. provisional patent application Ser. No. 60/398,061, attorney docket no. 25791.110, filed on Jul. 24, 2002, (81) PCT application US 03/20870, filed on Jul. 2, 2003, attorney docket no. 25791.111.02, which claims priority from U.S. provisional patent application Ser. No. 60/399,240, attorney docket no. 25791.111, filed on Jul. 29, 2002, (82) U.S. provisional patent application Ser. No. 60/412,487, attorney docket no. 25791.112, filed on Sep. 20, 2002, (83) U.S. provisional patent application Ser. No. 60/412,488, attorney docket no. 25791.114, filed on Sep. 20, 2002, (84) U.S. patent application Ser. No. 10/280,356, attorney docket no. 25791.115, filed on Oct. 25, 2002, which is a continuation of U.S. Pat. No. 6,470,966, which was filed as patent application Ser. No. 09/850,093, filed on May 7, 2001, attorney docket no. 25791.55, as a divisional application of U.S. Pat. No. 6,497,289, which was filed as U.S. patent application Ser. No. 09/454,139, attorney docket no. 25791.03.02, filed on Dec. 3, 1999, which claims priority from provisional application 60/111,293, filed on Dec. 7, 1998, (85) U.S. provisional patent application Ser. No. 60/412,177, attorney docket no. 25791.117, filed on Sep. 20, 2002, (86) U.S. provisional patent application Ser. No. 60/412,653, attorney docket no. 25791.118, filed on Sep. 20, 2002, (87) U.S. provisional patent application Ser. No. 60/405,610, attorney docket no. 25791.119, filed on Aug. 23, 2002, (88) U.S. provisional patent application Ser. No. 60/405,394, attorney docket no. 25791.120, filed on Aug. 23, 2002, (89) U.S. provisional patent application Ser. No. 60/412,544, attorney docket no. 25791.121, filed on Sep. 20, 2002, (90) PCT application US 03/24779, filed on Aug. 8, 2003, attorney docket no. 25791.125.02, which claims priority from U.S. provisional patent application Ser. No. 60/407,442, attorney docket no. 25791.125, filed on Aug. 30, 2002, (91) U.S. provisional patent application Ser. No. 60/423,363, attorney docket no. 25791.126, filed on Dec. 10, 2002, (92) U.S. provisional patent application Ser. No. 60/412,196, attorney docket no. 25791.127, filed on Sep. 20, 2002, (93) U.S. provisional patent application Ser. No. 60/412,187, attorney docket no. 25791.128, filed on Sep. 20, 2002, (94) U.S. provisional patent application Ser. No. 60/412,371, attorney docket no. 25791.129, filed on Sep. 20, 2002, (95) U.S. patent application Ser. No. 10/382,325, attorney docket no. 25791.145, filed on Mar. 5, 2003, which is a continuation of U.S. Pat. No. 6,557,640, which was filed as patent application Ser. No. 09/588,946, attorney docket no. 25791.17.02, filed on Jun. 7, 2000, which claims priority from provisional application 60/137,998, filed on Jun. 7, 1999, (96) U.S. patent application Ser. No. 10/624,842, attorney docket no. 25791.151, filed on Jul. 22, 2003, which is a divisional of U.S. patent application Ser. No. 09/502,350, attorney docket no. 25791.8.02, filed on Feb. 10, 2000, which claims priority from provisional application 60/119,611, filed on Feb. 11, 1999, (97) U.S. provisional patent application Ser. No. 60/431,184, attorney docket no. 25791.157, filed on Dec. 5, 2002, (98) U.S. provisional patent application Ser. No. 60/448,526, attorney docket no. 25791.185, filed on Feb. 18, 2003, (99) U.S. provisional patent application Ser. No. 60/461,539, attorney docket no. 25791.186, filed on Apr. 9, 2003, (100) U.S. provisional patent application Ser. No. 60/462,750, attorney docket no. 25791.193, filed on Apr. 14, 2003, (101) U.S. provisional patent application Ser. No. 60/436,106, attorney docket no. 25791.200, filed on Dec. 23, 2002, (102) U.S. provisional patent application Ser. No. 60/442,942; attorney docket no. 25791.213, filed on Jan. 27, 2003, (103) U.S. provisional patent application Ser. No. 60/442,938, attorney docket no. 25791.225, filed on Jan. 27, 2003, (104) U.S. provisional patent application Ser. No. 60/418,687, attorney docket no. 25791.228, filed on Apr. 18, 2003, (105) U.S. provisional patent application Ser. No. 60/454,896, attorney docket no. 25791.236, filed on Mar. 14, 2003, (106) U.S. provisional patent application Ser. No. 60/450,504, attorney docket no. 25791.238, filed on Feb. 26, 2003, (107) U.S. provisional patent application Ser. No. 60/451,152, attorney docket no. 25791.239, filed on Mar. 9, 2003, (108) U.S. provisional patent application Ser. No. 60/455,124, attorney docket no. 25791.241, filed on Mar. 17, 2003, (109) U.S. provisional patent application Ser. No. 60/453,678, attorney docket no. 25791.253, filed on Mar. 11, 2003, (110) U.S. patent application Ser. No. 10/421,682, attorney docket no. 25791.256, filed on Apr. 23, 2003, which is a continuation of U.S. patent application Ser. No. 09/523,468, attorney docket no. 25791.11.02, filed on Mar. 10, 2000, which claims priority from provisional application 60/124,042, filed on Mar. 11, 1999, (111) U.S. provisional patent application Ser. No. 60/457,965, attorney docket no. 25791.260, filed on Mar. 27, 2003, (112) U.S. provisional patent application Ser. No. 60/455,718, attorney docket no. 25791.262, filed on Mar. 18, 2003, (113) U.S. Pat. No. 6,550,821, which was filed as patent application Ser. No. 09/811,734, filed on Mar. 19, 2001, (114) U.S. patent application Ser. No. 10/436,467, attorney docket no. 25791.268, filed on May 12, 2003, which is a continuation of U.S. Pat. No. 6,604,763, which was filed as application Ser. No. 09/559,122, attorney docket no. 25791.23.02, filed on Apr. 26, 2000, which claims priority from provisional application 60/131,106, filed on Apr. 26, 1999, (115) U.S. provisional patent application Ser. No. 60/459,776, attorney docket no. 25791.270, filed on Apr. 2, 2003, (116) U.S. provisional patent application Ser. No. 60/461,094, attorney docket no. 25791.272, filed on Apr. 8, 2003, (117) U.S. provisional patent application Ser. No. 60/461,038, attorney docket no. 25791.273, filed on Apr. 7, 2003, (118) U.S. provisional patent application Ser. No. 60/463,586, attorney docket no. 25791.277, filed on Apr. 17, 2003, (119) U.S. provisional patent application Ser. No. 60/472,240, attorney docket no. 25791.286, filed on May 20, 2003, (120) U.S. patent application Ser. No. 10/619,285, attorney docket no. 25791.292, filed on Jul. 14, 2003, which is a continuation-in-part of U.S. utility patent application Ser. No. 09/969,922, attorney docket no. 25791.69, filed on Oct. 3, 2001, which is a continuation-in-part application of U.S. Pat. No. 6,328,113, which was filed as U.S. patent application Ser. No. 09/440,338, attorney docket number 25791.9.02, filed on Nov. 15, 1999, which claims priority from provisional application 60/108,558, filed on Nov. 16, 1998, (121) U.S. utility patent application Ser. No. 10/418,688, attorney docket no. 25791.257, which was filed on Apr. 18, 2003, as a division of U.S. utility patent application Ser. No. 09/523,468, attorney docket no. 25791.11.02, filed on Mar. 10, 2000, which claims priority from provisional application 60/124,042, filed on Mar. 11, 1999, (122) PCT patent application serial no. PCT/US2004/06246, attorney docket no. 25791.238.02, filed on Feb. 26, 2004, (123) PCT patent application serial number PCT/US2004/08170, attorney docket number 25791.40.02, filed on Mar. 15, 2004, (124) PCT patent application serial number PCT/US2004/08171, attorney docket number 25791.236.02, filed on Mar. 15, 2004, (125) PCT patent application serial number PCT/US2004/08073, attorney docket number 25791.262.02, filed on Mar. 18, 2004, (126) PCT patent application serial number PCT/US2004/07711, attorney docket number 25791.253.02, filed on Mar. 11, 2004, (127) PCT patent application serial number PCT/US2004/029025, attorney docket number 25791.260.02, filed on Mar. 26, 2004, (128) PCT patent application serial number PCT/US2004/010317, attorney docket number 25791.270.02, filed on Apr. 2, 2004, (129) PCT patent application serial number PCT/US2004/010712, attorney docket number 25791.272.02, filed on Apr. 6, 2004, (130) PCT patent application serial number PCT/US2004/010762, attorney docket number 25791.273.02, filed on Apr. 6, 2004, (131) PCT patent application serial number PCT/US2004/011973, attorney docket number 25791.277.02, filed on Apr. 15, 2004, (132) U.S. provisional patent application Ser. No. 60/495,056, attorney docket number 25791.301, filed on Aug. 14, 2003, (133) U.S. provisional patent application Ser. No. 60/600,679, attorney docket number 25791.194, filed on Aug. 11, 2004, (134) PCT patent application serial number PCT/US2005/027318, attorney docket number 25791.329.02, filed on Jul. 29, 2005, the disclosures of which are incorporated herein by reference. (135) PCT patent application serial number PCT/US2005/028936, attorney docket number 25791.338.02, filed on Aug. 12, 2005, (136) PCT patent application serial number PCT/US2005/028669, attorney docket number 25791.194.02, filed on Aug. 11, 2005, (137) PCT patent application serial number PCT/US2005/028453, attorney docket number 25791.371, filed on Aug. 11, 2005, (138) PCT patent application serial number PCT/US2005/028641, attorney docket number 25791.372, filed on Aug. 11, 2005, (139) PCT patent application serial number PCT/US2005/028819, attorney docket number 25791.373, filed on Aug. 11, 2005, (140) PCT patent application serial number PCT/US2005/028446, attorney docket number 25791.374, filed on Aug. 11, 2005, (141) PCT patent application serial number PCT/US2005/028642, attorney docket number 25791.375, filed on Aug. 11, 2005, (142) PCT patent application serial number PCT/US2005/028451, attorney docket number 25791.376, filed on Aug. 11, 2005, and (143). PCT patent application serial number PCT/US2005/028473, attorney docket number 25791.377, filed on Jul. 29, 2005, (144) U.S. National Stage application Ser. No. 10/546,084, attorney docket no. 25791.185.05, filed on Aug. 17, 2005; (145) U.S. National Stage application Ser. No. 10/546,082, attorney docket no. 25791.378, filed on Aug. 17, 2005; (146) U.S. National Stage application Ser. No. 10/546,076, attorney docket no. 25791.379, filed on Aug. 17, 2005; (147) U.S. National Stage application Ser. No. 10/546,936, attorney docket no. 25791.380, filed on Aug. 17, 2005; (148) U.S. National Stage application Ser. No. 10/546,079, attorney docket no. 25791.381, filed on Aug. 17, 2005; (149) U.S. National Stage application Ser. No. 10/545,941, attorney docket no. 25791.382, filed on Aug. 17, 2005; (150) U.S. National Stage application Ser. No. 10/546,078, attorney docket no. 25791.383, filed on Aug. 17, 2005 the disclosures of which are incorporated herein by reference.

The expansion device 4208a is positioned in the first tubular member passageway 4008 and moved through the first tubular member passageway 4008 in a direction 4208c. By positioning the expansion device 4208a in the first tubular member passageway 4008 and moving it in the direction 4208c, the first tubular member 4000 is radially expanded and plastically deformed such that the outer surface 4002a of the first tubular member 4000 engages the inner surface 3902 of the preexisting structure 3900, as illustrated in FIG. 67d. Continued movement of the expansion device 4208a in the direction 4208c results in the radial expansion and plastic deformation second tubular member 4100 and the portions of the first tubular member 4000 and the second tubular member 4100 which couple the first tubular member 4000 and the second tubular member 4100 together. In an exemplary embodiment, the inner surfaces 4002b and 4102b on the first tubular member 4000 and the second tubular member 4100, respectively, are coated with a lubricating material known in the art to facilitate movement of the expansion device 4208a through the first tubular member 4000 and the second tubular member 4100. Using a conventional apparatus and method to couple the first tubular member 4000 and the second tubular member 4100 can result in the distal end 4102c of the second tubular member 4100 experiencing spring-back, due to the residual stresses in the second tubular member 4100, which can cause the distal end 4102c of the second tubular member 4100 to disengage from the first tubular member 4000 and become biased towards the second tubular member passageway 4108. Spring-back can cause the seal between the first tubular member 4000 and the second tubular member 4100 to fail due to the disengagement of the sealing member engagement surface 4110a and the primary sealing member 4204a and the secondary sealing member 4204b. However, due to the engagement of the distal end securing member 4010 on the first tubular member 4000 and the distal end securing member 4110 on the second tubular member 4100, spring-back in the second tubular member 4100 is prevented and the engagement of the sealing member engagement surface 4110a and the primary sealing member 4204a and the secondary sealing member 4204b is maintained, providing a gas and liquid tight seal between the first tubular member 4000 and the second tubular member 4100. Thus, a method and apparatus are provided for coupling expandable tubular members which prevents spring-back in the expandable tubular members upon the radial expansion and plastic deformation of the expandable tubular members in order to provide a gas and liquid tight seal between the expandable tubular members.

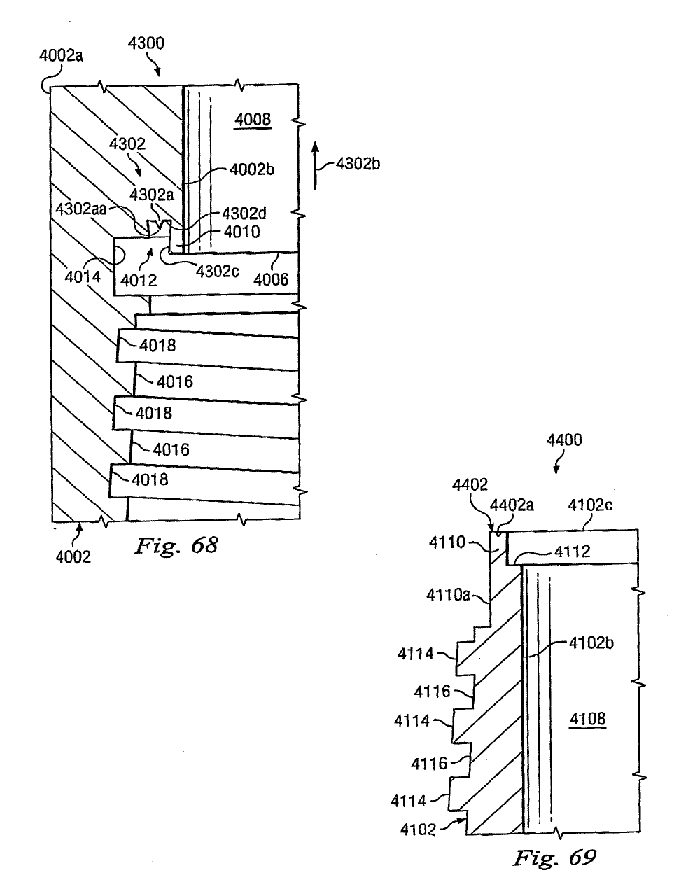

Referring now to FIG. 68, in an alternative embodiment, a first tubular member 4300 is substantially similar in design and operation to the first tubular member 4000, described above with reference to FIGS. 65, 67a, 67b, 67c, 67d, and 67e, with the provision of an interference fit feature 4302 included in the distal end securing channel 4012. In an exemplary embodiment, the interference fit feature 4302 includes an annular interference fit member 4302a which extends from the distal end securing channel 4012 and includes an engagement edge 4302aa. In an exemplary embodiment, the distal end securing channel 4012 increases in width along a direction 4302b from the beginning 4302c of the distal end securing channel 4012 to the rear surface 4302d of the distal end securing channel 4012. In an exemplary embodiment, the interference fit feature 4302, the interference fit member 4302a, and/or the distal end securing channel 4012 may include a variety of different configuration known in the art for providing an interference fit.

Referring now to FIG. 69, in an alternative embodiment, a second tubular member 4400 is substantially similar in design and operation to the second tubular member 4100, described above with reference to FIGS. 66, 67a, 67b, 67c, 67d, and 67e, with the provision of an interference fit feature 4402 included on the distal end securing member 4110. In an exemplary embodiment, the interference fit feature 4402 includes a annular notch 4402a defined by the distal end securing member 4110. In an exemplary embodiment, the interference fit feature 4402 and/or the notch 4402a may include a variety of different configuration known in the art for providing an interference fit.

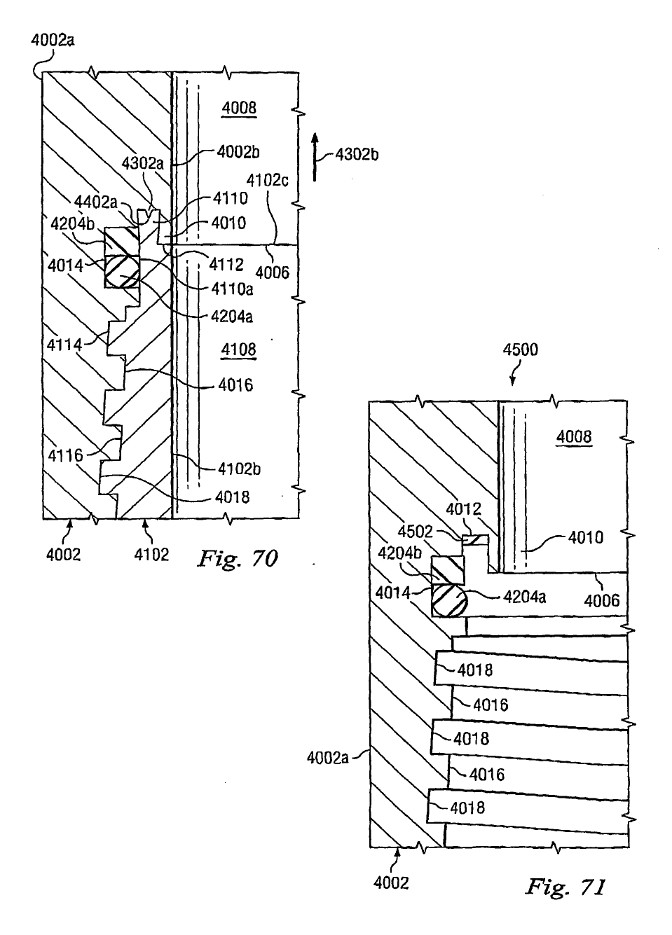

Referring now to FIGS. 67a, 67b, 68, 69, and 70, in operation, upon step 4204 of the method 4200 the first tubular member 4300 is coupled to the second tubular member 4400 in substantially the same manner as described above for the first tubular member 4000 and the second tubular member 4100. However, when the first tubular member 4000 is coupled to the second tubular member 4100, and the distal end securing member 4110 on the second tubular member 4100 enters the distal end securing channel 4012 on the first tubular member 4000, the engagement edge 4302aa on the interference fit member 4302a in the distal end securing channel 4012 engages the notch 4402a and causes the distal end securing member 4110 to deform into the distal end securing channel 4012, providing an interference fit between the distal end securing member 4110 and the distal end securing channel 4012. In an exemplary embodiment, the interference fit features 4302 and 4402 on the first tubular member 4300 and the second tubular member 4400, respectively, may include a variety of different configurations known in the art for providing an interference fit between the distal end securing member 4110 and the distal end securing channel 4012. In an exemplary embodiment, methods known in the art may be used to provide a cold weld between the distal end securing member 4110 on the second tubular member 4100 and the distal end securing channel 4012 on the first tubular member 4000. In an exemplary embodiment, the distal end securing member 4110 on the second tubular member 4100 is fabricated from a material having a different hardness than the distal end securing channel 4012 on the first tubular member 4000, facilitating the deformation of the distal end securing member 4110 in the distal end securing channel 4012 to couple the first tubular member 4000 to the second tubular member 4100.

Referring now to FIG. 71, in an alternative embodiment, a first tubular member 4500 is substantially similar in design and operation to the first tubular member 4000, described above with reference to FIGS. 65, 67a, 67b, 67c, 67d, and 67e, with the provision of an insert 4502 included in the distal end securing channel 4012. In an exemplary embodiment, the insert 4502 is a material known in the art for providing a brazed connection.

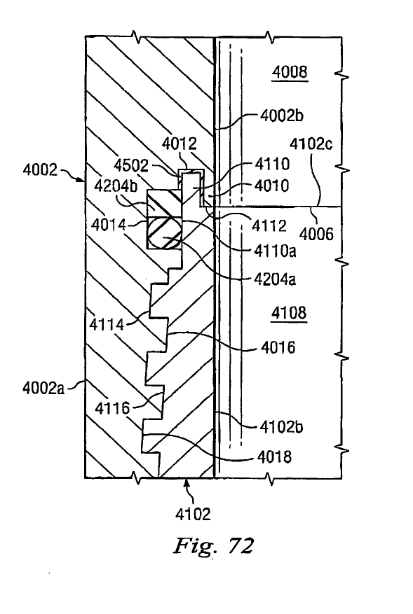

Referring now to FIGS. 65, 67a, 67b, 71, and 72, in operation, upon step 4204 of the method 4200 the first tubular member 4500 is coupled to the second tubular member 4100 in substantially the same manner as described above for the first tubular member 4000 and the second tubular member 4100. However, when the first tubular member 4500 is coupled to the second tubular member 4100, the insert 4502 deforms and provides a brazed connection between the distal end securing member 4110 and the distal end securing channel 4012, as illustrated in FIG. 72.

An expandable tubular member has been described that includes a first tubular member comprising a first tubular member diameter which decreases from a first outside diameter along the length of the first tubular member to a second outside diameter adjacent a first tubular member connection end on the first tubular member, a second tubular member comprising a second tubular member diameter which decreases from a third outside diameter along the length of the second tubular member to a fourth outside diameter adjacent a second tubular member connection end on the second tubular member, whereby the second tubular member connection end is positioned adjacent the first tubular member connection end, and a connection member coupled to the second outside diameter and the fourth outside diameter, whereby the connection member comprises a connection member diameter which is not substantially greater than the first outside diameter and the third outside diameter. In an exemplary embodiment, the first outside diameter is substantially equal to the third outside diameter. In an exemplary embodiment, the second outside diameter is substantially equal to the fourth outside diameter. In an exemplary embodiment, the connection member diameter is less than or equal to the first outside diameter and the third outside diameter. In an exemplary embodiment, the connection member diameter is less than the first outside diameter and the third outside diameter. In an exemplary embodiment, the first tubular member connection end is coupled the second tubular member connection end. In an exemplary embodiment, a protective sleeve is coupled to the connection member. In an exemplary embodiment, the first tubular member, the second tubular member, and the connection member are positioned in a wellbore.

An expandable tubular member has been described that includes a first tubular member comprising a maximum first tubular member diameter, a second tubular member comprising a maximum second tubular member diameter, whereby the second tubular member is positioned adjacent the first tubular member, and means for allowing a connection member to be coupled to the first tubular member and the second tubular without a maximum connection member diameter being substantially greater than the maximum first tubular member diameter and the maximum second tubular member diameter.

An expandable tubular member has been described that includes a tubular member comprising an inner surface and an outer surface, a thread member extending from the inner surface, and an expansion channel defined by the tubular member and located on the outer surface and adjacent the thread member. In an exemplary embodiment, a plurality of thread members extend from the inner surface, and an expansion channel is defined by the tubular member and located on the outer surface and adjacent each of the plurality of thread members. In an exemplary embodiment, the expansion channel is located radially adjacent the thread member. In an exemplary embodiment, the expansion channel comprises a helical channel on the outer surface of the tubular member. In an exemplary embodiment, the expansion channel provides a stress concentration in the thread member during radial expansion and plastic deformation of the tubular member.

An expandable tubular member has been described that includes a tubular member comprising an inner surface and an outer surface, a thread member extending from the inner surface, and means for providing a stress concentration in the thread member during radial expansion and plastic deformation of the tubular member. In an exemplary embodiment, the means for providing a stress concentration comprises a helical groove on the outer surface of the tubular member. In an exemplary embodiment, the means for providing a stress concentration comprises means for providing a stress concentration along the length of the thread member.

An expandable tubular member has been described that includes a first tubular member comprising an inner surface and an outer surface, a thread member extending from the inner surface, an expansion channel defined by the first tubular member and located on the outer surface and adjacent the thread member, and a second tubular member coupled the first tubular member and engaging the thread member. In an exemplary embodiment, a plurality of thread members extend from the inner surface, whereby the second tubular member is coupled to the first tubular member and engaging the plurality of thread members, and an expansion channel is defined by the first tubular member and located on the outer surface and adjacent each of the plurality of thread members. In an exemplary embodiment, the expansion channel is located radially adjacent the thread member. In an exemplary embodiment, the first tubular member and the second tubular member are positioned in a wellbore. In an exemplary embodiment, the expansion channel comprises a helical channel on the outer surface of the first tubular member. In an exemplary embodiment, the expansion channel provides a stress concentration in the thread member during radial expansion and plastic deformation of the tubular member. In an exemplary embodiment, a tubular connection sleeve is positioned on the first tubular member, and an expansion slot is defined by the tubular connection sleeve in a substantially axial orientation with respect to the tubular connection sleeve and located adjacent the expansion channel. In an exemplary embodiment, the expansion slot is oriented substantially perpendicularly with respect to the expansion channel. In an exemplary embodiment, a plurality of spaced apart expansion slots are defined by the tubular connection sleeve in a substantially axial orientation with respect to the tubular connection sleeve and located adjacent the expansion channel. In an exemplary embodiment, the plurality of spaced apart expansion slots are oriented substantially perpendicularly with respect to the expansion channel. In an exemplary embodiment, the plurality of spaced apart expansion slots are spaced apart about the circumference of the tubular connection sleeve. In an exemplary embodiment, the first tubular member the second tubular member, and the tubular connection sleeve are positioned in a wellbore. In an exemplary embodiment, the expansion slot on the tubular connection sleeve provides at least one discrete point stress concentration on the thread member during radial expansion and plastic deformation of the first tubular member.

An expandable tubular member has been described that includes a first tubular member comprising an inner surface and an outer surface, a thread member extending from the inner surface, an expansion channel defined by the first tubular member and located on the outer surface and adjacent the thread member, a tubular connection sleeve positioned on the first tubular member, an expansion slot defined by the tubular connection sleeve in a substantially axial orientation with respect to the tubular connection sleeve and located adjacent the expansion channel, and a second tubular member coupled the first tubular member and engaging the thread member, whereby upon radial expansion and plastic deformation of the first tubular member and the second tubular member, the first tubular member and the second tubular member can withstand a pressure of up to approximately 4000 pounds per square inch.

An expandable tubular member has been described that includes a first tubular member defining a flange channel on a first surface of the first tubular member, and resilient means positioned in the flange channel for forming a seal between the first tubular member and a second tubular member. In an exemplary embodiment, the resilient means for forming a seal comprises means for forming a metal to metal seal. In an exemplary embodiment, the resilient means comprises a wave spring. In an exemplary embodiment, the resilient means comprises an O-ring.

An expandable tubular member has been described that includes a first tubular member comprising a flange member extending from a surface on the first tubular member, the flange member comprising a resilient beam extending from a distal end of the flange member for forming a seal between the first tubular member and a second tubular member.

An expandable tubular member has been described that includes a first tubular member defining a flange channel on a surface of the first tubular member, a second tubular member comprising a flange member extending from a surface on the second tubular member, the second tubular member coupled to the first tubular member with the flange member positioned in the flange channel, whereby a sealing passageway is defined between the flange member and the flange channel, and resilient means for forming a seal between the first tubular member and the second tubular member positioned in the sealing passageway. In an exemplary embodiment, the resilient means for forming a seal comprises means for forming a metal to metal seal. In an exemplary embodiment, the resilient member comprises a wave spring. In an exemplary embodiment, the wave spring is positioned in the sealing passageway and circumferentially between the flange member and the flange channel. In an exemplary embodiment, the first tubular member, the second tubular member, and the wave spring are positioned in a wellbore. In an exemplary embodiment, the resilient member comprises an O-ring. In an exemplary embodiment, the O-ring is positioned in the sealing passageway and circumferentially between the flange member and the flange channel. In an exemplary embodiment, the first tubular member, the second tubular member, and the O-ring are positioned in a wellbore. In an exemplary embodiment, the resilient member comprises a resilient beam extending from a distal end of the flange member. In an exemplary embodiment, the resilient beam is located in the sealing passageway and circumferentially between the flange member and the flange channel. In an exemplary embodiment, the first tubular member, the second tubular member, and the resilient beam are positioned in a wellbore.

A connection member for coupling expandable tubular members has been described that includes a tubular connection member comprising an inner surface and an outer surface, a primary sealing member having a substantially diamond shaped cross section and extending from a substantially central location on the inner surface, a reinforced section located on the outer surface and adjacent the primary sealing member, and a plurality of secondary sealing surfaces located on opposite distal ends of the tubular connection member and on opposite sides of the primary sealing member. In an exemplary embodiment, the primary sealing member is deformable to provide a metal to metal seal between the tubular connection member and an expandable tubular member. In an exemplary embodiment, the plurality of secondary sealing surfaces are deformable to provide a metal to metal seal between the tubular connection member and an expandable tubular member.

A connection member for coupling expandable tubular members has been described that includes a tubular connection member, and means for providing a primary and secondary metal to metal seal between the tubular connection member and an expandable tubular member.

An expandable tubular member has been described that includes a first tubular member comprising a first connection end, a second tubular member comprising a second connection end, and a connection member coupling together the first tubular member and the second tubular member, the connection member including a tubular connection member comprising an inner surface and an outer surface, the inner surface engaging the first tubular member and the second tubular member, a primary sealing member having a substantially diamond shaped cross section, extending from a substantially central location on the inner surface, and positioned between the first connection end and the second connection end, a reinforced section located on the outer surface and adjacent the primary sealing member, and a plurality of secondary sealing surfaces located on opposite distal ends of the tubular connection member and on opposite sides of the primary sealing member, the secondary sealing surfaces coupled to the first connection end and the second connection end. In an exemplary embodiment, the primary sealing member is deformable to provide a metal to metal seal between the connection member and the first tubular member and the second tubular member. In an exemplary embodiment, the plurality of secondary sealing surfaces are deformable to provide a metal to metal seal between the connection member and the first tubular member and the second tubular member. In an exemplary embodiment, the first tubular member, the second tubular member, and the connection member are positioned in a wellbore.

An expandable tubular member has been described that includes a first tubular member comprising a first connection end, a second tubular member comprising a second connection end, a connection member coupled to the first connection end and the second connection end, and means for providing a primary and secondary metal to metal seal between the connection member and the first tubular member and the second tubular member.

A method for coupling expandable tubular members has been described that includes providing a first tubular member comprising a maximum first tubular member diameter, providing a second tubular comprising a maximum second tubular member diameter, and coupling the first tubular member to the second tubular member with a connection member comprising a maximum connection member diameter which is not substantially greater than the maximum first tubular member diameter and the maximum second tubular member diameter. In an exemplary embodiment, the method further includes coupling a protective sleeve adjacent the connection member. In an exemplary embodiment, the method further includes positioning the first tubular member, the second tubular member, and the connection member in a wellbore. In an exemplary embodiment, the method further includes radially expanding and plastically deforming the first tubular member and the second tubular member. In an exemplary embodiment, the radially expanding and plastically deforming comprises radially expanding and plastically deforming a first reduced diameter section on the first tubular member to substantially the maximum first tubular member diameter and radially expanding and plastically deforming a second reduced diameter section on the second tubular member to substantially the maximum second tubular member diameter. In an exemplary embodiment, the radially expanding and plastically deforming comprises radially expanding and plastically deforming the first tubular member and the second tubular member into engagement with the wellbore.

A method for coupling expandable tubular members has been described that includes providing a first tubular member comprising a thread member extending from an inner surface and defining a expansion channel on the outer surface which is located adjacent the thread member, and coupling a second tubular member to the first tubular member by engaging the thread member with a thread channel in the second tubular member. In an exemplary embodiment, the method further includes positioning the first tubular member and the second tubular member in a wellbore. In an exemplary embodiment, the method further includes radially expanding and plastically deforming the first tubular member and the second tubular member, whereby the expansion channel provides a stress concentration in the thread member which increases the deformation of the thread member in the thread channel during the radially expanding and plastically deforming. In an exemplary embodiment, the radially expanding and plastically deforming provides a metal to metal seal between the thread member and the thread channel. In an exemplary embodiment, the method further includes coupling a connection sleeve to the outer surface of the of the first tubular member, the connection sleeve defining an expansion slot oriented axially with respect the connection sleeve and which is positioned substantially perpendicularly to the expansion channel. In an exemplary embodiment, the method further includes positioning the first tubular member, the second tubular member, and the connection sleeve in a wellbore. In an exemplary embodiment, the method further includes radially expanding and plastically deforming the first tubular member, the second tubular member, and the connection sleeve, whereby the expansion slot and the expansion channel provide a stress concentration which increases the deformation of the thread member in the thread channel during the radially expanding and plastically deforming. In an exemplary embodiment, the radially expanding and plastically deforming provides a metal to metal seal between the thread member and the thread channel.

A method for coupling expandable tubular members has been described that includes providing a first tubular member comprising a flange member extending from an inner surface, providing a second tubular member defining a flange channel on an outer surface, positioning a resilient member in the flange channel, and coupling the first tubular member to the second tubular member by positioning the flange member in the flange channel and adjacent the resilient member. In an exemplary embodiment, the method further includes positioning the first tubular member and the second tubular member in a wellbore. In an exemplary embodiment, the method further includes radially expanding and plastically deforming the first tubular member and the second tubular member, whereby the radially expanding and plastically deforming compresses the resilient member and provides a seal between the flange member and the flange channel. In an exemplary embodiment, the radially expanding and plastically deforming provides a metal to metal seal between the flange member and the flange channel.

A method for coupling expandable tubular members has been described that includes providing a first tubular member comprising a first connection end, providing a second tubular member comprising a second connection end, positioning a connection member adjacent the first connection end and the second connection end such that a primary sealing member on the connection member is positioned between the first connection end and the second connection end, and a plurality of secondary sealing surfaces are positioned adjacent the first tubular member and the second tubular member, and coupling the first tubular member to the second tubular member using the connection member. In an exemplary embodiment, the coupling includes providing a metal sealing member between the first tubular member, the second tubular member, and the secondary sealing surfaces. In an exemplary embodiment, the method further includes positioning the first tubular member, the second tubular member, and the connection member in a wellbore. In an exemplary embodiment, the method further includes radially expanding and plastically deforming the first tubular member and the second tubular member, whereby the radially expanding and plastically deforming provides a primary seal between the primary sealing member and the first tubular member and the second tubular member, and the radially expanding and plastically deforming provides a secondary seal between the secondary sealing surfaces and the first tubular member and the second tubular member.

An expandable tubular member has been described that includes a first tubular member, a second tubular member coupled to the first tubular member, and means for effecting a gas and fluid tight seal between the first tubular member and the second tubular member before, during, and after radial expansion and plastic deformation of the first tubular member and the second tubular member, the means providing a seal which can withstand a pressure of up to 4000 pounds per square inch.

An expandable tubular member has been described that includes a first tubular member comprising a first tubular member diameter which decreases from a first outside diameter along the length of the first tubular member to a second outside diameter adjacent a first tubular member connection end on the first tubular member, a second tubular member comprising a second tubular member diameter which decreases from first outside diameter along the length of the second tubular member to the second outside diameter adjacent a second tubular member connection end on the second tubular member, whereby the second tubular member connection end is coupled to the first tubular member connection end, and a connection member coupled to the second outside diameter, whereby the connection member comprises a connection member diameter which is less than or equal to the first outside diameter.

An expandable tubular member has been described that includes a tubular member comprising an inner surface and an outer surface, a plurality of thread members extending from the inner surface, and a helical expansion channel defined by the tubular member and located on the outer surface and radially adjacent each of the plurality of thread members, whereby the expansion channel provides a stress concentration in the thread member during radial expansion and plastic deformation of the tubular member.

An expandable tubular member has been described that includes a first tubular member comprising an inner surface and an outer surface, a plurality of thread member extending from the inner surface, a helical expansion channel defined by the first tubular member and located on the outer surface and radially adjacent each of the plurality of thread members, a second tubular member coupled the first tubular member and engaging the plurality of thread members, whereby the expansion channel provides a stress concentration in the thread member during radial expansion and plastic deformation of the first tubular member and the second tubular member, a tubular connection sleeve positioned on the first tubular member, and a plurality of spaced apart expansion slots defined by the tubular connection sleeve in a substantially axial orientation with respect to the tubular connection sleeve and oriented substantially perpendicularly adjacent to and with respect to the expansion channel; whereby the plurality of expansion slots on the tubular connection sleeve provides a plurality of discrete point stress concentrations on the thread member during radial expansion and plastic deformation of the first tubular member, the second tubular member, and the connection sleeve.

A connection member for coupling expandable tubular members has been described that includes a tubular connection member comprising an inner surface and an outer surface, a primary sealing member having a substantially diamond shaped cross section, extending from a substantially central location on the inner surface, and deformable to provide a metal to metal seal between the tubular connection member and an expandable tubular member, a reinforced section located on the outer surface and adjacent the primary sealing member, and a plurality of secondary sealing surfaces located on opposite distal ends of the tubular connection member on opposite sides of the primary sealing member, and deformable to provide a metal to metal seal between the tubular connection member and an expandable tubular member.

An expandable tubular member has been described that includes a first tubular member comprising a first connection end, a second tubular member comprising a second connection end, and a connection member coupling together the first tubular member and the second tubular member, the connection member including a tubular connection member comprising an inner surface and an outer surface, the inner surface engaging the first tubular member and the second tubular member, a primary sealing member having a substantially diamond shaped cross section, extending from a substantially central location on the inner surface, positioned between the first connection end and the second connection end, and deformable to provide a metal to metal seal between the connection member and the first tubular member and the second tubular member, a reinforced section located on the outer surface and adjacent the primary sealing member, and a plurality of secondary sealing surfaces located on opposite distal ends of the tubular connection member and on opposite sides of the primary sealing member, the secondary sealing surfaces coupled to the first connection end and the second connection end and deformable to provide a metal to metal seal between the connection member and the first tubular member and the second tubular member.

A method for coupling expandable tubular members has been described that includes providing a first tubular member comprising a maximum first tubular member diameter, providing a second tubular comprising a maximum second tubular member diameter, coupling the first tubular member to the second tubular member with a connection member comprising a maximum connection member diameter which is not substantially greater than the maximum first tubular member diameter and the maximum second tubular member diameter, positioning the first tubular member, the second tubular member, and the connection member in a wellbore, and radially expanding and plastically deforming the first tubular member and the second tubular member, wherein the radially expanding and plastically deforming comprises one of either radially expanding and plastically deforming a first reduced diameter section on the first tubular member to substantially the maximum first tubular member diameter and radially expanding and plastically deforming a second reduced diameter section on the second tubular member to substantially the maximum second tubular member diameter or radially expanding and plastically deforming the first tubular member and the second tubular member into engagement with the wellbore.

A method for coupling expandable tubular members has been described that includes providing a first tubular member comprising a thread member extending from an inner surface and defining a expansion channel on the outer surface which is located adjacent the thread member, coupling a connection sleeve to the outer surface of the of the first tubular member, the connection sleeve defining an expansion slot oriented axially with respect the connection sleeve and which is positioned substantially perpendicularly to the expansion channel, coupling a second tubular member to the first tubular member by engaging the thread member with a thread channel in the second tubular member, positioning the first tubular member, the second tubular member, and the connection sleeve in a wellbore, and radially expanding and plastically deforming the first tubular member, the second tubular member, and the connection sleeve, whereby the expansion slot and the expansion channel provide a stress concentration which increases the deformation of the thread member in the thread channel during the radially expanding and plastically deforming and provides a metal to metal seal between the thread member and the thread channel.

A method for coupling expandable tubular members has been described that includes providing a first tubular member comprising a flange member extending from an inner surface, providing a second tubular member defining a flange channel on an outer surface, positioning a resilient member in the flange channel, coupling the first tubular member to the second tubular member by positioning the flange member in the flange channel and adjacent the resilient member, positioning the first tubular member and the second tubular member in a wellbore, and radially expanding and plastically deforming the first tubular member and the second tubular member, whereby the radially expanding and plastically deforming compresses the resilient member and provides a seal between the flange member and the flange channel; whereby the radially expanding and plastically deforming provides a metal to metal seal between the flange member and the flange channel.

A method for coupling expandable tubular members has been described that includes providing a first tubular member comprising a first connection end, providing a second tubular member comprising a second connection end, positioning a connection member adjacent the first connection end and the second connection end such that a primary sealing member on the connection member is positioned between the first connection end and the second connection end, and a plurality of secondary sealing surfaces are positioned adjacent the first tubular member and the second tubular member, coupling the first tubular member to the second tubular member using the connection member, whereby the coupling includes providing a metal sealing member between the first tubular member, the second tubular member, and the secondary sealing surfaces, positioning the first tubular member, the second tubular member, and the connection member in a wellbore, and radially expanding and plastically deforming the first tubular member and the second tubular member, whereby the radially expanding and plastically deforming provides a primary seal between the primary sealing member and the first tubular member and the second tubular member, and the radially expanding and plastically deforming provides a secondary seal between the secondary sealing surfaces and the first tubular member and the second tubular member.

A useful method of forming a wellbore casing within a borehole that traverses a subterranean formation has been described that includes a first wellbore casing for positioning within the borehole and coupling the first wellbore casing to a second wellbore casing for positioning within the borehole such that the second wellbore casing overlaps with and is coupled to a portion of the first wellbore casing thereby forming a joint, positioning a tubular sleeve so that it overlaps with and is coupled to at least a portion of the first wellbore casing and to a portion of the second wellbore casing, the tubular sleeve extending a length in either axial direction from the joint between the first and second wellbore casings, causing the tubular sleeve to collapse inwardly onto the respective end portions of the first and second wellbore casings and to sealingly engage the exterior surfaces of the end portions of the first and second wellbore casings respectively on either side of the joint there between, thereby facilitating sealing the joint.

In an exemplary embodiment, the method further includes regularly expanding and plastically deforming the overlapping portions of the first and second wellbore casing and regularly expanding and plastically deforming the tubular sleeve that was sealingly collapsed onto the overlapping portions of the first and second wellbore casings. In an exemplary embodiment, the exterior diameters of the first and second wellbore casings axially adjacent to the joint there between are substantially equal. In an exemplary embodiment, the inside diameters of the first wellbore casings and the inside diameter of the second wellbore casing are substantially equal. In an exemplary embodiment, the inside diameters of the first wellbore casing and the second wellbore casing are substantially constant.

An assembly has been described that includes a first tubular member including external threads, and a second tubular member comprising internal threads coupled to the external threads of the first tubular member. At least one of the first and second tubular members define one or more stress concentrators. In an exemplary embodiment, the assembly further comprises an external sleeve coupled to and overlapping with the ends of the first and second tubular members. In an exemplary embodiment, one or more of the stress concentrators comprise surface grooves formed in the surfaces of at least one of the first and second tubular members. In an exemplary embodiment, the stress concentrators are defined above the internal and external threads of the first and second tubular members.

A method for forming a wellbore casing has been described that includes positioning any one, portion, or combination, of the exemplary embodiments of the assemblies of the present application within a borehole that traverses a subterranean formation, and radially expanding and plastically deforming the assembly within the borehole.

An apparatus has been described that includes a wellbore that traverses a subterranean formation, and a wellbore casing positioned within and coupled to the wellbore. The wellbore casing is coupled to the wellbore by a process including: positioning any one, portion, or combination, of the exemplary assemblies of the present application within the wellbore, and radially expanding and plastically deforming the assembly within the wellbore.

A system for forming a wellbore casing has been described that includes means for positioning any one, portion, or combination, of the exemplary assemblies of the present application within a borehole that traverses a subterranean formation, and means for radially expanding and plastically deforming the assembly within the borehole.

A method of providing a fluid tight seal between a pair of overlapping tubular members has been described that includes forming one or more stress concentrators within at least one of the tubular members, and radially expanding and plastically deforming the tubular members. In an exemplary embodiment, the tubular members are threadably coupled, and the stress concentrators are formed above the threaded coupling. In an exemplary embodiment, the stress concentrators comprise surface grooves formed in at least one of the tubular members.

An assembly has been described that includes a first tubular member including external threads, a second tubular member including internal threads coupled to the external threads of the first tubular member, and at least one stress concentrator adapted to improve a seal between the first tubular member and the second tubular member. In an exemplary embodiment, the assembly further includes an external sleeve surrounding the first and second tubular members. In an exemplary embodiment, one or more of the stress concentrators include at least one surface of at least one of the first tubular member and the second tubular member. In an exemplary embodiment, the stress concentrator is defined axially adjacent to the internal threads of the second tubular member and external threads of the first tubular member. In an exemplary embodiment, the stress concentrator is defined radially offset from the internal threads of the second tubular member and external threads of the first tubular member.

An assembly has been described that includes a first tubular member including first threads on an external surface of the first tubular member, and a second tubular member including second threads on an internal surface of the second tubular member; wherein the first threads are adapted to threadingly engage with the second threads, and at least one stress concentrator. In an exemplary embodiment, the stress concentrator includes a groove defined on an exterior surface of the second tubular member. In an exemplary embodiment, the groove includes a helical groove. In an exemplary embodiment, the second threads include a pitch and a thread count, and the helical groove includes at least one of a pitch and a thread count substantially similar to the pitch and the thread count of the second threads. In an exemplary embodiment, the groove includes a plurality of radial grooves. In an exemplary embodiment, the stress concentrator includes a plurality of axial grooves. In an exemplary embodiment, the stress concentrator includes a groove on an internal surface of the first tubular member. In an exemplary embodiment, the assembly further includes a sleeve exterior to the second tubular member, wherein the stress concentrator includes at least one of a groove and a notch in a surface of the sleeve

A method has been described that includes connecting a first tubular member including external threads with a second tubular member including internal threads, providing at least one stress concentrator adapted to improve a seal between the first tubular member and the second tubular member, positioning the first tubular member and the second tubular member within a borehole that traverses a subterranean formation, and radially expanding and plastically deforming the first tubular member and the second tubular member within the borehole.

A method has been described that includes connecting a first tubular member including first threads on an external surface with a second tubular member including second threads on an internal surface, providing at least one stress concentrator, positioning the first tubular member and the second tubular member within a borehole that traverses a subterranean formation, and radially expanding and plastically deforming the first tubular member and the second tubular member within the borehole.

An apparatus has been described that includes a wellbore that traverses a subterranean formation, and a wellbore casing positioned within the wellbore, the wellbore casing including: a first tubular member including external threads, and a second tubular member including internal threads coupled to the external threads of the first tubular member, at least one stress concentrator adapted to improve a seal between the first tubular member and the second tubular member.

An apparatus has been described that includes a wellbore that traverses a subterranean formation, and a wellbore casing positioned within the wellbore, wherein the wellbore casing is position within the wellbore by a process including: connecting a first tubular member including external threads with a second tubular member including internal threads, providing at least one stress concentrator adapted to improve a seal between the first tubular member and the second tubular member, positioning the first tubular member and the second tubular member within the wellbore, and radially expanding and plastically deforming the first tubular member and the second tubular member within the wellbore.

An apparatus has been described that includes a first tubular member including external threads, a second tubular member including internal threads coupled to the external threads of the first tubular member, and a means to improve a seal between the first tubular member and the second tubular member following a radial expansion and plastic deformation of the first and second tubular members.

A method has been described that includes providing a first tubular member and a second tubular member, forming one or more stress concentrators within at least one of the first and the second tubular members, connecting the first tubular member including first threads on an external surface with the second tubular member including second threads on an internal surface, and radially expanding and plastically deforming the tubular members. In an exemplary embodiment, the tubular members are threadably coupled, and the stress concentrators are formed adjacent the threaded coupling. In an exemplary embodiment, the stress concentrators include surface grooves formed in at least one of the tubular members.

A radially expandable multiple tubular member apparatus has been described that includes a first tubular member; a second tubular member engaged with the first tubular member forming a joint; a sleeve overlapping and coupling the first and second tubular members at the joint; the sleeve having opposite tapered ends and a flange engaged in a recess formed in an adjacent tubular member; and one of the tapered ends being a surface formed on the flange. In an exemplary embodiment, the recess includes a tapered wall in mating engagement with the tapered end formed on the flange. In an exemplary embodiment, the sleeve includes a flange at each tapered end and each tapered end is formed on a respective flange. In an exemplary embodiment, each tubular member includes a recess. In an exemplary embodiment, each flange is engaged in a respective one of the recesses. In an exemplary embodiment, each recess includes a tapered wall in mating engagement with the tapered end formed on a respective one of the flanges.

A method of joining radially expandable multiple tubular members has also been described that includes providing a first tubular member; engaging a second tubular member with the first tubular member to form a joint; providing a sleeve having opposite tapered ends and a flange, one of the tapered ends being a surface formed on the flange; and mounting the sleeve for overlapping and coupling the first and second tubular members at the joint, wherein the flange is engaged in a recess formed in an adjacent one of the tubular members. In an exemplary embodiment, the method further includes providing a tapered wall in the recess for mating engagement with the tapered end formed on the flange. In an exemplary embodiment, the method further includes providing a flange at each tapered end wherein each tapered end is formed on a respective flange. In an exemplary embodiment, the method further includes providing a recess in each tubular member. In an exemplary embodiment, the method further includes engaging each flange in a respective one of the recesses. In an exemplary embodiment, the method further includes providing a tapered wall in each recess for mating engagement with the tapered end formed on a respective one of the flanges.

A radially expandable multiple tubular member apparatus has been described that includes a first tubular member; a second tubular member engaged with the first tubular member forming a joint; and a sleeve overlapping and coupling the first and second tubular members at the joint; wherein at least a portion of the sleeve is comprised of a frangible material.

A radially expandable multiple tubular member apparatus has been described that includes a first tubular member; a second tubular member engaged with the first tubular member forming a joint; and a sleeve overlapping and coupling the first and second tubular members at the joint; wherein the wall thickness of the sleeve is variable.

A method of joining radially expandable multiple tubular members has been described that includes providing a first tubular member; engaging a second tubular member with the first tubular member to form a joint; providing a sleeve comprising a frangible material; and mounting the sleeve for overlapping and coupling the first and second tubular members at the joint.

A method of joining radially expandable multiple tubular members has been described that includes providing a first tubular member; engaging a second tubular member with the first tubular member to form a joint; providing a sleeve comprising a variable wall thickness; and mounting the sleeve for overlapping and coupling the first and second tubular members at the joint.

An expandable tubular assembly has been described that includes a first tubular member; a second tubular member coupled to the first tubular member; and means for increasing the axial compression loading capacity of the coupling between the first and second tubular members before and after a radial expansion and plastic deformation of the first and second tubular members.

An expandable tubular assembly has been described that includes a first tubular member; a second tubular member coupled to the first tubular member; and means for increasing the axial tension loading capacity of the coupling between the first and second tubular members before and after a radial expansion and plastic deformation of the first and second tubular members.

An expandable tubular assembly has been described that includes a first tubular member; a second tubular member coupled to the first tubular member; and means for increasing the axial compression and tension loading capacity of the coupling between the first and second tubular members before and after a radial expansion and plastic deformation of the first and second tubular members.

An expandable tubular assembly has been described that includes a first tubular member; a second tubular member coupled to the first tubular member; and means for avoiding stress risers in the coupling between the first and second tubular members before and after a radial expansion and plastic deformation of the first and second tubular members.

An expandable tubular assembly has been described that includes a first tubular member; a second tubular member coupled to the first tubular member; and means for inducing stresses at selected portions of the coupling between the first and second tubular members before and after a radial expansion and plastic deformation of the first and second tubular members.

In several exemplary embodiments of the apparatus described above, the sleeve is circumferentially tensioned; and wherein the first and second tubular members are circumferentially compressed.

In several exemplary embodiments of the method described above, the method further includes maintaining the sleeve in circumferential tension; and maintaining the first and second tubular members in circumferential compression before, during, and/or after the radial expansion and plastic deformation of the first and second tubular members.

An expandable tubular assembly has been described that includes a first tubular member, a second tubular member coupled to the first tubular member, a first threaded connection for coupling a portion of the first and second tubular members, a second threaded connection spaced apart from the first threaded connection for coupling another portion of the first and second tubular members, a tubular sleeve coupled to and receiving end portions of the first and second tubular members, and a sealing element positioned between the first and second spaced apart threaded connections for sealing an interface between the first and second tubular member, wherein the sealing element is positioned within an annulus defined between the first and second tubular members. In an exemplary embodiment, the annulus is at least partially defined by an irregular surface. In an exemplary embodiment, the annulus is at least partially defined by a toothed surface. In an exemplary embodiment, the sealing element comprises an elastomeric material. In an exemplary embodiment, the sealing element comprises a metallic material. In an exemplary embodiment, the sealing element comprises an elastomeric and a metallic material.

A method of joining radially expandable multiple tubular members has been described that includes providing a first tubular member, providing a second tubular member, providing a sleeve, mounting the sleeve for overlapping and coupling the first and second tubular members, threadably coupling the first and second tubular members at a first location, threadably coupling the first and second tubular members at a second location spaced apart from the first location, and sealing an interface between the first and second tubular members between the first and second locations using a compressible sealing element. In an exemplary embodiment, the sealing element includes an irregular surface. In an exemplary embodiment, the sealing element includes a toothed surface. In an exemplary embodiment, the sealing element comprises an elastomeric material. In an exemplary embodiment, the sealing element comprises a metallic material. In an exemplary embodiment, the sealing element comprises an elastomeric and a metallic material.

An expandable tubular assembly has been described that includes a first tubular member, a second tubular member coupled to the first tubular member, a first threaded connection for coupling a portion of the first and second tubular members, a second threaded connection spaced apart from the first threaded connection for coupling another portion of the first and second tubular members, and a plurality of spaced apart tubular sleeves coupled to and receiving end portions of the first and second tubular members. In an exemplary embodiment, at least one of the tubular sleeves is positioned in opposing relation to the first threaded connection; and wherein at least one of the tubular sleeves is positioned in opposing relation to the second threaded connection. In an exemplary embodiment, at least one of the tubular sleeves is not positioned in opposing relation to the first and second threaded connections.

A method of joining radially expandable multiple tubular members has been described that includes providing a first tubular member, providing a second tubular member, threadably coupling the first and second tubular members at a first location, threadably coupling the first and second tubular members at a second location spaced apart from the first location, providing a plurality of sleeves, and mounting the sleeves at spaced apart locations for overlapping and coupling the first and second tubular members. In an exemplary embodiment, at least one of the tubular sleeves is positioned in opposing relation to the first threaded coupling; and wherein at least one of the tubular sleeves is positioned in opposing relation to the second threaded coupling. In an exemplary embodiment, at least one of the tubular sleeves is not positioned in opposing relation to the first and second threaded couplings.

An expandable tubular assembly has been described that includes a first tubular member, a second tubular member coupled to the first tubular member, and a plurality of spaced apart tubular sleeves coupled to and receiving end portions of the first and second tubular members.

A method of joining radially expandable multiple tubular members has been described that includes providing a first tubular member, providing a second tubular member, providing a plurality of sleeves, coupling the first and second tubular members, and mounting the sleeves at spaced apart locations for overlapping and coupling the first and second tubular members.

An expandable tubular assembly has been described that includes a first tubular member, a second tubular member coupled to the first tubular member, a threaded connection for coupling a portion of the first and second tubular members, and a tubular sleeves coupled to and receiving end portions of the first and second tubular members, wherein at least a portion of the threaded connection is upset. In an exemplary embodiment, at least a portion of tubular sleeve penetrates the first tubular member.

A method of joining radially expandable multiple tubular members has been described that includes providing a first tubular member, providing a second tubular member, threadably coupling the first and second tubular members, and upsetting the threaded coupling. In an exemplary embodiment, the first tubular member further comprises an annular extension extending therefrom, and the flange of the sleeve defines an annular recess for receiving and mating with the annular extension of the first tubular member. In an exemplary embodiment, the first tubular member further comprises an annular extension extending therefrom; and the flange of the sleeve defines an annular recess for receiving and mating with the annular extension of the first tubular member.

A radially expandable multiple tubular member apparatus has been described that includes a first tubular member, a second tubular member engaged with the first tubular member forming a joint, a sleeve overlapping and coupling the first and second tubular members at the joint, and one or more stress concentrators for concentrating stresses in the joint. In an exemplary embodiment, one or more of the stress concentrators comprises one or more external grooves defined in the first tubular member. In an exemplary embodiment, one or more of the stress concentrators comprises one or more internal grooves defined in the second tubular member. In an exemplary embodiment, one or more of the stress concentrators comprises one or more openings defined in the sleeve. In an exemplary embodiment, one or more of the stress concentrators comprises one or more external grooves defined in the first tubular member; and one or more of the stress concentrators comprises one or more internal grooves defined in the second tubular member. In an exemplary embodiment, one or more of the stress concentrators comprises one or more external grooves defined in the first tubular member; and one or more of the stress concentrators comprises one or more openings defined in the sleeve. In an exemplary embodiment, one or more of the stress concentrators comprises one or more internal grooves defined in the second tubular member; and one or more of the stress concentrators comprises one or more openings defined in the sleeve. In an exemplary embodiment, one or more of the stress concentrators comprises one or more external grooves defined in the first tubular member; wherein one or more of the stress concentrators comprises one or more internal grooves defined in the second tubular member; and wherein one or more of the stress concentrators comprises one or more openings defined in the sleeve.

A method of joining radially expandable multiple tubular members has been described that includes providing a first tubular member, engaging a second tubular member with the first tubular member to form a joint, providing a sleeve having opposite tapered ends and a flange, one of the tapered ends being a surface formed on the flange, and concentrating stresses within the joint. In an exemplary embodiment, concentrating stresses within the joint comprises using the first tubular member to concentrate stresses within the joint. In an exemplary embodiment, concentrating stresses within the joint comprises using the second tubular member to concentrate stresses within the joint. In an exemplary embodiment, concentrating stresses within the joint comprises using the sleeve to concentrate stresses within the joint. In an exemplary embodiment, concentrating stresses within the joint comprises using the first tubular member and the second tubular member to concentrate stresses within the joint. In an exemplary embodiment, concentrating stresses within the joint comprises using the first tubular member and the sleeve to concentrate stresses within the joint. In an exemplary embodiment, concentrating stresses within the joint comprises using the second tubular member and the sleeve to concentrate stresses within the joint. In an exemplary embodiment, concentrating stresses within the joint comprises using the first tubular member, the second tubular member, and the sleeve to concentrate stresses within the joint.

A system for radially expanding and plastically deforming a first tubular member coupled to a second tubular member by a mechanical connection has been described that includes means for radially expanding the first and second tubular members, and means for maintaining portions of the first and second tubular member in circumferential compression following the radial expansion and plastic deformation of the first and second tubular members.

A system for radially expanding and plastically deforming a first tubular member coupled to a second tubular member by a mechanical connection has been described that includes means for radially expanding the first and second tubular members; and means for concentrating stresses within the mechanical connection during the radial expansion and plastic deformation of the first and second tubular members.

A system for radially expanding and plastically deforming a first tubular member coupled to a second tubular member by a mechanical connection has been described that includes means for radially expanding the first and second tubular members; means for maintaining portions of the first and second tubular member in circumferential compression following the radial expansion and plastic deformation of the first and second tubular members; and means for concentrating stresses within the mechanical connection during the radial expansion and plastic deformation of the first and second tubular members.

An expandable tubular member has been described which includes a tubular member comprising an inner surface, an outer surface located opposite the inner surface, and a distal end, and a distal end securing member extending from the distal end and defining a distal end securing channel adjacent the inner surface. In an exemplary embodiment, the distal end securing member comprises an interference fit feature. In an exemplary embodiment, the interference fit feature comprises a notch defined by the distal end securing member and located on a terminating end of the distal end securing member. In an exemplary embodiment, the distal end securing member comprises a sealing member engagement surface. In an exemplary embodiment, the sealing member engagement surface is located on an opposite side of the distal end securing member from the distal end securing channel. In an exemplary embodiment, the distal end securing channel comprises an annular channel located adjacent the distal end. In an exemplary embodiment, the inner surface defines a tubular member passageway, whereby the distal end securing channel is located between the distal end securing member and the tubular member passageway. In an exemplary embodiment, a plurality of threads extend from the outer surface of the tubular member, the plurality of threads defining a plurality of thread channels. In an exemplary embodiment, a lubricating material is included on the inner surface of the tubular member. In an exemplary embodiment, the tubular member is positioned in a preexisting structure. In an exemplary embodiment, the tubular member is a pin-thread tubular member.

An expandable tubular member has been described which includes a first tubular member comprising a distal end, and means on the first tubular member for preventing spring-back of the distal end of the first tubular member upon the coupling of the first tubular member to a second tubular member and radial expansion and plastic deformation of the first tubular member and the second tubular member. In an exemplary embodiment, the means for preventing spring-back comprises means for creating an interference fit. In an exemplary embodiment, the means for preventing spring back comprises means for providing a gas and liquid tight seal between the first tubular member and the second tubular member. In an exemplary embodiment, the expandable tubular member further includes means for coupling the first tubular member to the second tubular member.

An expandable tubular member has been described which includes a tubular member comprising a distal end, an outer surface, and an inner surface located opposite the outer surface, the inner surface defining a second tubular member coupling passageway extending from the distal end to a coupling passageway end located along the length of the tubular member, a distal end securing member extending from the tubular member adjacent the coupling passageway end, and a distal end securing channel defined by the tubular member and located between the distal end securing member and the outer surface. In an exemplary embodiment, the distal end securing channel comprises an interference fit feature. In an exemplary embodiment, the interference fit feature comprises an interference fit member extending from the distal end securing channel. In an exemplary embodiment, a sealing member channel is defined by the tubular member and located adjacent the distal end securing channel. In an exemplary embodiment, a sealing member is positioned in the sealing member channel. In an exemplary embodiment, the sealing member is an O-ring. In an exemplary embodiment, a primary sealing member is positioned in the sealing member channel, and a secondary sealing member is positioned in the sealing member channel. In an exemplary embodiment, the distal end securing channel comprises an annular channel located adjacent the distal end securing member. In an exemplary embodiment, the inner surface defines a tubular member passageway, whereby the distal end securing member is located between the distal end securing channel and the tubular member passageway. In an exemplary embodiment, a plurality of threads extend from the inner surface of the tubular member and are located in the second tubular member coupling passageway, the plurality of threads defining a plurality of thread channels. In an exemplary embodiment, a lubricating material is provided on the inner surface of the tubular member. In an exemplary embodiment, an insert is positioned in the distal end securing channel which is operable to provide a brazed connection. In an exemplary embodiment, the tubular member is positioned in a preexisting structure. In an exemplary embodiment, the tubular member is a box-thread tubular member.

An expandable tubular member has been described which includes a first tubular member, and means on the first tubular member for preventing spring-back of a distal end of a second tubular member upon the coupling of the first tubular member to the second tubular member and radial expansion and plastic deformation of the first tubular member and the second tubular member. In an exemplary embodiment, the means for preventing spring-back comprises means for creating an interference fit. In an exemplary embodiment, the means for preventing spring back comprises means for providing a gas and liquid tight seal between the first tubular member and the second tubular member. In an exemplary embodiment, the expandable tubular member further includes means for coupling the first tubular member to the second tubular member. In an exemplary embodiment, the expandable tubular member further includes means for providing a brazed connection positioned in the means for preventing spring back.

An expandable tubular member has been described which includes a first tubular member defining a second tubular member coupling passageway and defining a distal end securing channel located adjacent the second tubular member coupling passageway, and a second tubular member positioned in the second tubular member coupling passageway and coupled to the first tubular member, whereby the second tubular member comprises a distal end securing member positioned in the distal end securing channel. In an exemplary embodiment, the distal end securing member is coupled to the distal end securing channel by an interference fit. In an exemplary embodiment, the distal end securing member comprises an interference fit notch defined by the distal end securing member and located on a terminating end of the distal end securing member. In an exemplary embodiment, the distal end securing channel comprises an interference fit member extending from the distal end securing channel. In an exemplary embodiment, the first tubular member defines a sealing member channel located adjacent the distal end securing channel. In an exemplary embodiment, a sealing member is positioned in the sealing channel. In an exemplary embodiment, the sealing member is an O-ring. In an exemplary embodiment, a primary sealing member is positioned in the sealing channel, and a secondary sealing member is positioned in the sealing channel. In an exemplary embodiment, the distal end securing member comprises a sealing member engagement surface located adjacent the sealing member channel. In an exemplary embodiment, a sealing member is positioned in the sealing channel, whereby the sealing member engagement surface engages the sealing member. In an exemplary embodiment, the positioning of the distal end securing member in the distal end securing channel results in the engagement of the sealing member engagement surface with the sealing member before, during, and after the radial expansion and plastic deformation of the first tubular member and the second tubular member. In an exemplary embodiment, the positioning of the distal end securing member in the distal end securing channel prevents spring-back of a distal end of the second tubular member upon the radial expansion and plastic deformation of the first tubular member and the second tubular member. In an exemplary embodiment, a plurality of first tubular member threads are included on the first tubular member, and a plurality of second tubular member threads are included on the second tubular member, whereby the first tubular member threads and the second tubular member threads are engaged and couple the first tubular member to the second tubular member. In an exemplary embodiment, a lubricating material is included on an inner surface of the first tubular member and on an inner surface of the second tubular member. In an exemplary embodiment, the first tubular member and the second tubular member are positioned in a preexisting structure. In an exemplary embodiment, the first tubular member is a box-thread tubular member and the second tubular member is a pin-thread tubular member. In an exemplary embodiment, the positioning of the distal end securing member in the distal end securing channel provides a gas and liquid tight seal between the first tubular member and the second tubular member. In an exemplary embodiment, the distal end securing channel and the distal end securing member are fabricated from materials having different hardness. In an exemplary embodiment, a cold weld is provided between the distal end securing member and the distal end securing channel with the distal end securing member positioned in the distal end securing channel. In an exemplary embodiment, an insert is positioned in the distal end securing channel, whereby a brazed connection is provided by the insert between the distal end securing channel and the distal end securing member with the distal end securing member positioned in the distal end securing channel.

An expandable tubular member has been described which includes a first tubular member, a second tubular member comprising a distal end and coupled to the first tubular member, and means on the first tubular member and the second tubular member for preventing spring-back of the distal end of the second tubular member upon the radial expansion and plastic deformation of the first tubular member and the second tubular member. In an exemplary embodiment, the means for preventing spring-back comprises means for creating an interference fit between the distal end of the second tubular member and the first tubular member. In an exemplary embodiment, the expandable tubular member further includes means for coupling the first tubular member to the second tubular member. In an exemplary embodiment, the means for preventing spring-back comprises means for creating a gas and liquid tight seal between the first tubular member and the second tubular member. In an exemplary embodiment, the expandable tubular member further includes means for providing a cold weld between the first tubular member and the second tubular member. In an exemplary embodiment, the expandable tubular member further includes means for providing a brazed connection between the first tubular member and the second tubular member.

A method for coupling expandable tubular members has been described which includes providing a first tubular member defining a second tubular member coupling passageway and defining a distal end securing channel located adjacent the second tubular member coupling passageway, providing second tubular member comprising a distal end and a distal end securing member extending from the distal end, and coupling the first tubular member to the second tubular member, whereby the distal end securing member is positioned in the distal end securing channel. In an exemplary embodiment, the method further includes positioning the first tubular member and the second tubular member in a preexisting structure. In an exemplary embodiment, the method further includes radially expanding and plastically deforming the first tubular member and the second tubular member. In an exemplary embodiment, the positioning of the distal end securing member in the distal end securing channel prevents spring-back of the distal end on the second tubular member upon radial expansion and plastic deformation of the first tubular member and the second tubular member. In an exemplary embodiment, the method further includes providing a gas and liquid tight seal between the first tubular member and the second tubular member. In an exemplary embodiment, the positioning of the distal end securing member in the distal end securing channel maintains the seal between the first tubular member and the second tubular member before, during, and after radial expansion and plastic deformation of the first tubular member and the second tubular member. In an exemplary embodiment, the coupling provides a cold weld between the distal end securing member and the distal end securing channel. In an exemplary embodiment, the method further includes positioning an insert in the distal end securing channel, wherein during the coupling, the insert provides a brazed connection between the distal end securing member and the distal end securing channel.

An expandable tubular member has been described which includes a pin-thread tubular member comprising an inner surface, an outer surface located opposite the inner surface, and a distal end, a tubular member passageway defined by the inner surface, a distal end securing member extending from the distal end and defining a annular distal end securing channel adjacent the Inner surface, whereby the annular distal end securing channel is located between the distal end securing member and the tubular member passageway, an interference fit notch defined by the distal end securing member and located on a terminating end of the distal end securing member, a sealing member engagement surface located on an opposite side of the distal end securing member from the distal end securing channel, a plurality of threads extending from the outer surface of the tubular member, the plurality of threads defining a plurality of thread channels, and a lubricating material on the inner surface of the tubular member.

An expandable tubular member has been described which includes a box-thread tubular member comprising a distal end, an outer surface, and an inner surface located opposite the outer surface, the inner surface defining a second tubular member coupling passageway extending from the distal end to a coupling passageway end located along the length of the tubular member, a distal end securing member extending from the tubular member adjacent the coupling passageway end, an annular distal end securing channel defined by the tubular member and located between the distal end securing member and the outer surface, an interference fit member extending from the distal securing channel, a sealing member channel defined by the tubular member and located adjacent the distal end securing channel, a plurality of threads extending from the inner surface of the tubular member and located in the second tubular member coupling passageway, the plurality of threads defining a plurality of thread channels and a lubricating material on the inner surface of the tubular member.

An expandable tubular member has been described which includes a first tubular member comprising a first tubular member distal end, a first tubular member outer surface, and a first tubular member inner surface located opposite the first tubular member outer surface, the first tubular member inner surface defining a second tubular member coupling passageway extending from the first tubular member distal end to a coupling passageway end located along the length of the first tubular member, a first tubular member distal end securing member extending from the first tubular member adjacent the coupling passageway end, a first tubular member distal end securing channel defined by the first tubular member and located between the first tubular member distal end securing member and the first tubular member outer surface, a second tubular member coupled to the first tubular member, the second tubular member comprising an second tubular member inner surface, a second tubular member outer surface located opposite the second tubular member inner surface, and a second tubular member distal end, and a second tubular member distal end securing member extending from the second tubular member distal end and defining a second tubular member distal end securing channel adjacent the second tubular member inner surface, whereby the second tubular member distal end securing member is positioned in the first tubular member distal end securing channel, and the first tubular member distal end securing member is positioned in the second tubular member distal end securing channel.

A method for coupling expandable tubular members has been described which includes providing a first tubular member defining a second tubular member coupling passageway and defining a distal end securing channel located adjacent the second tubular member coupling passageway, providing second tubular member comprising a distal end and a distal end securing member extending from the distal end, coupling the first tubular member to the second tubular member, whereby the distal end securing member is positioned in the distal end securing channel, positioning the first tubular member and the second tubular member in a preexisting structure, providing a seal between the first tubular member and the second tubular member, and radially expanding and plastically deforming the first tubular member and the second tubular member, wherein the positioning of the distal end securing member in the distal end securing channel prevents spring-back of the distal end on the second tubular member and maintains the seal between the first tubular member and the second tubular member before, during, and after radial expansion and plastic deformation of the first tubular member and the second tubular member.

It is understood that variations may be made in the foregoing without departing from the scope of the disclosure. For example, the teachings of the present illustrative embodiments may be used to provide a wellbore casing, a pipeline, or a structural support. For example, the external sleeve may be omitted. Furthermore, one or more of the stress concentration grooves may be omitted. In addition, the stress concentration grooves may be provided in any geometric shape capable of concentrating stresses. Furthermore, stress concentration grooves may or may not be positioned in opposing relation in both the pin and box members. In addition, the pin and box members, may or may not be threadably coupled to one another, and the threads of the box and pin members may be any type of threads. Furthermore, the elements and teachings of the various illustrative embodiments may be combined in whole or in part in some or all of the illustrative embodiments. In addition, one or more of the elements and teachings of the various illustrative embodiments may be omitted, at least in part, and/or combined, at least in part, with one or more of the other elements and teachings of the various illustrative embodiments.

It will be further understood by those skilled in the art upon reading the foregoing disclosure and the claims that follow, and upon review of the drawings that the method may further include forming a wellbore casing within a borehole that traverses a subterranean formation including positioning first wellbore casing, second wellbore casing and additional wellbore casings within the borehole that overlaps one with the other and that are coupled to one another at a joint between each successive wellbore casing. In the method with additional wellbore casings would further includes additional tubular sleeves positioned to overlap each successive joint of the successive wellbore casings and causing each sleeve to collapse inwardly onto the respective end portions of the first, second, and additional wellbore casings to sealingly engage the exterior surfaces of the respective end portions. The method further includes the use of magnetic impulse energy to collapse the tubular sleeves onto the surfaces of the wellbore casings at the joints thereof, thereby facilitating sealing of the joints.

Although illustrative embodiments of the disclosure have been shown and described, a wide range of modification, changes and substitution is contemplated in the foregoing disclosure. In some instances, some features of the present disclosure may be employed without a corresponding use of the other features. Accordingly, it is appropriate that the appended claims be construed broadly and in a manner consistent with the scope of the disclosure.

What is claimed is:

1. An apparatus, comprising: a first tubular member; a second tubular member; a threaded connection for coupling the first tubular member to the second tubular member; at least one sealing member channel defined between the first and second tubular members; and one or more sealing members disposed within the sealing member channel for sealing the interface between the first and second tubular members before, during, and after a radial expansion and plastic deformation of the first and second tubular members; wherein one of the first and second tubular members comprises an inner surface, an outer surface opposite the inner surface, a distal end, and a distal end securing member extending from the distal end and defining a distal end securing channel.

2. The apparatus of claim 1, wherein the distal end securing member comprises an interference fit feature.

3. The apparatus of claim 2, wherein the interference fit feature comprises a notch defined by the distal end securing member and located on a terminating end of the distal end securing member.

4. The apparatus of claim 1, wherein the distal end securing member comprises a sealing member engagement surface.

5. The apparatus of claim 4, wherein the sealing member engagement surface is located on an opposite side of the distal end securing member from the distal end securing channel.

6. The apparatus of claim 1, wherein the distal end securing channel comprises an annular channel located adjacent the distal end.

7. The apparatus of claim 1, wherein the inner surface defines a tubular member passageway, whereby the distal end securing channel is located between the distal end securing member and the tubular member passageway.

8-11. (canceled)

12. An apparatus, comprising: a first tubular member; a second tubular member; a threaded connection for coupling the first tubular member to the second tubular member; at least one sealing member channel defined between the first and second tubular members; and one or more sealing members disposed within the sealing member channel for sealing the interface between the first and second tubular members before, during, and after a radial expansion and plastic deformation of the first and second tubular members; wherein one of the first and second tubular members comprises:
a distal end; an outer surface; an inner surface located opposite the outer surface, the inner surface defining a coupling passageway extending from the distal end to a coupling passageway end located along the length of the one of the first and second tubular members; a distal end securing member extending from the one of the first and second tubular members adjacent the coupling passageway end; and a distal end securing channel defined by the one of the first and second tubular members and located between the distal end securing member and the outer surface.

13. The apparatus of claim 12, wherein the distal end securing channel comprises an interference fit feature.

14. The apparatus of claim 13, wherein the interference fit feature comprises an interference fit member extending from the distal end securing channel.

15. The apparatus of claim 12, wherein the sealing member channel is located adjacent the distal end securing channel.

16. (canceled)

17. The apparatus of claim 15, wherein the one or more sealing members comprise:
a primary sealing member positioned in the sealing member channel; and
a secondary sealing member positioned in the sealing member channel.

18-21. (canceled)

22. The apparatus of claim 12, further comprising:
an insert positioned in the distal end securing channel which is operable to provide a brazed connection.

23-33. (canceled)

34. The apparatus of claim 1, wherein the positioning of the distal end securing member in the distal end securing channel results in the engagement of the sealing member engagement surface with the one or more sealing members before, during, and after the radial expansion and plastic deformation of the first tubular member and the second tubular member.

35. The apparatus of claim 1, wherein the positioning of the distal end securing member in the distal end securing channel prevents spring-back of a distal end of the second tubular member upon the radial expansion and plastic deformation of the first tubular member and the second tubular member.

36-39. (canceled)

40. The apparatus of claim 1, wherein the positioning of the distal end securing member in the distal end securing channel provides a gas and liquid tight seal between the first tubular member and the second tubular member.

41. The apparatus of claim 1, wherein the distal end securing channel and the distal end securing member are fabricated from materials having different hardness.

42. The apparatus of claim 1, wherein a cold weld is provided between the distal end securing member and the distal end securing channel with the distal end securing member positioned in the distal end securing channel.

43. The apparatus of claim 1, further comprising:
an insert positioned in the distal end securing channel, whereby a brazed connection is provided by the insert between the distal end securing channel and the distal end securing member with the distal end securing member positioned in the distal end securing channel.

44. A method for sealing a connection between adjoining first and second tubular members, the method comprising: threadably engaging a threaded axial end of the first tubular member within a threaded axial end opening of the second tubular member whereby a sealing member channel is defined between the first and the second tubular members; disposing a sealing member in the sealing member channel between the first and second tubular members; and radially expanding the first and the second tubular members to compress the sealing member between the first and second tubular members to seal the sealing member channel between the first and second tubular members;
wherein the first tubular member defines a second tubular member coupling passageway and defines a distal end securing channel located adjacent the second tubular member coupling passageway;
wherein the second tubular member comprises a distal end and a distal end securing member extending from the distal end; and
wherein the method further comprises positioning the distal end securing member in the distal end securing channel.

45. The method of claim 44, further comprising:
positioning the first tubular member and the second tubular member in a preexisting structure.

46. The method of claim 45, wherein radially expanding the first and the second tubular members comprises radially expanding and plastically deforming the first tubular member and the second tubular member.

47. The method of claim 46, wherein the positioning of the distal end securing member in the distal end securing channel prevents spring-back of the distal end on the second tubular member upon radial expansion and plastic deformation of the first tubular member and the second tubular member.

48.-51. (canceled)

52. A method comprising:
providing a first tubular member and a second tubular member comprising a distal end;
coupling the first and second tubular members; and
preventing spring-back of the distal end of the second tubular member upon the radial expansion and plastic deformation of the first tubular member and the second tubular member.

53-56. (canceled)
